(19) United States
(12) Patent Application Publication
(10) Pub. No.: US 2026/0330864 A1
(43) Pub. Date: Oct. 22, 2026

(54) SYSTEM

(71) Applicant: SoftBank Group Corp., Tokyo (JP)

(72) Inventor: Mika UMEKI, Tokyo (JP)

(73) Assignee: SoftBank Group Corp., Tokyo (JP)

(21) Appl. No.: 19/650,332

(22) Filed: Apr. 17, 2026

(30) Foreign Application Priority Data
Apr. 21, 2025 (JP) 2025-069963

(51) Int. Cl. G06V 30/414; G06F 16/334; G06F 21/56; G06F 40/295; G06N 20/00

(52) U.S. Cl. CPC G06V 30/414; G06F 16/334; G06F 21/56; G06F 40/295; G06N 20/00

(57) ABSTRACT

The present invention relates to a business partner information management system, and relates to a system in which an information acquisition unit automatically collects information such as a company name, a representative name, financial information, a certificate of all historical matters, a personal information protection system, past business performance, a history of administrative guidance, website contents, an alliance partner, and a business plan from diverse internal and external databases and external information sources, a determination unit comprehensively determines suitability and a risk by analyzing and scoring these pieces of information from multiple angles using generative AI, thereby unitarily and highly accurately automating business partner investigation and examination operations that have conventionally been complicated and inefficient manually, and further a mapping unit visualizes a determination result and risk evaluation with diverse attributes, thereby realizing strengthening of internal governance, risk reduction, and speeding up of decision-making.

### CROSS-REFERENCE TO RELATED APPLICATION

The present application claims priority to and incorporates by reference the entire contents of Japanese Patent Application No. 2025-069963 filed in Japan on Apr. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that when a plurality of departments such as an internal business partner management department, a legal and compliance department, an accounting and finance department, and a sales department make a contract with a new business partner or manage an existing business partner, diverse investigations and examinations such as a merchant investigation, a financial investigation, confirmation of a certificate of all historical matters, confirmation of a personal information handling system, investigation of past business performance, confirmation of duplication with an existing business partner, appropriateness determination of an alliance partner, validity evaluation of a business plan, presence or absence of a history of administrative guidance, and authenticity confirmation of website description contents are individually and manually executed, so that a great deal of time and effort is required to acquire and confirm information, it is difficult to share information among the departments and unitarily grasp a past examination background, and problems such as duplication and omission of investigation contents, variation in determination criteria, oversight of risks, occurrence of compliance violations, a decrease in operational efficiency, and a delay in decision-making occur, and that the present invention provides a new business partner information management platform capable of radically improving efficiency of conventional complicated and inefficient business partner investigation and examination operations, strengthening internal governance, reducing risks, and enabling prompt decision-making by realizing comprehensive database creation including past, present, and future predictions of business partner information, objective and highly accurate suitability determination by AI, visualization of a relationship and a risk by a corporate map, and the like.

### SUMMARY OF THE INVENTION

A means for solving the problem according to the present invention is to provide a business partner information management system, the system comprising an information acquisition unit, a determination unit, and a mapping unit, wherein the information acquisition unit is configured to automatically collect multifaceted corporate information such as a company name of a new business partner candidate, a representative name, financial information for a plurality of past periods, a certificate of all historical matters, a personal information protection system, past business performance, a history of administrative guidance, website description contents, alliance partner information, a business plan, and regional information from a plurality of internal and external databases and external information sources, the determination unit is configured to analyze various types of acquired information using generative AI, perform scoring and suitability determination from a plurality of viewpoints such as financial soundness, legitimacy of corporate status, suitability of a personal information management system, reliability of past business performance, presence or absence of a history of administrative guidance, authenticity of website description contents, validity of an alliance partner, appropriateness of a business plan, and presence or absence of duplication with an existing business partner, and automatically output registration availability and a reason for non-suitability based on a determination result, and the mapping unit is configured to classify registered business partner information by attributes such as a region, an industry, a transaction scale, and a risk level, visualize the classified information as a corporate map, and manage a past registration history and a determination background as a database, and further the determination unit is configured to continuously learn past determination results and external information to improve determination accuracy, thereby unitarily and automatically executing conventional complicated and inefficient business partner investigation and examination operations, and enabling strengthening of internal governance, risk reduction, and prompt decision-making.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

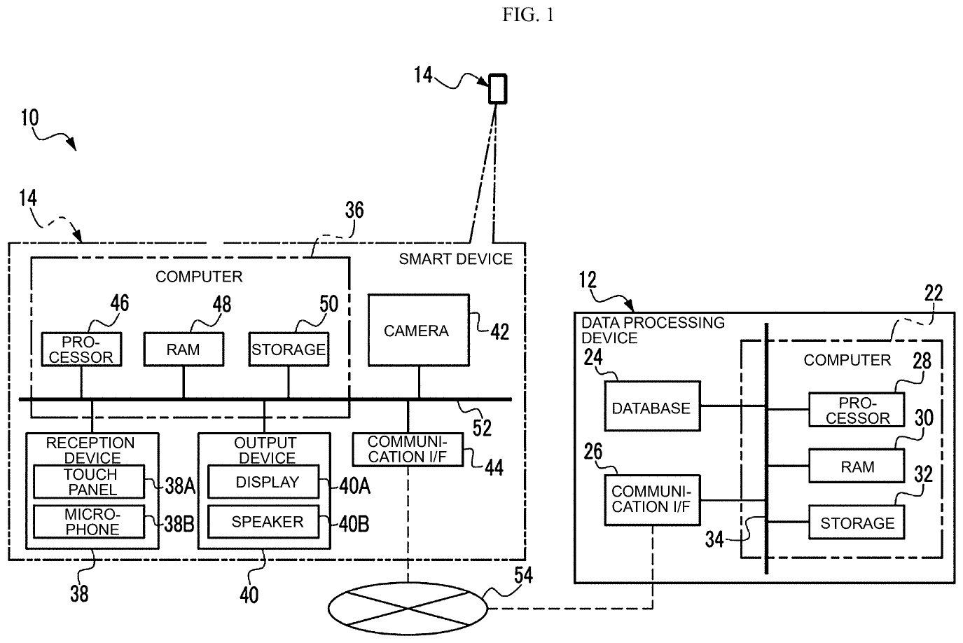

FIG. 1 Shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

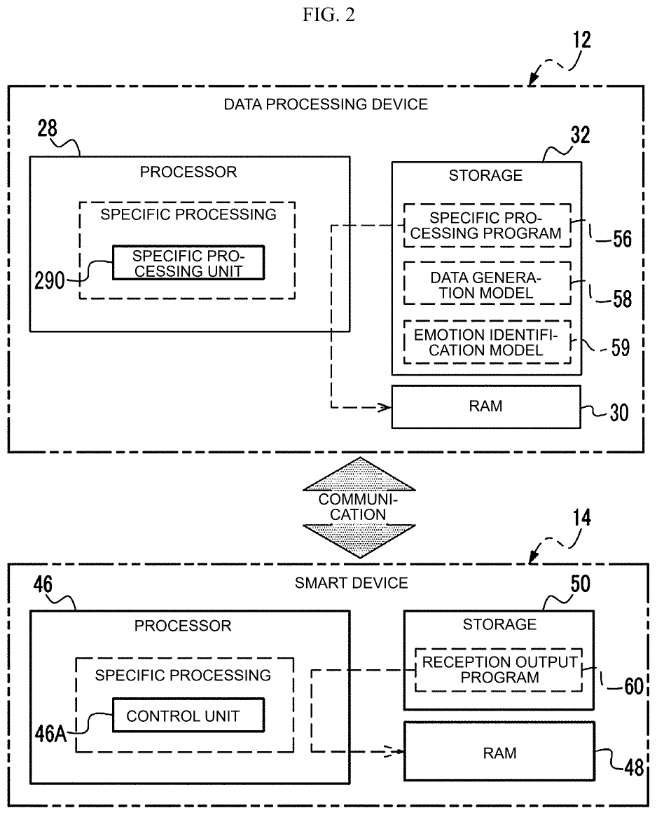

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

As an embodiment of the present invention, a business partner information management system is configured by connecting a server and a terminal via a network. A plurality of functional modules such as an information acquisition unit, a determination unit, a mapping unit, a database management unit, an external cooperation unit, an AI learning management unit, a log management unit, and a security management unit are implemented on the server side, and a user interface unit, an input support unit, a result display unit, a notification unit, a file upload unit, a download unit, a user authentication unit, and the like are implemented on the terminal side. Specifically, the present business partner information management system is constructed in a distributed computing environment including a plurality of arithmetic processing devices and a large-capacity memory. The present system containerizes each functional module on the server side as an independent microservice. The present system dynamically allocates execution resources of each module using a container orchestration technology. The arithmetic processing device on the server side includes a central processing unit and an image processing unit specialized for parallel computing. The present system utilizes these hardware resources to execute large-scale data processing at high speed. The information acquisition unit executes asynchronous communication via a network interface. The determination unit drives a large language model and a deep learning model deployed on a memory. The mapping unit executes a dimensionality reduction algorithm that projects high-dimensional data into a low-dimensional space. The database management unit integrally controls a relational database and a distributed non-relational database. The external cooperation unit communicates with an external application programming interface using a secure communication protocol. The AI learning management unit updates a weight parameter of a neural network using a parallel computing core of the image processing unit. The log management unit writes a system event to a time-series database at high speed. The security management unit executes encryption and decryption of data using a hardware encryption module. The terminal side includes an arithmetic device that executes a web browser or a dedicated application. The user interface unit dynamically rewrites a document object model to draw a screen. The input support unit refers to dictionary data cached in a local memory on the terminal side to execute predictive conversion. The result display unit analyzes structured data received from the server to render a graphical element. The notification unit receives a push notification from the server in real time using WebSocket communication. The file upload unit divides a file into data blocks of a certain size and transmits them asynchronously. The download unit writes a received data stream to a local storage. The user authentication unit executes challenge-response authentication using a public key cryptography system. With these configurations, the present system appropriately distributes a processing load to the server and the terminal. The present system improves throughput of the entire system. The present system brings about a technical improvement of improving a processing speed by optimizing a computer architecture, rather than mere automation of operations. Specific application fields of the present system include a credit examination system in a financial institution, a supply chain risk management system in a global company, and the like.

First, a user on the terminal side (for example, a person in charge of a business partner management department, a person in charge of a legal department, a person in charge of an accounting department, a person in charge of a sales department, a person in charge of an audit department, or the like) inputs or uploads necessary information in diverse formats through the user interface unit, such as a company name of a new business partner candidate, a representative name, a location, contact information, a date of establishment, capital, a number of employees, business contents, financial statements for three past periods (for example, a balance sheet, a profit and loss statement, and a cash flow statement), a certificate of all historical matters (for example, a PDF and image data), information regarding a personal information protection system (for example, a privacy policy, information management regulations, presence or absence of an office entry/exit management system, and an implementation status of information security education), past business performance (for example, a main business partner list, a past history of administrative guidance, a past career of a representative, and a past trouble history with a business partner), a history of administrative guidance (for example, contents of an administrative disposition, a disposition date, and an improvement report), a URL of a corporate website, alliance partner information (for example, an alliance partner company name, alliance contents, and an alliance start date), a business plan (for example, a sales target, an investment plan, a growth strategy, and a risk analysis), and regional information (for example, a prefecture, a municipality, and a business office location). For example, the financial statements are uploaded as an Excel file or a PDF, and the certificate of all historical matters is attached as an image file. The personal information protection system is input in a checklist format or a document file, and the past business performance can be collectively registered by text input or a CSV file. Furthermore, by inputting the URL of the corporate website, external information can be automatically acquired. Specifically, the arithmetic processing device on the terminal side executes preprocessing for converting the input data in a wide variety of formats into a unified internal data structure. The present terminal normalizes character string data such as a text-input company name and location using a character code standardization algorithm. The present terminal extracts a numerical value in a specific cell range from the uploaded spreadsheet file, and deploys it on the memory as an array of floating-point numbers. The present terminal converts the certificate of all historical matters input as an image file into a multidimensional tensor of pixel values. The present terminal serializes these converted data into a hierarchical data format consisting of key-value pairs. The present terminal transmits the serialized data to the server via an encrypted communication protocol. The present terminal executes a validation process for detecting a missing value or an abnormal value of the input data in advance on the client side. The present terminal immediately renders an error message, for example, when an input value of the capital is a negative value or when the date of establishment is a future date. The present terminal prevents invalid data transmission to the server side by this preliminary verification on the client side. The present terminal reduces consumption of a network bandwidth and reduces a communication load of the entire system. The present terminal analyzes the input URL of the corporate website, and confirms validity of a domain name by an inquiry to a domain name system. When determining that the URL is a valid URL, the present terminal activates a background process to asynchronously acquire initial metadata of the website. The present terminal transmits the acquired metadata to the server as a part of the input data. With these processes, the present terminal brings about a technical improvement of not only reducing a burden of manual input by a human but also improving accuracy and efficiency of data collection as a computer system. A specific application field of the present system includes a vendor onboarding process in a procurement department of a manufacturing industry that needs to continuously evaluate a large number of new suppliers.

The input support unit on the terminal side has a function of, for example, automatically suggesting and displaying a company name registered in the past or a similar company name when a company name is input, presenting a past representative list when a representative name is input, or automatically complementing from a postal code when a location is input. The file upload unit automatically determines a format of an uploaded file, performs text extraction from a PDF and OCR processing from an image as necessary, and standardizes data. The user authentication unit includes a security function such as single sign-on or multi-factor authentication, and controls an access authority for each department. Specifically, every time the user types a character in an input field, the present input support unit transmits a query to a search application programming interface on the server side using asynchronous communication. The present input support unit receives a search result by an N-gram-based character string similarity calculation algorithm or an edit distance calculation algorithm executed on the server side. The present input support unit dynamically renders the received list of similar company names on a screen in a drop-down format. The present file upload unit reads a magic number included in header information of a file, and determines an accurate file format without depending on an extension. When an image file is input, the present file upload unit activates an optical character recognition model using a convolutional neural network. The present optical character recognition model receives a two-dimensional image tensor whose resolution is normalized and which is subjected to grayscale conversion as input data. The present optical character recognition model outputs coordinate data of a bounding box of a recognized character and a certainty score of each character as output data. The present file upload unit specifies a character region whose certainty score is less than a preset threshold, and executes a subsequent process of assigning a flag prompting the user for manual confirmation. The present user authentication unit cooperates with an external identity provider using a security assertion markup language or an open authentication protocol. The present user authentication unit safely stores an encrypted token generated at the time of initial login in a local storage. The present user authentication unit realizes stateless authentication by adding the token to a header of a hypertext transfer protocol in subsequent communication. The present user authentication unit holds an access control list for each department on a memory, and dynamically switches display and non-display of an operation element on the screen based on a user's role. The present system physically eliminates a human error at the time of data input by these advanced input support and automation processes. The present system dramatically improves a processing speed of converting unstructured data into structured data by highly accurate text extraction by the optical character recognition model. The present system exhibits a technical effect of fundamentally improving data processing efficiency of a computer. A specific application field of the present system includes a document management system in a legal department or a compliance department that processes a large amount of contracts and certificates every day.

The information input from the terminal is transmitted to the information acquisition unit on the server side. In addition to the information received from the terminal, the information acquisition unit automatically collects related information from a plurality of internal databases such as an internal existing business partner database, a contract database managed by a legal department, a financial database managed by an accounting department, a transaction history database managed by a sales department, and an audit record database managed by an audit department. For example, for duplication confirmation with an existing business partner, a search is performed using a company name, a representative name, a location, a date of establishment, and the like as keys, and whether or not the same or similar business partner has been registered in the past is automatically extracted. Furthermore, related information is automatically acquired from a database of a credit research agency, public information of an administrative agency, a corporate information site on the Internet, a news site, an SNS, a list of an industry group, a patent information database, and the like via the external cooperation unit. For example, a past financial score and a credit rating are collected from a credit research agency, a history of administrative guidance and a history of legal violations are collected from an administrative agency, a corporate reputation, word of mouth, a news article, and a flaming history on an SNS are collected from the Internet, presence or absence of a membership qualification is collected from an industry group, and a possession status of intellectual property is collected from a patent information database. Specifically, the present information acquisition unit parses the received input data, and dynamically generates a search query necessary for an inquiry to each database. In accessing the internal database, the present information acquisition unit executes a parallel search for a plurality of data sources using a distributed search engine. The present information acquisition unit converts a company name into a normalized vector representation using a natural language processing model in order to absorb orthographical variants of the company name. By calculating a cosine similarity on a vector database, the present information acquisition unit extracts an existing business partner that is not only completely matched but also semantically similar with high accuracy. The present information acquisition unit queues an asynchronous data acquisition task to the external cooperation unit. The present external cooperation unit acquires a task from a message queue, and issues a hypertext transfer protocol request to an application programming interface of a target external information source. In acquiring information from a website, the present external cooperation unit controls a headless browser to render a dynamically generated document object model, and scrapes text data based on a designated XPath or cascading style sheet selector. The present external cooperation unit applies a named entity recognition algorithm to the acquired unstructured text data, and extracts an entity such as a company name, a person name, a date, and an amount of money as structured data. In acquiring data from a social networking service, the present external cooperation unit receives stream data of a post including a specific keyword in real time. The present external cooperation unit applies a sentiment analysis model to the received stream data, and calculates a probability distribution of positive, negative, and neutral. The present information acquisition unit merges a huge amount of data collected from inside and outside the company into an integrated database using a hash value uniquely identifying a company as a key. With these parallel distributed processing and vector search technologies, the present system executes advanced name identification processing at high speed, which was impossible with a simple character string search of a conventional relational database. The present system brings about a technical improvement of dramatically improving comprehensiveness and a processing speed of data collection. Specific application fields of the present system include due diligence operations of an investee company in an investment fund, an integrated management system of a global business partner network in a general trading company, and the like.

The huge amount of information collected by the information acquisition unit is transmitted to the determination unit on the server side. The determination unit executes analysis and determination of various types of information using generative AI. For example, regarding financial information, the generative AI automatically reads financial statements for three past periods, automatically calculates sales, profit, an equity ratio, presence or absence of insolvency, soundness of cash flow, a turnover period of accounts receivable and accounts payable, an increase or decrease in fixed assets, contents of investment activities, and the like, and compares them with an industry average and past business partner data to score soundness. Regarding a certificate of all historical matters, the generative AI automatically analyzes contents using OCR and natural language processing, extracts legitimacy of corporate status, a change history of a representative, description contents of a purpose column, an increase/decrease history of capital, a change history of a location, a record of dissolution and liquidation, and the like, and collates them with a past fraud case and a risk pattern. Regarding a personal information protection system, the generative AI analyzes an input checklist and regulation document, and automatically determines conformity with laws and guidelines, comprehensiveness of information management regulations, an implementation status of employee education, presence or absence of an information leakage countermeasure, an acquisition status of third-party certification, and the like. Regarding past business performance and a history of administrative guidance, the generative AI crawls an external database and a news article, extracts a past administrative disposition, a trouble case, a litigation history, contents of administrative guidance, presence or absence of an improvement report, an implementation status of a recurrence prevention measure, and the like, and evaluates a risk level. Regarding website description contents, the generative AI automatically crawls a website, and automatically determines authenticity of description contents, presence or absence of false advertising, a difference from past description contents, accuracy of explanation of a product/service, presence or absence of a legal violation, presence or absence of infringement of a third party's right, and the like. Regarding alliance partner information, the generative AI analyzes credit information of an alliance partner company, past transaction performance, a reputation in an industry, validity of alliance contents, contents of a contract, and the like, and evaluates a risk and a synergy effect. Regarding a business plan, the generative AI automatically summarizes contents of a business plan document, and analyzes validity of a sales target, reality of an investment plan, feasibility of a growth strategy, comprehensiveness of a risk analysis, comparison with a past similar case, consistency with an industry trend, and the like. For example, when a sales target greatly deviates from past performance or an industry average, a risk is warned, and when an investment plan is excessive, reevaluation of validity of a financing plan is prompted. Specifically, the present determination unit executes a large language model and a multimodal neural network based on a transformer architecture. The present determination unit inputs a 128-dimensional numerical vector obtained by normalizing numerical values of financial statements as input data. The present determination unit inputs a 512-dimensional embedding vector obtained by tokenizing text extracted from a certificate of all historical matters by byte pair encoding as input data. The present determination unit inputs a 256-dimensional feature tensor obtained by processing a screenshot image of a corporate website with a convolutional neural network as input data. The present determination unit combines these heterogeneous data, and calculates a hidden correlation between the data using a self-attention mechanism. The present determination unit outputs a continuous value score in a range of 0.0 to 1.0 indicating financial soundness as output data. The present determination unit outputs a percentage numerical value indicating a possibility of a compliance violation as output data. The present determination unit outputs a one-hot encoded vector indicating classification of a risk factor as output data. When the output score exceeds a preset threshold, the present determination unit executes a branching process of determining the company as high risk. The present determination unit executes a subsequent process of transferring data of the company determined as high risk to another module requesting a detailed manual examination. The present determination unit receives text data of a business plan document as input, and outputs a summary text string obtained by extracting an important context using an encoder-decoder model. The present system extracts a non-linear relationship in a high-dimensional space by a neural network. The present system specifies a potential risk, which has been difficult to discover by a conventional manual rule-based examination, at high speed and with high accuracy. The present system brings about a technical improvement of improving data analysis accuracy by a computer, rather than mere automation of examination operations. Specific application fields of the present system include credit evaluation operations of a borrower in a bank, business feasibility evaluation operations of an investee startup in a venture capital, and the like.

The determination unit performs scoring for each of these items, and implements comprehensive suitability determination. For example, when financial soundness falls below a certain standard, when there is a serious history of administrative guidance in the past, when a false description is recognized on a website, when a personal information protection system is insufficient, when a risk is recognized in an alliance partner, or when a business plan is unrealistic, it is determined as non-suitable, and a reason for non-suitability is automatically generated and notified to the terminal side. Conversely, when all items satisfy the standards, it is determined that registration as a business partner is possible, and a registration process is executed. A determination result is transmitted to the result display unit on the terminal side together with a detailed scoring result, basis data, a summary comment by AI, a comparison result with a past similar case, and the like. Specifically, the present determination unit executes an ensemble learning model using a gradient boosting decision tree algorithm in order to integrate a plurality of individual scores output from each analysis module. The present determination unit inputs a 10-dimensional numerical vector such as a financial score, a compliance score, a website reliability score, and a personal information protection score as input data. The present determination unit inputs an array of weighting parameters indicating importance of each item as input data. The present determination unit processes these input data in accordance with a conditional branch at a node of a decision tree. The present determination unit outputs a binary label indicating final transaction availability as output data. The present determination unit outputs an integer value score from 0 to 100 indicating a comprehensive risk degree as output data. The present determination unit outputs an importance vector indicating a contribution degree of each feature amount of the decision tree as output data. When the binary label is a value indicating non-suitability, the present determination unit executes a subsequent process of specifying a feature amount having the highest contribution degree in the importance vector. The present determination unit dynamically generates a prompt of a large language model based on the specified feature amount. The present determination unit inputs the generated prompt to the large language model, and causes it to output a natural language text string explaining a specific reason for non-suitability. When determined as suitable, the present determination unit issues a transaction commit instruction to the database management unit, and inserts a new record into a business partner master table. The present determination unit serializes a data set of the determination result into a JSON format, and transmits it to the terminal side via a hypertext transfer protocol. The present system eliminates overfitting and bias that can occur in a single model by an ensemble method combining a plurality of machine learning models. The present system stably outputs an objective and reproducible determination result. The present system realizes strict data-driven decision making that does not depend on human subjectivity, and exhibits a technical effect of improving reliability of the entire system. Specific application fields of the present system include a tenant move-in examination system in a real estate management company, an examination system of a new store opener in an electronic commerce platform, and the like.

Registered business partner information is automatically classified by a mapping unit on the server side for each of a plurality of attributes such as a region, an industry, a transaction scale, a risk level, an attribute of an alliance partner, contents of a business plan, presence or absence of a history of administrative guidance, a possession status of intellectual property, a scale of the number of employees, a scale of capital, and a number of years of establishment. For example, a corporate map is automatically generated from various perspectives, such as a group of companies in an IT industry in the Kanto region with an annual turnover of 1 billion yen or more and a low risk level, a group of companies that have a history of administrative guidance in the past but are currently determined to have been improved, a group of growth companies possessing a large amount of intellectual property, and a group of startup companies established less than three years ago. The mapping unit displays these pieces of information by diverse visualization methods such as a graph structure, on a map, a heat map, a network diagram, a tree map, and a timeline, and enables a person in charge of each department to refer to them in real time through the result display unit on the terminal side. For example, when a person in charge of a sales department considers a new project, it becomes possible to grasp at a glance a distribution of existing business partners in the same region and the same industry, positioning of a company with a high risk level, a network structure of an alliance partner, a time-series transition of a history of administrative guidance, and the like. Specifically, the present mapping unit executes a dimensionality reduction algorithm based on manifold learning in order to process multidimensional attribute data extracted from a database. The present mapping unit inputs a 50-dimensional feature vector group obtained by digitizing attributes of each company as input data. The present mapping unit inputs an adjacency matrix indicating a transaction relationship and a capital relationship between companies as input data. The present mapping unit outputs two-dimensional or three-dimensional coordinate data while maintaining a local structure between data points in a high-dimensional space using a dimensionality reduction algorithm. The present mapping unit outputs floating-point numbers of an X coordinate and a Y coordinate of each company node as output data. The present mapping unit outputs a numerical array indicating a weight of an edge between nodes as output data. The present mapping unit outputs an integer value of a group identifier assigned by a clustering algorithm as output data. The present mapping unit executes a subsequent process of generating a graph data structure interpretable by a front-end drawing library using the calculated coordinate data and group identifier. The present mapping unit transmits the generated graph data to the terminal side. The result display unit on the present terminal side renders the received graph data at high speed by hardware acceleration using a web graphics library. The present result display unit executes level-of-detail control for dynamically adjusting a resolution of a node to be displayed in accordance with a user's zoom operation or pan operation. The present system provides visual information intuitively understandable by a human by advanced arithmetic processing of mapping data having a high-dimensional and complex relationship into a low-dimensional space. The present system brings about a technical improvement of dramatically reducing a cognitive load of information and improving a speed of decision making as compared with a conventional interface that reads a large amount of text data. Specific application fields of the present system include visualization of customer segmentation in a marketing department, an analysis system of an alliance network with a competitor in a corporate planning department, and the like.

Furthermore, the AI learning management unit on the server side continuously learns a determination result made by the determination unit in the past, information newly acquired from the outside, presence or absence of occurrence of a trouble after an actual transaction, presence or absence of occurrence of administrative guidance, bankruptcy or merger of a business partner, a growth track record, and the like, and improves determination accuracy of the generative AI. For example, when a company determined as non-suitable in the past causes a problem at a later date, the case is taken in as learning data and reflected in a future determination standard. Conversely, a case where it was determined that a risk was high in the past but no problem actually occurred is also utilized for reviewing a determination standard. Even when there is a new legal revision or a change in industry guidelines, the AI learning management unit automatically acquires information and reflects it in an algorithm of the determination unit. Thereby, determination accuracy and reliability of the entire system are continuously improved. Specifically, the present AI learning management unit constructs an arithmetic pipeline dedicated to learning independent of an inference model operating in a production environment. The present AI learning management unit inputs a teacher data set consisting of a pair of an input feature vector at the time of past determination and a correct label based on a subsequent actual event as input data. The present AI learning management unit inputs an embedding tensor obtained by vectorizing a newly acquired legal text as input data. The present AI learning management unit divides these data into mini-batches, and executes forward propagation processing of a neural network. The present AI learning management unit outputs a scalar value of a loss function indicating an error between a predicted value of a model and a correct label as output data. The present AI learning management unit outputs a gradient vector for a weight parameter of each layer as output data. The present AI learning management unit executes a subsequent process of updating a weight parameter by a stochastic gradient descent method or an adaptive moment estimation algorithm using the calculated gradient vector. The present AI learning management unit executes evaluation using a verification data set for the updated model, and executes blue-green deployment for seamlessly replacing a model in a production environment only when an accuracy index exceeds a previous model. The present AI learning management unit designs a reward function that gives a positive reward when a determination result brings a business profit and gives a negative reward when it brings a loss using a framework of reinforcement learning, and optimizes a model by a policy gradient method. The present system implements an online learning mechanism that autonomously adapts to an environmental change and a new data trend. The present system exhibits a technical effect of preventing obsolescence of a model and maintaining high inference accuracy over a long period of time. The present system realizes a self-evolving computer system, which is impossible with a static rule-based system. Specific application fields of the present system include continuous update of a fraudulent use detection system in a credit card company, operation of a dynamic insurance premium calculation model in an insurance company, and the like.

The database management unit on the server side unitarily manages all business partner information, determination results, scoring data, mapping data, AI learning data, user operation logs, external cooperation histories, and the like, and stores them as an audit trail. The log management unit records all operation histories, data acquisition histories, determination histories, mapping histories, and the like in detail, and enables an audit department and a compliance department to refer to them at a later date. The security management unit implements data encryption, access authority management, unauthorized access detection, data backup, a recovery function at the time of failure occurrence, and the like, and ensures safety and reliability of the entire system. Specifically, the present database management unit adopts a polyglot persistence architecture combining a relational database storing structured data and a distributed non-relational database storing unstructured data and time-series data. The present database management unit caches frequently accessed data in an in-memory data grid, and reduces an overhead of disk input/output. The present log management unit receives a log message asynchronously output from each module by a message broker, and writes it to a unitary log storage via a log collection agent. The present log management unit applies a hash chain technology to log data, and includes a hash value of each log entry in a next entry, thereby making it possible to mathematically detect data falsification. The present security management unit executes encryption with a 256-bit key length using an advanced encryption standard algorithm for all stored data. The present security management unit applies a transport layer security protocol to data on a communication path. The present security management unit constantly monitors network traffic, and specifies a packet flow deviating from a normal communication pattern in real time using a machine learning-based anomaly detection algorithm. When detecting an anomaly, the present security management unit executes a subsequent process of automatically blocking communication from a corresponding Internet protocol address by a firewall. The present security management unit periodically acquires a snapshot of a database, and executes asynchronous replication to another geographically distant data center. The present system eliminates a single point of failure and maximizes availability of the system and integrity of data by these advanced data management and security mechanisms. The present system brings about a technical improvement of improving fault tolerance against a cyber attack and a hardware failure. Specific application fields of the present system include a secure management system of an electronic medical record in a medical institution, an integrated database system of confidential information in a government agency, and the like.

On the terminal side, the user interface unit integrally provides an input support function, an automatic complement function, a file upload function, a result display function, a notification function, a download function, a user authentication function, and the like. For example, a suitability determination result and a reason for non-suitability transmitted from the determination unit, visualization information of a corporate map, a summary comment by AI, a risk alert, a request for additional information, and the like are displayed in an easy-to-understand manner, and can be downloaded in a PDF or Excel format as necessary. The notification unit notifies a user of a determination result, a request for additional information, a risk alert, feedback of an AI learning result, and the like in real time. Specifically, the present user interface unit is constructed using a component-oriented front-end framework. The present user interface unit operates as a single-page application that efficiently re-renders only a changed part using a virtual document object model without reloading an entire screen. The present user interface unit holds data in a JSON format received from the server in a local state management store, and synchronizes the data between respective components. The present user interface unit dynamically changes a color and an icon of an indicator on a screen in accordance with a score of a determination result. The present notification unit establishes a WebSocket connection with the server, and maintains a bidirectional real-time communication channel. When receiving an event message push-transmitted from the server, the present notification unit calls a native notification application programming interface of an operating system, and displays a pop-up notification on a user's desktop screen beyond a frame of a browser. The present download unit receives data as a binary large object from the server, and encodes it into a designated file format on a memory on the client side. The present download unit generates a virtual uniform resource locator for the encoded data, activates a download manager of a browser, and executes saving to a local storage. The present system minimizes an influence of a network delay by these asynchronous processes and rendering optimization on the client side. The present system dramatically improves a response speed of the system to a user operation, and exhibits a technical effect of providing a smooth user experience. Specific application fields of the present system include a real-time trading dashboard in a securities company, a dynamic delivery status monitoring system in a logistics base, and the like.

As described above, in the present embodiment, main functions such as the information acquisition unit, the determination unit, the mapping unit, the AI learning management unit, the database management unit, the external cooperation unit, the log management unit, and the security management unit are realized on the server side, and functions such as the user interface unit, the input support unit, the result display unit, the notification unit, the file upload unit, the download unit, and the user authentication unit are realized on the terminal side. The generative AI is incorporated as an essential component in the determination unit and the AI learning management unit on the server side, and is utilized one by one for processing such as analysis, determination, learning, summarization, comparison, and visualization of various types of information. For example, by combining diverse functions of the generative AI, such as document analysis by natural language processing, extraction of certificate contents by image recognition, risk evaluation by anomaly detection, automatic summarization of a business plan by summary generation, presentation of a determination basis by similar case search, automatic crawling and summarization of external information, trend analysis of time-series data, and visualization of an alliance structure by network analysis, it is possible to realize highly accurate and efficient business partner information management, which has been difficult to realize by conventional manual work. Specifically, the present system adopts a client-server architecture that clearly separates lightweight front-end processing on the terminal side and heavy back-end processing on the server side. The present system loosely connects each processing module via a message queue to construct a data processing pipeline. The present system calls an inference endpoint of the generative AI at each stage in a process in which input data sequentially flows from the information acquisition unit to the determination unit and the mapping unit. The present system executes inference processing of the generative AI in parallel on a cluster of image processing devices to maximize throughput. The present system extracts a semantic feature vector from unstructured text using a natural language processing model, and extracts a spatial feature tensor from pixel data using an image recognition model. The present system integrates these heterogeneous feature amounts in a connection layer, and calculates a final determination score using a multilayer perceptron. The present system predicts a future numerical value from a past data series using a long short-term memory network in trend analysis of time-series data. The present system quantifies the strength of a relationship between nodes using a graph convolutional network in network analysis. By integrating these advanced arithmetic processes, the present system multilaterally evaluates a complex business risk that cannot be fully captured by a single algorithm. The present system processes data at a scale and speed exceeding the limits of human cognitive ability, and brings about a fundamental improvement in business processes through the advancement of computer technology itself. Specific application fields of the present system include a global compliance integrated management platform in a multinational corporation and a large-scale public procurement eligibility examination system in a government agency.

### (System Configuration)

The system according to the present embodiment includes an information acquisition unit, a determination unit, a mapping unit, a database management unit, an external cooperation unit, an AI learning management unit, a log management unit, a security management unit, a user interface unit, an input support unit, a result display unit, a notification unit, a file upload unit, a download unit, and a user authentication unit. The information acquisition unit receives data in diverse formats input from a terminal, such as a company name of a new business partner candidate, a representative name, a location, a date of establishment, capital, a number of employees, business contents, financial statements for three past periods, a certificate of all historical matters, information regarding a personal information protection system, past business performance, a history of administrative guidance, a URL of a corporate website, alliance partner information, a business plan document, and regional information, and further automatically collects related information from a plurality of internal databases such as an internal existing business partner database, a contract database of a legal department, a financial database of an accounting department, a transaction history database of a sales department, and an audit record database of an audit department. For example, the information acquisition unit automatically extracts duplication with an existing business partner using a company name, a representative name, a location, and a date of establishment as keys, or refers to contents of a past contract or a transaction history. Furthermore, in cooperation with the external cooperation unit, the information acquisition unit acquires a past financial score and a credit rating from a database of a credit research agency, acquires a history of administrative guidance and a history of legal violations from public information of an administrative agency, and automatically collects a reputation, word of mouth, a news article, a flaming history, a membership qualification, a possession status of intellectual property, and the like from a corporate information site on the Internet, a news site, an SNS, a list of an industry group, and a patent information database. For example, this includes analyzing an appearance frequency of a company name or a co-occurrence rate with a negative word on an SNS to evaluate a flaming risk. Specifically, the present information acquisition unit automates a series of extraction, transformation, and load processing using a data pipeline orchestration tool in order to process the received wide variety of data. In collecting information from the internal databases, the present information acquisition unit issues a standardized structured query language via a data virtualization layer that absorbs a difference in schema of each database. The present information acquisition unit executes named entity extraction using a pre-trained language model on unstructured text data acquired by the external cooperation unit. The present information acquisition unit constructs a knowledge graph on a memory with the extracted entities as nodes and their relationships as edges. The present information acquisition unit applies a sliding window stream processing algorithm to a data stream from a social networking service. The present information acquisition unit counts a co-occurrence frequency of a company name and a word having a negative emotional polarity within a specific time frame, and detects a sudden flaming event using a statistical significance test. The present information acquisition unit analyzes a patent classification code and citation network data acquired from the patent information database, and calculates an index for quantifying technical competitiveness of a company. The present system integrates information from these diverse data sources in real time and asynchronously. The present system exhibits a technical effect of eliminating data silos and constructing a single reliable information source. The present system breaks through the limits of manual information collection and realizes comprehensive and high-speed data aggregation by a computer. Specific application fields of the present system include a comprehensive profiling system for a target company in M&A advisory operations and an underwriting examination system for corporate cyber insurance in an insurance company.

The determination unit inputs the huge amount of information collected by the information acquisition unit into the generative AI, and executes analysis and determination of various types of information. For example, regarding financial information, the generative AI automatically reads financial statements for three past periods, automatically calculates sales, profit, an equity ratio, presence or absence of insolvency, soundness of cash flow, a turnover period of accounts receivable and accounts payable, an increase or decrease in fixed assets, contents of investment activities, and the like, and scores soundness by comparing them with an industry average and past business partner data. Regarding a certificate of all historical matters, the generative AI automatically analyzes contents using OCR and natural language processing, extracts legitimacy of corporate status, a change history of a representative, description contents of a purpose column, an increase/decrease history of capital, a change history of a location, a record of dissolution or liquidation, and the like, and collates them with past fraud cases and risk patterns. Regarding a personal information protection system, the generative AI analyzes an input checklist and rule document, and automatically determines suitability with laws and guidelines, comprehensiveness of information management rules, an implementation status of employee education, presence or absence of information leakage countermeasures, an acquisition status of third-party certification, and the like. Regarding past business performance and a history of administrative guidance, the generative AI crawls an external database and a news article, extracts a past administrative disposition, a trouble case, a litigation history, contents of administrative guidance, presence or absence of an improvement report, an implementation status of recurrence prevention measures, and the like, and evaluates a risk level. Regarding website description contents, the generative AI automatically crawls a website, and automatically determines authenticity of description contents, presence or absence of false advertising, a difference from past description contents, accuracy of explanation of a product/service, presence or absence of a legal violation, presence or absence of infringement of a third party's right, and the like. Regarding alliance partner information, the generative AI analyzes credit information of an alliance partner company, past transaction performance, a reputation in an industry, validity of alliance contents, contents of a contract, and the like, and evaluates a risk and a synergy effect. Regarding a business plan, the generative AI automatically summarizes contents of a business plan document, and analyzes validity of a sales target, reality of an investment plan, feasibility of a growth strategy, comprehensiveness of risk analysis, comparison with a past similar case, consistency with an industry trend, and the like. For example, if a sales target greatly deviates from past performance or an industry average, a risk is warned, and if an investment plan is excessive, re-evaluation of validity of a financing plan is prompted. The determination unit performs scoring for each of these items, executes comprehensive suitability determination, generates a detailed scoring result, basis data, a summary comment by AI, a comparison result with a past similar case, and the like, and transmits them to the result display unit on the terminal side. Specific examples of a prompt sentence to be read by the generative AI include “Analyze the following financial statement data and score financial soundness compared with an industry average”, “Extract legitimacy of corporate status and a past risk factor from contents of the following certificate of all historical matters, and determine a risk level”, “Collate the following rule document regarding a personal information protection system with legal guidelines, and evaluate suitability”, “Crawl contents of the following corporate website, and determine presence or absence of false description and false advertising”, and “Summarize the following business plan document, and analyze growth potential and a risk by comparing it with a past similar case”. Specifically, the present determination unit dynamically combines a system prompt and a user prompt optimized for each task using prompt engineering technology. The present determination unit inputs structured data in a JSON format having each item of financial statements as a key and a numerical value as a value as input data. The present determination unit inputs an embedding tensor obtained by chunking text of a business plan document and converting each chunk into a 768-dimensional vector as input data. The present determination unit inputs top five pieces of text data extracted by vector similarity search from a database of past similar cases as a context as input data. The present determination unit inputs these pieces of input data to an encoder of a large language model, and calculates a dependency relationship between respective tokens by a self-attention mechanism. The present determination unit outputs an array of integer values from 0 to 10 indicating a score of each evaluation item as output data. The present determination unit outputs a binary logit value indicating presence or absence of a risk as output data. The present determination unit outputs a text string in a markdown format explaining a basis of determination as output data. The present determination unit executes subsequent processing of applying a sigmoid function to the output logit value and converting it into a probability value. When the probability value exceeds a set threshold value, the present determination unit sets a risk alert flag to true and fires an event to the notification unit. By utilizing inference capability of the large language model, the present system accurately interprets an ambiguous text expression and a complex context that cannot be handled by a conventional rule base. The present system realizes precise scoring based on advanced natural language understanding, and exhibits a technical effect of dramatically improving accuracy of determination operations. Specific application fields of the present system include an automation support system for internal control evaluation of a company in an auditing firm and a business due diligence system for a company in a consulting firm.

The mapping unit automatically classifies information by a plurality of attributes such as a suitability determination result and a risk evaluation result by the determination unit, a region of a company, an industry, a transaction scale, a risk level, an attribute of an alliance partner, contents of a business plan, presence or absence of a history of administrative guidance, a possession status of intellectual property, a scale of the number of employees, a scale of capital, and a number of years of establishment, generates a corporate map by diverse visualization methods such as a graph structure, on a map, a heat map, a network diagram, a tree map, and a timeline, and enables a person in charge of each department to refer to the corporate map in real time through the result display unit on the terminal side. For example, a corporate map is automatically generated from various perspectives, such as a group of companies in the IT industry in the Kanto region with an annual turnover of 1 billion yen or more and a low risk level, a group of companies that have a past history of administrative guidance but are determined to have been improved at present, a group of growth companies possessing a large amount of intellectual property, and a group of startup companies established less than three years ago. The mapping unit enables a person in charge of the sales department to grasp at a glance a distribution of existing business partners in the same region and the same industry, positioning of a company with a high risk level, a network structure of an alliance partner, a time-series transition of a history of administrative guidance, and the like when considering a new project. Specifically, the present mapping unit executes a graph neural network in order to model a complex relationship between companies. The present mapping unit inputs graph structure data having each company as a node and a transaction relationship or a capital relationship between companies as an edge as input data. The present mapping unit inputs a 64-dimensional feature vector indicating attribute information of a company assigned to each node as input data. The present mapping unit aggregates feature amounts of adjacent nodes using a graph convolutional layer, and updates a hidden state vector of each node. The present mapping unit outputs a new embedding vector of each node reflecting a structural feature of the entire graph as output data. The present mapping unit outputs a score matrix in a range of 0.0 to 1.0 indicating an existence probability of a potential link between nodes as output data. The present mapping unit outputs an integer value of a cluster ID assigned by a community detection algorithm as output data. The present mapping unit executes subsequent processing of applying a uniform manifold approximation and projection algorithm to the calculated embedding vector and generating two-dimensional coordinate data for drawing. The present mapping unit constructs a visualization data set in a JSON format that can be drawn on a front end using the generated coordinate data and cluster ID. The present system mathematically extracts a hidden risk propagation path and a possibility of synergy between companies, which cannot be discovered by simple attribute filtering, by advanced relationship learning using a graph neural network. The present system brings about a technical improvement that expands human information processing capability and supports quick and accurate decision-making by converting a high-dimensional network structure into an intuitive visual representation. Specific application fields of the present system include a system for identifying a bottleneck company in supply chain management and a simulation system for a chain bankruptcy risk in a financial institution.

The database management unit unitarily manages all business partner information, determination results, scoring data, mapping data, AI learning data, user operation logs, external cooperation histories, and the like, and stores them as an audit trail. For example, information of all business partners registered in the past, a scoring result output by the determination unit, a corporate map generated by the mapping unit, learning data accumulated by the AI learning management unit, all operation histories performed by a user, an acquisition history of external data acquired by the external cooperation unit, and the like are stored in chronological order so that they can be searched, extracted, and reused as necessary. Specifically, the present database management unit includes a routing mechanism that dynamically selects an optimal storage engine according to characteristics of data. The present database management unit uses a relational database engine that guarantees ACID properties for business partner master data requiring transaction consistency. The present database management unit uses a column-oriented time-series database engine specialized for write performance for a huge amount of log data and time-series scoring data. The present database management unit inputs a data insertion query and an update query asynchronously transmitted from each module as input data. The present database management unit inputs a search query including a complex join condition transmitted from the user interface unit as input data. The present database management unit executes a query optimizer to generate an optimal execution plan, and scans an index tree to specify a target record. The present database management unit outputs a result set indicating a set of records matching a search condition as output data. The present database management unit outputs performance metrics such as query execution time and the number of read pages as output data. The present database management unit outputs a status code indicating success or failure of a transaction as output data. The present database management unit executes subsequent processing of storing a result set of a frequently executed search query in an in-memory cache server and shortening response time to the next identical query to a millisecond unit. The present system maintains high-speed read/write performance even for petabyte-class large-scale data by a combination of a distributed database architecture and an in-memory cache. The present system exhibits a technical effect of achieving both data persistence and search efficiency. Specific application fields of the present system include an integrated management system for customer and product data in a large-scale electronic commerce platform and a real-time analysis system for a huge amount of call history data in a telecommunications carrier.

The external cooperation unit cooperates with a plurality of external information sources such as a credit research agency, an administrative agency, a corporate information site on the Internet, a news site, an SNS, an industry group, and a patent information database by diverse methods such as an API, web crawling, an RSS feed, and database cooperation, and automatically acquires necessary information. For example, the external cooperation unit acquires a credit rating and a financial score from a credit research agency by API cooperation, acquires a history of administrative guidance and a history of legal violations from an administrative agency by web crawling, analyzes an appearance frequency of a company name and a co-occurrence rate with a negative word from an SNS, acquires a membership qualification and a reputation in an industry from an industry group, and acquires a possession status and an application status of intellectual property from a patent information database. Specifically, the present external cooperation unit efficiently manages simultaneous connections to thousands of external endpoints using an asynchronous input/output framework. The present external cooperation unit dynamically switches a hypertext transfer protocol request based on a RESTful architecture and binary communication using a gRPC protocol according to specifications of a target external information source. In web crawling, the present external cooperation unit automatically analyzes a robot exclusion standard of a target site, and executes a rate limit algorithm for controlling an access frequency. The present external cooperation unit inputs a dictionary object of a search parameter including a company name and an identifier to be acquired as input data. The present external cooperation unit inputs a character string of an authentication token or an API key of each external information source as input data. The present external cooperation unit constructs a request header and a body using these pieces of input data, and transmits them via a network socket. The present external cooperation unit outputs a response payload in a JSON format or an XML format returned from an external server as output data. The present external cooperation unit outputs a status code of a hypertext transfer protocol as output data. The present external cooperation unit outputs a numerical value in a millisecond unit indicating communication latency as output data. When the status code indicates an error, the present external cooperation unit executes subsequent processing of executing retry processing according to an exponential backoff algorithm. The present external cooperation unit parses the acquired response payload, maps it to a unified data model inside the system, and transfers it to the information acquisition unit. The present system realizes stable data collection without being affected by instability of an external network or load fluctuation of a partner server by these advanced communication control and error handling mechanisms. The present system brings about a technical improvement that improves fault tolerance in cooperation with an external system. Specific application fields of the present system include a real-time market data aggregation system in a financial information service provider and a vacant seat information integration system of a plurality of airlines in a travel agency.

The AI learning management unit continuously learns a determination result made by the determination unit in the past, information newly acquired from the outside, presence or absence of occurrence of a trouble after an actual transaction, presence or absence of occurrence of administrative guidance, bankruptcy or merger of a business partner, a growth track record, and the like, and improves determination accuracy of the generative AI. For example, when a company determined to be non-suitable in the past causes a problem at a later date, the case is taken in as learning data and reflected in a future determination criterion. Even when there is a new legal revision or a change in industry guidelines, the AI learning management unit automatically acquires information and reflects it in an algorithm of the determination unit. Specifically, the present AI learning management unit executes an MLOps infrastructure in which machine learning lifecycle management is integrated into a continuous integration and continuous delivery pipeline. The present AI learning management unit inputs a tensor data set consisting of tens of thousands of records in which an input feature amount at the time of past inference and a correct label based on subsequent observation are paired as input data. The present AI learning management unit inputs an initial value array of hyperparameters such as a learning rate and a batch size of a model as input data. The present AI learning management unit inputs a context vector obtained by encoding newly acquired legal text with a natural language processing model as input data. The present AI learning management unit executes weight update processing by a backpropagation method of a neural network using these pieces of data. The present AI learning management unit outputs a scalar value of a cross entropy error for a verification data set as output data. The present AI learning management unit outputs an array of floating-point numbers indicating precision, recall, and an F1 score as output data. The present AI learning management unit outputs a binary file including a weight parameter of an updated model as output data. The present AI learning management unit executes subsequent processing of testing whether or not the calculated F1 score statistically significantly exceeds a score of a current production model. When a significant improvement is recognized, the present AI learning management unit pushes a new model image to a container registry, and issues a rolling update command to an orchestration tool. The present system completely automates from re-learning of a model to evaluation and deployment without human intervention. The present system autonomously adapts to a change in data distribution (data drift) and a change in concept (concept drift), and exhibits a technical effect of always maintaining optimal inference accuracy. Specific application fields of the present system include an automatic update system for a personalized product recommendation model in an electronic commerce site and a continuous improvement system for a defective product detection model in a manufacturing line.

The log management unit records all operation histories, data acquisition histories, determination histories, mapping histories, and the like in detail, and enables an audit department and a compliance department to refer to them at a later date. For example, who input which business partner information and when, what kind of determination result was output, which external information was acquired at which timing, what kind of mapping was generated, and the like are recorded in chronological order and stored as an audit trail. Specifically, the present log management unit executes a log transfer agent that collects an unstructured log message asynchronously output from each microservice in the system and converts it into structured data. The present log management unit inputs a log entry in a JSON format including a time stamp, an event type, a user identifier, a target resource identifier, and a payload as input data. The present log management unit inputs a text string in a syslog format output from a network device as input data. The present log management unit extracts a necessary field from the text string using a regular expression engine, and maps it to a key-value pair. The present log management unit outputs indexed document data optimized for a search engine as output data. The present log management unit outputs time-series metrics data indicating a data amount of logs and an error occurrence rate as output data. The present log management unit outputs an anomaly score of each log entry calculated by an anomaly detection algorithm as output data. When the anomaly score exceeds a set threshold value, the present log management unit executes subsequent processing of transmitting an immediate alert to the security management unit. The present log management unit applies unsupervised machine learning such as an isolation forest algorithm to the accumulated log data, and automatically specifies a suspicious access deviating from a normal operation pattern. The present system not only simply stores a huge amount of log data, but also enables real-time search and advanced analysis. The present system brings about a technical improvement that supports early discovery of a security incident and quick cause investigation at the time of a system failure. Specific application fields of the present system include an access log analysis system for insider trading monitoring in a financial institution and a large-scale infrastructure monitoring system in a cloud service provider.

The security management unit implements data encryption, access authority management, unauthorized access detection, data backup, a recovery function at the time of failure occurrence, and the like, and ensures safety and reliability of the entire system. For example, access authority is finely set for each user, information that can be browsed and edited is controlled for each department, all communications are encrypted, an alert is automatically issued when unauthorized access is detected, data backup is periodically acquired, and quick recovery can be performed when a failure occurs. Specifically, the present security management unit executes an access control mechanism based on a zero trust architecture that does not depend on network perimeter defense. The present security management unit inputs authentication information (a hash value of a password and a one-time password) transmitted at the time of a user's login attempt as input data. The present security management unit inputs a context vector including an Internet protocol address of an access source, a fingerprint of a device, and position information as input data. The present security management unit inputs an identifier of a requested resource and an operation type (read, write, delete, etc.) as input data. The present security management unit inputs these pieces of input data to a risk-based authentication engine, and calculates a degree of deviation from a past access pattern. The present security management unit outputs a Boolean value indicating success or failure of authentication as output data. The present security management unit outputs an authorization decision policy indicating permission or denial for an access request as output data. The present security management unit outputs a JSON Web Token including an expiration date of a session and an authority scope as output data. When authorization is denied, the present security management unit executes subsequent processing of recording the access attempt in a security information and event management system and displaying a warning on a dashboard of an administrator. In backup processing of a database, the present security management unit extracts only a difference in data, compresses it, encrypts it, and asynchronously transfers it to an object storage at a remote location. By combining multi-layered security defense and dynamic risk evaluation, the present system provides robust protection against an internal threat and an advanced cyber attack from the outside. The present system exhibits a technical effect of minimizing an information leakage risk and ensuring business continuity of the system. Specific application fields of the present system include a protection system for confidential technical information in the defense industry and a personal health information management system for a patient in the healthcare industry.

The user interface unit operates on the terminal side, and integrally provides an input support function, an automatic complementation function, a file upload function, a result display function, a notification function, a download function, a user authentication function, and the like. For example, when a company name is input, a past candidate list and a similar company name are automatically displayed, automatic format conversion is performed when financial statements are uploaded, a suitability determination result and a reason for non-suitability transmitted from the determination unit, visualization information of a corporate map, a summary comment by AI, a risk alert, a request for additional information, and the like are displayed in an easy-to-understand manner, and downloading in a PDF or Excel format is enabled as necessary. The notification unit notifies the user of a determination result, a request for additional information, a risk alert, feedback of an AI learning result, and the like in real time. The file upload unit automatically determines a format of an uploaded file, performs text extraction from a PDF and OCR processing from an image as necessary, and aims at standardization of data. The download unit enables downloading of a determination result, a corporate map, a summary comment by AI, and the like in various file formats. The user authentication unit includes a security function such as single sign-on and multi-factor authentication, and controls an access authority for each department. Specifically, the present user interface unit adopts an architecture that offloads heavy arithmetic processing to a background thread called a web worker so as not to block a main thread of a browser. The present user interface unit inputs an event object such as a user's keyboard input or mouse click as input data. The present user interface unit inputs a JSON payload of a determination result asynchronously received from the server as input data. The present user interface unit inputs array data of nodes and edges of a graph structure received from the mapping unit as input data. The present user interface unit integrates these pieces of input data into a unitary state tree using a state management library, detects a change in data, and recalculates only a related screen component. The present user interface unit outputs a node tree of a virtual document object model passed to a rendering engine of the browser as output data. The present user interface unit outputs an array of pixel data drawn on a canvas element as output data. The present user interface unit outputs a payload of a hypertext transfer protocol request transmitted to the server as output data. The present user interface unit executes subsequent processing of applying a minimum patch to an actual document object model based on a difference calculation result of the virtual document object model. The present system maintains smooth drawing performance of 60 frames per second even when handling a large amount of data or complex graphics by these advanced front-end technologies. The present system eliminates a user's operation delay, and brings about a technical improvement of providing an intuitive and efficient human-machine interface. Specific application fields of the present system include a real-time radar information display console used by an air traffic controller, a monitoring and control panel of a manufacturing line used by a factory operator, and the like.

In this way, the system according to the present embodiment realizes highly accurate and efficient business partner information management centered on the generative AI by operating each unit in cooperation. Specific examples of a prompt sentence to be read by the generative AI include “analyze the following financial statement data and score financial soundness compared with an industry average”, “extract legitimacy of corporate status and a past risk factor from contents of the following certificate of all historical matters, and determine a risk level”, “collate the following rule document regarding a personal information protection system with legal guidelines, and evaluate suitability”, “crawl contents of the following corporate website, and determine presence or absence of a false description and false advertising”, “summarize the following business plan, and analyze growth potential and a risk in comparison with a past similar case”, and the like, and by the generative AI executing analysis, determination, summarization, comparison, visualization, and the like of various types of information using these prompts, it is possible to realize highly accurate and efficient business partner information management that has been difficult to realize by conventional manual work. Specifically, the present system is configured with a generative AI module based on a large language model as a core. The present generative AI module is a multi-layer neural network adopting a transformer architecture. The present system converts input text data into a fixed-dimensional token embedding vector by a tokenizer. The present system executes a matrix operation using a self-attention mechanism on the vector. The present system quantifies a context dependency relationship in a high-dimensional space. The present system generates an input tensor in which a prompt sentence and target data are combined. For example, the present system formats numerical data of financial statements as a comma-separated time-series array. The present system inputs the time-series array together with a prompt sentence into the present generative AI module as a 512-dimensional input tensor. The present generative AI module outputs a continuous value score from 0 to 100 indicating financial soundness based on a pre-learned weight parameter. The present generative AI module outputs a binary label indicating presence or absence of a risk factor. The present generative AI module outputs a natural language text vector indicating a determination basis. The present system determines whether or not the output score exceeds a preset threshold value. The present system automatically branches subsequent approval flow processing based on a result of the threshold value determination. The present system converts a subjective document reading process by a human into a deterministic matrix operation process in a high-dimensional vector space. The present system dramatically improves a processing speed of examination operations. The present system eliminates variation in examination criteria and improves determination accuracy. The present system is extremely useful in a use case such as a loan examination in a financial institution or a new supplier evaluation in a large company. The present system periodically executes fine-tuning processing using a cross-entropy error function. The present system reflects latest legal data and industry trends in the weight parameter. The present system autonomously improves determination accuracy over time.

### (Implementation Steps)

### Step 1: Input and Collection of Business Partner Candidate Information

A user inputs or uploads a company name of a new business partner candidate, a representative name, a location, a date of establishment, capital, a number of employees, business contents, financial statements for three past periods, a certificate of all historical matters, information regarding a personal information protection system, past business performance, a history of administrative guidance, a URL of a corporate website, alliance partner information, a business plan, regional information, and the like through the user interface unit of the terminal. The input support unit performs automatic complementation of a company name and a representative name, postal code conversion of a location, format conversion of financial statements, OCR processing of a certificate of all historical matters, checklist creation of a personal information protection system, templating of a business plan, and the like, and streamlines input work. Specifically, the present input support unit operates as a dedicated client application deployed on a memory of a user terminal. The present input support unit monitors a user's keystroke event in units of milliseconds. The present input support unit transmits an input character string to a search module on the server side via an asynchronous communication protocol. The present search module executes a prefix search using a trie tree structure on an in-memory database. The present search module extracts a list of candidate company names and representative names on the order of milliseconds. The present search module returns the extracted list to the terminal as array data in a JSON format. The present input support unit immediately renders the received array data as a drop-down list on the user interface. The present input support unit executes binary header analysis on an uploaded file group. The present input support unit deterministically identifies a file format. The present input support unit executes optical character recognition processing using a convolutional neural network on an image file. The present input support unit converts a pixel array in an image into a 256-dimensional feature map. The present input support unit extracts a bounding box of a character from the feature map. The present input support unit converts the extracted region into text character string data. The present input support unit converts an image file, which is unstructured data, into structured text data interpretable by a subsequent natural language processing model. The present input support unit extracts a table structure from a PDF file of financial statements. The present input support unit converts the extracted table structure into a multidimensional numerical array tensor. The present input support unit performs distributed processing of these pre-processes in an edge computing environment. The present input support unit significantly reduces a communication load and an arithmetic load on the server side. The present system automates normalization and structuring of input data. The present system physically eliminates a human error at the time of data input. The present system improves inference accuracy in subsequent AI analysis processing. The present system resolves a bottleneck of data collection in a use case such as a securities company that processes a large number of new account openings or a platform operator that examines a large number of merchants.

### Step 2: Automatic Information Acquisition From Internal and External Databases and External Information Sources

In addition to the information received from the terminal, the information acquisition unit automatically collects related information from an internal existing business partner database, a contract database of a legal department, a financial database of an accounting department, a transaction history database of a sales department, an audit record database of an audit department, and the like. Furthermore, the external cooperation unit automatically acquires a credit rating, a history of administrative guidance, a reputation, word of mouth, a news article, a flaming history, a membership qualification, a possession status of intellectual property, and the like from a database of a credit research agency, public information of an administrative agency, a corporate information site on the Internet, a news site, an SNS, a list of an industry group, a patent information database, and the like. For example, analyzing an appearance frequency of a company name on an SNS and a co-occurrence rate with a negative word to evaluate a flaming risk is also included. Specifically, the present information acquisition unit controls a plurality of crawler agents operating on a distributed processing framework. The present information acquisition unit issues an SQL query or a RESTful API request in parallel to a plurality of heterogeneous databases using an identifier of a target company as a key. The present external cooperation unit collects unstructured text data on the Internet. The present external cooperation unit executes morphological analysis and named entity extraction on the collected text data. The present external cooperation unit extracts a text segment related to the target company. The present external cooperation unit inputs the extracted text segment into a word embedding model. The present external cooperation unit converts the text segment into a 768-dimensional dense vector. The present external cooperation unit calculates a cosine similarity between the dense vector and a predefined dictionary vector group of negative words. The present external cooperation unit counts the number of text segments whose cosine similarity exceeds a predetermined threshold value. The present external cooperation unit calculates a ratio of negative texts to the total number of acquired texts, and generates a flaming risk score which is a continuous value in a range of 0.0 to 1.0. The present external cooperation unit applies an autoregressive moving average model to a transition of the appearance frequency acquired as time-series data. The present external cooperation unit predicts an abnormal spike in a future appearance frequency. The present system executes these collection and analysis processes asynchronously in multi-threads. The present system minimizes an influence of a network delay and ensures real-time performance of information collection. The present system replaces a conventional process in which a human manually operates a search engine to collect information with an automated data pipeline based on an algorithm. The present system ensures comprehensiveness and objectivity of information collection. The present system brings about a technical effect of discovering a potential risk at an early stage in a use case such as reputation risk management in a public relations department of a company or due diligence of an investee company in an investment fund.

### Step 3: Multifaceted Information Analysis and Determination by Generative AI

The determination unit inputs all information collected by the information acquisition unit into the generative AI, and performs analysis and determination of various types of information. For example, regarding financial information, the generative AI automatically reads financial statements for three past periods, automatically calculates sales, profit, an equity ratio, presence or absence of insolvency, soundness of cash flow, a turnover period of accounts receivable and accounts payable, an increase or decrease in fixed assets, contents of investment activities, and the like, and scores soundness by comparing them with an industry average and past business partner data. Regarding a certificate of all historical matters, the generative AI automatically analyzes contents using OCR and natural language processing, extracts legitimacy of corporate status, a change history of a representative, description contents of a purpose column, an increase/decrease history of capital, a change history of a location, a record of dissolution and liquidation, and the like, and collates them with a past fraud case and a risk pattern. Regarding a personal information protection system, the generative AI analyzes a checklist and a rule document, and automatically determines suitability with laws and guidelines, comprehensiveness of information management rules, an implementation status of employee education, presence or absence of an information leakage countermeasure, an acquisition status of third-party certification, and the like. Regarding past business performance and a history of administrative guidance, the generative AI crawls an external database and a news article, extracts a past administrative disposition, a trouble case, a litigation history, contents of administrative guidance, presence or absence of an improvement report, an implementation status of a recurrence prevention measure, and the like, and evaluates a risk level. Regarding website description contents, the generative AI automatically crawls a website, and automatically determines authenticity of description contents, presence or absence of false advertising, a difference from past description contents, accuracy of an explanation of a product/service, presence or absence of a legal violation, presence or absence of infringement of a third party's right, and the like. Regarding alliance partner information, the generative AI analyzes credit information of an alliance partner company, past transaction performance, a reputation in an industry, validity of alliance contents, contents of a contract, and the like, and evaluates a risk and a synergy effect. Regarding a business plan, the generative AI automatically summarizes contents of a business plan, and analyzes validity of a sales target, reality of an investment plan, feasibility of a growth strategy, comprehensiveness of risk analysis, comparison with a past similar case, consistency with an industry trend, and the like. Specific examples of a prompt sentence to be read by the generative AI include “analyze the following financial statement data and score financial soundness compared with an industry average”, “extract legitimacy of corporate status and a past risk factor from contents of the following certificate of all historical matters, and determine a risk level”, “collate the following rule document regarding a personal information protection system with legal guidelines, and evaluate suitability”, “crawl contents of the following corporate website, and determine presence or absence of a false description and false advertising”, “summarize the following business plan, and analyze growth potential and a risk in comparison with a past similar case”, and the like. Specifically, the present determination unit includes an ensemble learning architecture integrating a plurality of specialized neural network models operating on a parallel computing cluster using a GPU. The present determination unit classifies a wide variety of input data for each modality. The present determination unit applies a regression model using a multilayer perceptron to structured numerical data such as financial data. The present determination unit configures financial indicators for three past periods as a 128-dimensional input vector. The present determination unit inputs the input vector into the regression model, and causes a financial soundness score in a range of 0 to 100 to be output. The present determination unit applies a transformer-based large language model to unstructured text data such as a rule document and a business plan. The present determination unit tokenizes text data, and generates an input tensor of up to 4096 tokens. The present determination unit inputs the input tensor into the large language model. The present determination unit causes a probability distribution indicating legal suitability to be output from a hidden state vector of a final layer of the large language model. For example, the present determination unit outputs numerical values of a suitability probability of 0.85 and a non-suitability probability of 0.15. The present determination unit causes a one-hot vector indicating a category of an extracted risk factor to be output. The present determination unit combines a score, a probability distribution, and a vector output from each model, and generates an integrated feature vector. The present determination unit inputs the integrated feature vector into a final-stage classifier. The present determination unit outputs a binary determination result indicating comprehensive transaction availability. The present determination unit transmits the output determination result to the database management unit, and uses it as a trigger for a subsequent approval workflow. The present system converts a complex information integration process performed by a human examiner based on tacit knowledge into a mathematical feature synthesis process in a high-dimensional space. The present system completely guarantees objectivity and reproducibility of an examination. The present system dramatically shortens a lead time required for an examination from several days to several minutes. The present system exhibits a technical effect of strongly supporting an expert's judgment in a use case requiring advanced expertise such as due diligence of a target company in a corporate acquisition or investee evaluation in venture capital. The present system extracts an attention weight in an inference process of each model. The present system quantifies which input data contributed most to a determination, and visualizes it as a basis for the determination. The present system resolves a black box problem of AI, and realizes explainable AI.

### Step 4: Generation and Notification of Determination Result, Scoring, and Basis Information

The determination unit performs scoring for each item, executes comprehensive suitability determination, generates a detailed scoring result, basis data, a summary comment by AI, a comparison result with a past similar case, and the like, and transmits them to the result display unit on the terminal side. The notification unit notifies the user of a determination result, a reason for non-suitability, a risk alert, a request for additional information, feedback of an AI learning result, and the like in real time. For example, when financial soundness falls below a certain standard, when there is a serious history of administrative guidance in the past, when a false description is recognized on a website, when a personal information protection system is insufficient, when a risk is recognized in an alliance partner, when a business plan is unrealistic, or the like, it is determined as non-suitable, and a reason thereof is automatically generated and notified to the terminal side. Specifically, the present determination unit inputs a continuous value score and a probability distribution of each item output from a preceding neural network into a decision tree algorithm predefined on a memory. The present determination unit executes threshold value determination at each node of the decision tree. The present determination unit deterministically derives a final comprehensive suitability determination label. For example, the present determination unit outputs a label of any of approval, conditional approval, and rejection. The present determination unit records a traversal path of the decision tree. The present determination unit specifies a main factor of non-suitability based on the path. The present determination unit inputs an identifier of the specified main factor into a natural language generation model. The present determination unit dynamically generates an explanatory text corresponding to the identifier. For example, the present determination unit generates a character string that an equity ratio is 20 percent below an industry average. The present determination unit packages a score array, a determination label, and the generated explanatory text as structured data in a JSON format. The present determination unit transmits the structured data to the result display unit on the terminal side via a secure communication channel. The present notification unit monitors an event-driven messaging queue operating on the server side. The present notification unit detects that new determination result data is enqueued in the queue. The present notification unit transmits a push notification to the terminal using a WebSocket protocol. The present system executes a process from generation of a determination result to notification completely asynchronously and in real time. The present system minimizes a user's waiting time. The present system presents a reason for non-suitability together with a specific numerical basis. The present system clarifies an action to be taken next by the user. For example, the present system presents an additional collateral request, a correction instruction for a specific rule, and the like on a screen. The present system brings about a technical effect of reducing rework of a business process and improving overall throughput. The present system contributes to rapid feedback of an examination result and improvement of customer satisfaction in a use case such as a move-in examination in real estate rental or a new issuance examination of a credit card.

### Step 5: Automatic Generation and Visualization of Corporate Map

The mapping unit automatically classifies information by a plurality of attributes such as a suitability determination result and a risk evaluation result by the determination unit, a region of a company, an industry, a transaction scale, a risk level, an attribute of an alliance partner, contents of a business plan, presence or absence of a history of administrative guidance, a possession status of intellectual property, a scale of the number of employees, a scale of capital, and a number of years of establishment, generates a corporate map by diverse visualization methods such as a graph structure, on a map, a heat map, a network diagram, a tree map, and a timeline, and enables a person in charge of each department to refer to the corporate map in real time through the result display unit on the terminal side. For example, a corporate map is automatically generated from various perspectives, such as a group of companies in an IT industry in the Kanto region with an annual turnover of 1 billion yen or more and a low risk level, a group of companies having a history of administrative guidance in the past but determined to have been improved at present, a group of growth companies possessing a large number of intellectual properties, and a group of startup companies established less than three years ago. Specifically, the present mapping unit expresses each company as a data point on a multidimensional feature space. The present mapping unit combines attribute data and a determination score of each company, and generates a 256-dimensional feature vector. The present mapping unit executes principal component analysis or a t-distributed stochastic neighbor embedding algorithm. The present mapping unit dimensionally compresses the 256-dimensional feature vector into two-dimensional or three-dimensional low-dimensional coordinate data. The present mapping unit calculates a similarity between companies as a Euclidean distance based on the compressed coordinate data. The present mapping unit applies a k-means clustering algorithm, and automatically divides a company group into a plurality of clusters. The present mapping unit calculates barycentric coordinates of each cluster and an included company list. The present mapping unit generates directed graph data using a transaction relationship and a capital relationship between companies as an edge and a company as a node. The present mapping unit applies a graph drawing algorithm based on a dynamic model, and calculates optimal arrangement coordinates of a node. The present mapping unit converts these calculation results into vector graphics data. For example, the present mapping unit generates vertex array data for an SVG format or WebGL. The present mapping unit transmits the graphics data to the terminal. The result display unit on the present terminal side renders graphics data at high speed using hardware acceleration of a GPU. The present system converts a high-dimensional and complex corporate data group into a low-dimensional spatial arrangement that can be intuitively processed by a human visual cortex. The present system facilitates discovery of a hidden correlation and a cluster structure between data. The present system has a technical effect of dramatically reducing a cognitive load of information grasping as compared with a conventional analysis method of reading a huge amount of text data. The present system strongly supports strategic decision-making in a use case such as vulnerability analysis of a supply chain, grasping of a distribution status of a competitor in a specific region, and extraction of a target company for new market development.

### Step 6: Continuous Improvement of Determination Accuracy by AI Learning

The AI learning management unit continuously learns a determination result made by the determination unit in the past, information newly acquired from the outside, presence or absence of occurrence of a trouble after an actual transaction, presence or absence of occurrence of administrative guidance, bankruptcy or merger of a business partner, a growth track record, and the like, and improves determination accuracy of the generative AI. For example, when a company determined to be non-suitable in the past causes a problem at a later date, the case is taken in as learning data and reflected in a future determination criterion. Even when there is a new legal revision or a change in industry guidelines, the AI learning management unit automatically acquires information and reflects it in an algorithm of the determination unit. Specifically, the present AI learning management unit manages a time-series database constructed in a storage area of the server. The present AI learning management unit accumulates a past input tensor, an output score, and a determination label output by the determination unit as history data. The present AI learning management unit periodically acquires a post-status of a target company via the external cooperation unit. For example, the present AI learning management unit acquires binary data such as a bankruptcy flag, an administrative guidance flag, and a default flag. The present AI learning management unit combines the acquired post-status as a correct label with history data, and automatically generates a training data set for supervised learning. The present AI learning management unit detects that a size of the training data set has reached a predetermined batch size. The present AI learning management unit activates a re-learning process of a model using a backpropagation algorithm in a background thread. The present AI learning management unit calculates a cross-entropy error between a prediction score and a correct label. The present AI learning management unit minutely updates a weight parameter of each layer of a neural network using a gradient descent method. The present AI learning management unit newly acquires text data of a legal revision or a guideline change. The present AI learning management unit adds the text data as a corpus, and continuously executes a pre-learning process of a large language model. Unlike a static rule-based system, the present system autonomously adapts to an environmental change and a new risk pattern. The present system brings about a technical effect of improving generalization performance of a model over time and continuously reducing a prediction error for unknown data. The present system automatically executes an accuracy evaluation test using a verification data set before and after updating a weight of a model. The present system updates a model parameter of a production environment by hot swap only when accuracy is improved. The present system always provides the latest inference capability while keeping a system downtime to zero. The present system provides essential adaptability in a use case such as a compliance check system corresponding to a frequent change in financial regulations or a security monitoring system detecting a new method of a cyber attack.

### (Specific Use Case)

For example, when a sales department examines a corporation whose main business is sales of information and communication equipment as a new business partner candidate, first, a company name, a representative name, a location, a date of establishment, capital, a number of employees, business contents, financial statements for three past periods (a balance sheet, a profit and loss statement, and a cash flow statement), a certificate of all historical matters (PDF file), a rule document regarding a personal information protection system, a main business partner list, presence or absence of a history of administrative guidance, a URL of a corporate website, alliance partner information, a business plan (a sales target, an investment plan, a growth strategy, and risk analysis), regional information, and the like are input or uploaded using a user interface unit of a terminal. An input support unit automatically suggests a past registered company name or a similar company name when a company name is input, automatically complements an address from a postal code when a location is input, automatically extracts numerical data from a PDF when financial statements are uploaded, performs OCR processing from an image of a certificate of all historical matters, and automatically generates a checklist of a personal information protection system. Specifically, the input support unit executes a plurality of data preprocessing pipelines in parallel in the background in a process in which a user inputs data into an input form of the terminal. The input support unit normalizes a character code of a character string input to a text field of the company name. The input support unit executes a fuzzy search based on a Levenshtein distance for an in-memory distributed cache server using the normalized character string as a query. The input support unit extracts a company name list whose similarity score exceeds a threshold value in milliseconds, and dynamically renders the list on a screen as suggestion candidates. The input support unit applies a layout analysis algorithm to the uploaded PDF file of the financial statements. The input support unit calculates ruled line information and relative coordinates of a text block in the document. The input support unit reconstructs a table structure based on the calculated coordinate information, and expands a numerical value of each cell on a memory as floating-point multidimensional array data. The input support unit executes image preprocessing of noise removal and contrast adjustment on image data of the certificate of all historical matters. The input support unit inputs the preprocessed image tensor to a convolutional neural network, and outputs a bounding box in units of characters and a probability distribution of a character class. The input support unit generates text data by connecting character classes having the highest probability. The input support unit extracts a specific keyword from the extracted text data using natural language processing. For example, the input support unit extracts a character string such as personal information or a management representative. The input support unit automatically generates checklist data in a JSON format based on an extraction result. The system completes a conversion process from unstructured data to structured data on an edge side. The system brings about a technical effect of saving a communication bandwidth to a server and reducing processing latency of the entire system. The system eliminates a bottleneck of input work in use cases such as an underwriting examination operation of an insurance company that digitizes a large amount of paper medium materials and performs an examination, and a procurement department of a manufacturing industry that processes documents in diverse formats submitted from a large number of suppliers.

An information acquisition unit automatically collects related information from an internal existing business partner database, a contract database of a legal department, a financial database of an accounting department, a transaction history database of a sales department, and an audit record database of an audit department in addition to the information received from the terminal, and extracts, for example, a history registered with the same company name or the same representative name in the past, past contract contents, past transaction performance, an audit indication item, and the like. An external cooperation unit acquires a credit rating and a financial score from a database of a credit research agency, acquires a history of administrative guidance and a history of legal violations from public information of an administrative agency, automatically acquires a reputation, word of mouth, and a news article from a corporate information site and a news site on the Internet, analyzes an appearance frequency of a company name and a co-occurrence rate with a negative word from an SNS, acquires a membership qualification and a reputation in an industry from an industry group, and acquires a possession status and an application status of intellectual property from a patent information database. Specifically, the information acquisition unit orchestrates a plurality of data fetch workers based on a microservice architecture. The information acquisition unit issues an asynchronous RPC call to each database on an internal network using a corporate identifier received from the terminal as a key. The information acquisition unit merges a record group in an XML or JSON format returned from each database into a single integrated data frame in accordance with a common data schema. The external cooperation unit transmits a secure request using OAuth authentication to an external Web API. The external cooperation unit acquires structured data such as a credit rating and a financial score, and stores the structured data in a corresponding column of the integrated data frame. The external cooperation unit deploys a distributed web crawler for an unstructured data source such as a news site or an SNS. The external cooperation unit analyzes a DOM tree from an HTML document, and extracts body text. The external cooperation unit inputs the extracted text to a natural language processing pipeline. The external cooperation unit tokenizes the text, removes a stop word, and then generates an appearance frequency vector of a word. The external cooperation unit calculates an inner product of the appearance frequency vector and a negative word dictionary. The external cooperation unit normalizes an inner product value to calculate a co-occurrence rate score in a range of 0 to 1. The external cooperation unit converts a list of patent classification codes acquired from the patent information database into a multidimensional vector by one-hot encoding. The system automatically constructs a unified tensor representation processable by a machine learning model from heterogeneous data sources scattered inside and outside the company. The system has a technical effect of dramatically improving comprehensiveness of data collection and eliminating information silos. The system enables precise risk profiling based on multifaceted information in use cases such as corporate valuation in an investment bank and selection of a new business partner in a general trading company.

A determination unit inputs all information collected by the information acquisition unit to generative AI, and for example, regarding financial information, the generative AI automatically reads financial statements for three past periods, automatically calculates sales, profit, an equity ratio, presence or absence of insolvency, soundness of cash flow, a turnover period of accounts receivable and accounts payable, an increase or decrease in fixed assets, contents of investment activities, and the like, and compares them with an industry average and past business partner data to score financial soundness. Regarding a certificate of all historical matters, the generative AI automatically analyzes contents using OCR and natural language processing, extracts legitimacy of corporate status, a change history of a representative, description contents of a purpose column, an increase or decrease history of capital, a change history of a location, a record of dissolution or liquidation, and the like, and collates them with a past fraud case and a risk pattern. Regarding a personal information protection system, the generative AI analyzes a checklist and a rule document, and automatically determines suitability with laws and regulations and guidelines, comprehensiveness of information management rules, an implementation status of employee education, presence or absence of an information leakage countermeasure, an acquisition status of third-party certification, and the like. Regarding past business performance and a history of administrative guidance, the generative AI crawls an external database and a news article, extracts a past administrative disposition, a trouble case, a litigation history, contents of administrative guidance, presence or absence of an improvement report, an implementation status of a recurrence prevention measure, and the like, and evaluates a risk level. Regarding website description contents, the generative AI automatically crawls a website, and automatically determines authenticity of description contents, presence or absence of false advertising, a difference from past description contents, accuracy of explanation of a product/service, presence or absence of a legal violation, presence or absence of infringement of a third party's right, and the like. Regarding alliance partner information, the generative AI analyzes credit information of an alliance partner company, past transaction performance, a reputation in an industry, validity of alliance contents, contents of a contract, and the like, and evaluates a risk and a synergy effect. Regarding a business plan, the generative AI automatically summarizes contents of a business plan document, and analyzes validity of a sales target, reality of an investment plan, feasibility of a growth strategy, comprehensiveness of risk analysis, comparison with a past similar case, consistency with an industry trend, and the like. Specifically, the determination unit divides the integrated data frame for each modality, and inputs the divided data frames to corresponding neural network models. The determination unit normalizes a numerical array of the financial information, and inputs the normalized numerical array to a long short-term memory network in order to capture a time-series dependency relationship. The determination unit inputs a final hidden state vector of the long short-term memory network to a fully connected layer, and outputs a financial soundness score which is a continuous value from 0 to 100. The determination unit inputs text data extracted from the certificate of all historical matters to a pre-trained language model. The determination unit calculates an attention weight for each word token in the text, and extracts a feature vector indicating a specific event such as a representative change or a location change. The determination unit calculates a cosine similarity between the feature vector and a risk pattern vector generated from a past fraud case database. The determination unit sets a risk flag to 1 when the similarity exceeds a threshold value. The determination unit divides text data of the rule document in units of sentences, and converts each sentence into a sentence embedding vector. The determination unit calculates a pairwise similarity matrix with a vector of each provision of legal guidelines. The determination unit executes max pooling of the similarity matrix, and calculates a suitability score from 0 to 1 indicating comprehensiveness of rules. The determination unit applies a sentiment analysis model to text data of a news article or a website. The determination unit outputs a probability distribution of positive, negative, and neutral for the entire text. The determination unit executes a process of raising a risk level by one step when a negative probability exceeds a predetermined value. The determination unit inputs text data of the business plan document to a summarization model, extracts a main sentence, and generates a summarized text vector. The determination unit maps the summarized text vector to a vector space of a past success case and a failure case, and estimates a success probability using a k-nearest neighbor algorithm. The system combines a score, a flag, and a probability value output from each model into a single feature vector. The system inputs the feature vector to a gradient boosting decision tree algorithm, and calculates a final comprehensive evaluation score. The system converts a wide variety of unstructured data into a high-dimensional mathematical representation, and performs evaluation by a quantitative operation. The system brings about a technical effect of eliminating fluctuation in evaluation due to human subjectivity and ensuring objectivity and reproducibility of an examination. The system makes it possible to process a large number of projects at high speed and with high accuracy in use cases such as an examination of a franchise merchant and a preliminary examination of a project in crowdfunding.

For example, specific examples of a prompt sentence to be read by the generative AI include “Analyze the following financial statement data and score financial soundness compared with an industry average”, “Extract legitimacy of corporate status and a past risk factor from contents of the following certificate of all historical matters, and determine a risk level”, “Collate the following rule document regarding a personal information protection system with legal guidelines, and evaluate suitability”, “Crawl contents of the following corporate website, and determine presence or absence of false description or false advertising”, “Summarize the following business plan document, compare it with a past similar case, and analyze growth potential and a risk”, “Extract a negative topic or a flaming risk regarding a company name from the following SNS posting data, and calculate a risk score”, and the like. Specifically, the system dynamically constructs these prompt sentences in natural language on a memory as a system prompt interpretable by a large language model. The system converts a character string of the prompt sentence into an integer index array by a tokenizer. The system inputs the index array to an embedding layer, and converts each token into a multidimensional dense vector. The system similarly vectorizes a target input data group. For example, the system vectorizes a numerical array of financial statements and text data of an SNS posting. The system combines a vector sequence of the prompt and a vector sequence of the input data to generate a single input tensor. For example, the system receives a text string indicating that a product breaks easily as SNS posting data and a target company name as an input. The system tokenizes these texts, and combines them at the end of a token sequence of the prompt sentence. The system inputs the combined input tensor to a self-attention mechanism of a transformer model. The model calculates an attention weight between instruction contents of the prompt sentence and the input data to be high. The model outputs a floating-point number in a range of 0.0 to 1.0 indicating a flaming risk and extracted text serving as a basis thereof as an output of a final layer. For example, the model outputs a score of 0.85 and a character string indicating that a product breaks easily. The system passes the output floating-point number to a subsequent threshold determination module. The system converts a flexible instruction in natural language into a deterministic matrix operation process in a high-dimensional space. The system reduces a cost of developing and learning an individual dedicated model for each task. The system brings about a technical effect of executing diverse analysis tasks in parallel using a single foundation model. The system provides extremely high versatility and processing efficiency in use cases such as automatic classification of customer voices in customer support and quantitative measurement of a brand image in a marketing department.

The determination unit performs scoring for each of these items, executes comprehensive suitability determination, generates a detailed scoring result, data serving as a basis, a summary comment by AI, a comparison result with a past similar case, and the like, and transmits them to a result display unit on the terminal side. A notification unit notifies a user of a determination result, a reason for non-suitability, a risk alert, a request for additional information, feedback of an AI learning result, and the like in real time. For example, when financial soundness falls below a certain standard, when there is a serious history of administrative guidance in the past, when false description is recognized on a website, when a personal information protection system is insufficient, when a risk is recognized in an alliance partner, when a business plan is unrealistic, or the like, it is determined as non-suitable, and a reason thereof is automatically generated and notified to the terminal side. Specifically, the determination unit combines individual score groups output from each neural network model on a memory as a one-dimensional feature vector. The determination unit multiplies the feature vector by a pre-learned weight matrix. The determination unit calculates a weighted average score in consideration of importance of each item. The determination unit inputs the calculated weighted average score to a sigmoid function, and outputs a comprehensive suitability probability in a range of 0 to 1. The determination unit sets a non-suitability flag in a register on the memory when the comprehensive suitability probability is less than a preset threshold value. For example, the determination unit performs determination with a threshold value of 0.7. The determination unit specifies an element most deviating from the threshold value in the feature vector when the non-suitability flag is set. For example, the determination unit specifies a financial soundness score as a main factor. The determination unit inputs an identifier of the specified element to a natural language generation model. The determination unit dynamically generates a text string explaining a reason for non-suitability. For example, the determination unit generates a character string indicating that a financial soundness score was 42, which is below a reference value of 50. The determination unit serializes the score, the flag, and the generated text string as a JSON object. The determination unit transfers the JSON object to the notification unit. The notification unit analyzes the received JSON object. The notification unit asynchronously push-transmits the data via a persistent TCP connection established with a user terminal. The system automatically converts a result of complex multivariate analysis into structured data and natural language text that can be immediately understood by a human. The system eliminates a cognitive load for a person in charge of examination to interpret a huge amount of raw data. The system has a technical effect of completing a feedback loop of an examination result in milliseconds. The system realizes strict risk management without impairing user experience in use cases such as an immediate examination in an online lending platform and an automatic background check at the time of platform registration of a gig worker.

A mapping unit automatically classifies information by a plurality of attributes such as a suitability determination result and a risk evaluation result by the determination unit, a region of a company, an industry, a transaction scale, a risk level, an attribute of an alliance partner, contents of a business plan, presence or absence of a history of administrative guidance, a possession status of intellectual property, a scale of the number of employees, a scale of capital, and a number of years of establishment, generates a corporate map by diverse visualization methods such as a graph structure, on a map, a heat map, a network diagram, a tree map, and a timeline, and enables a person in charge of each department to refer to the corporate map in real time through the result display unit on the terminal side. For example, a corporate map is automatically generated from various perspectives, such as a group of companies in an IT industry in the Kanto region with an annual turnover of 1 billion yen or more and a low risk level, a group of companies having a history of administrative guidance in the past but determined to have been improved at present, a group of growth companies possessing a large number of intellectual properties, and a group of startup companies established less than three years ago. Specifically, the mapping unit loads multidimensional attribute data of each company extracted from a database into an in-memory data frame. The mapping unit parses a filtering condition transmitted from the user terminal. For example, the mapping unit parses a condition that a region is Kanto, an industry is IT, an annual turnover is 1 billion or more, and a risk score is less than 0.3. The mapping unit applies a logical product operation to the data frame, and extracts a subset of a corporate record matching the condition at high speed. The mapping unit dynamically generates a data structure corresponding to a designated visualization method using data of the extracted subset. For example, when generating a network diagram, the mapping unit constructs an adjacency matrix using a company as a node and a transaction relationship or a capital relationship between companies as an edge. The mapping unit applies an eigenvector centrality algorithm to the adjacency matrix, and calculates an importance score of each node. The mapping unit determines a drawing size of a node in accordance with the importance score. The mapping unit allocates an RGB color code of a node in accordance with a risk level. The mapping unit generates graph data in a JSON format including these drawing parameters, and transmits the graph data to the terminal. The result display unit on the terminal side renders the received graph data on a canvas using a WebGL library. The system dynamically recalculates and redraws corporate data on a scale of tens of thousands of cases in milliseconds in accordance with an interactive operation of a user. The system visually reveals a hidden relationship between companies, which is difficult to discover in a static report, and uneven distribution of risks in a specific segment. The system brings about a technical effect of dramatically improving efficiency of data exploration. The system provides a data-driven decision-making foundation in use cases such as monitoring of a macro systemic risk by a financial authority and optimization of a global supply chain in a multinational company.

An AI learning management unit continuously learns a determination result performed by the determination unit in the past, information newly acquired from the outside, presence or absence of occurrence of a trouble after an actual transaction, presence or absence of occurrence of administrative guidance, bankruptcy or merger of a business partner, growth performance, and the like, and improves determination accuracy of the generative AI. For example, when a company determined to be non-suitable in the past causes a problem at a later date, the case is taken in as learning data and reflected in a future determination standard. Even when there is a new legal revision or a change in industry guidelines, the AI learning management unit automatically acquires information and reflects the information in an algorithm of the determination unit. Specifically, the AI learning management unit ingests latest transaction data and an external event log into a data lake constructed in the system by daily batch processing. The AI learning management unit combines an input feature vector at a past determination time point and a subsequent actual event to construct a new teacher data set. For example, the AI learning management unit combines a binary flag indicating presence or absence of default within one year after the start of a transaction. The AI learning management unit executes fine tuning of a neural network model using the constructed teacher data set. The AI learning management unit performs backpropagation using a stochastic gradient descent method, and updates a weight matrix of the model. The AI learning management unit dynamically increases a weight of a penalty in a loss function for a false positive case in which a problem occurred despite being determined to be suitable in the past. The AI learning management unit adjusts a direction of learning so that the model does not repeat the same error. The AI learning management unit periodically polls an external official gazette database or an API of the Ministry of Justice. The AI learning management unit acquires text data of a new legal revision. The AI learning management unit tokenizes the acquired text data, and uses the tokenized text data as an additional pre-learning corpus of a large language model. The system eliminates conventional maintenance work in which a human engineer manually rewrites a rule-based conditional expression. The system establishes an autonomous model update pipeline based on data. The system has a technical effect of continuously and automatically adapting prediction accuracy of the system to an economic environment changing over time and a new fraud method. The system is extremely effective in a use case in which it is necessary to constantly continue learning a latest pattern in a hostile environment, such as a fraudulent use detection system of a credit card or a filtering system of spam mail.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

As an embodiment of the present invention, a merchant examination management system in an electronic payment service is configured by connecting a server and a terminal via a network. A plurality of functional modules such as an information acquisition unit, a determination unit, a mapping unit, a database management unit, an external cooperation unit, an AI learning management unit, a log management unit, and a security management unit are implemented on a server side, and a user interface unit, an input support unit, a result display unit, a notification unit, a file upload unit, a download unit, a user authentication unit, and the like are implemented on a terminal side. Specifically, the merchant examination management system adopts a distributed system architecture constructed on a cloud computing environment. The system deploys each functional module on the server side as an independent container. The system dynamically scales resource allocation of each module using a container orchestration tool. The system preferentially allocates a GPU instance to a module involving a high-load operation such as the information acquisition unit or the determination unit. The system realizes communication between respective modules by high-speed binary communication using a gRPC protocol. The system implements each unit on the terminal side as a single page application operating on a web browser. The system constructs a virtual DOM on a memory on the terminal side, and executes drawing update of a user interface with a minimum operation cost. The system executes mutual authentication using a digital certificate based on a public key cryptosystem in the user authentication unit. The system encrypts a data packet on a communication path by a TLS protocol. The system executes a token-based authorization check for all API requests in the security management unit. The system records all state transitions and data access histories in the system in a tamper-proof blockchain-based distributed ledger in the log management unit. The system eliminates a performance bottleneck caused by a monolithic system design. The system brings about a technical effect of ensuring high scalability and availability capable of processing merchant data on a scale of millions of cases. The system provides a robust and high-speed infrastructure in use cases such as a huge e-commerce platform deployed globally and a payment gateway service integrating a large number of mobile payment apps.

First, a user on the terminal side (for example, a person in charge of merchant examination, a person in charge of risk management, a person in charge of sales, a person in charge of legal affairs, a person in charge of accounting, a person in charge of system cooperation, a person in charge of audit, or the like) inputs or uploads a company name of a merchant candidate, a representative name, a location, a date of establishment, capital, a number of employees, business contents, financial statements for three past periods (a balance sheet, a profit and loss statement, and a cash flow statement), a certificate of all historical matters (PDF file or image file), a rule document regarding a personal information protection system (for example, a privacy policy, information management rules, and an employee education record), a written oath regarding exclusion of anti-social forces, a past history of fraudulent transactions and a history of administrative guidance, a URL of a corporate website, an industry classification, technical information for payment system cooperation (an API specification, security authentication information, a system configuration diagram, a communication protocol specification, an explanation of an encryption method, a sandbox test result, and the like) through the user interface unit. For example, financial statements are uploaded as an Excel file or a PDF, and a certificate of all historical matters is attached as an image file. Regarding a personal information protection system, it is input in a checklist format or a document file, and a written oath for exclusion of anti-social forces is submitted as a PDF with an electronic signature. Regarding technical information, an API specification, a system configuration diagram, details of a communication protocol, an explanation of an encryption method, an execution result report of a sandbox test, and the like are uploaded. Specifically, the user interface unit renders a dynamic input form on a display of the terminal. The user interface unit temporarily buffers text data input by a user or an uploaded binary file on a local memory of the terminal. The file upload unit executes verification of a MIME type and a malware scan in the background for a buffered file group. The file upload unit asynchronously transmits a file whose safety has been confirmed to the server as multipart form data. When receiving a PDF file with an electronic signature, the system executes cryptographic verification of a signature using a public key infrastructure. The system confirms integrity of a file using a hash function, and deterministically determines presence or absence of falsification. The system parses an API specification uploaded as technical information. For example, the system parses a YAML file in an OpenAPI format. The system expands a URL of an endpoint, a data type of a request parameter, and a response schema as a data structure on a memory. The system applies an object detection algorithm to an image file of a system configuration diagram. The system identifies a component such as a firewall, a load balancer, or a database, and extracts a network topology as graph data. The system automates preprocessing for converting unstructured and semi-structured data provided in a wide variety of formats into a unified internal representation processable by a subsequent machine learning model. The system has a technical effect of eliminating a human error at the time of data input and ensuring quality of data in an initial stage of an examination process. The system streamlines collection and verification of complex technical requirements in use cases such as a new token listing examination in a crypto asset exchange and a connection examination of a third-party provider using an open banking API.

An input support unit, for example, automatically suggests a past registered company name or a similar company name when a company name is input, presents a past representative list when a representative name is input, automatically complements an address from a postal code when a location is input, automatically extracts numerical data from a PDF or Excel when financial statements are uploaded, performs OCR processing from an image of a certificate of all historical matters, automatically generates a checklist of a personal information protection system, and also performs format conversion of an API specification and automatic analysis of a communication protocol. A file upload unit automatically determines a format of an uploaded file, performs text extraction from a PDF and OCR processing from an image as necessary, and achieves standardization of data. A user authentication unit includes a security function such as single sign-on or multi-factor authentication, controls an access authority for each department, and leaves an audit trail. Specifically, the input support unit transmits an asynchronous AJAX request to a server for each keystroke of a user. The input support unit executes high-speed character string matching using an N-gram index on an in-memory database on a server side. The input support unit returns a candidate list having a high similarity score to a terminal in milliseconds, and displays the candidate list as a drop-down menu. When an Excel file is uploaded, the input support unit analyzes a file header and decodes an OpenXML format. The input support unit extracts a numerical value such as sales or operating profit based on a specific cell address or a regular expression pattern, and converts the numerical value into floating-point array data. The input support unit inputs text data of an API specification to a parser. The input support unit automatically determines a protocol type such as REST or GraphQL, and converts the protocol type into an internal standardized JSON schema. The user authentication unit cooperates with an external identity provider using a SAML or OAuth 2.0 protocol. The user authentication unit issues a JWT including access authority information upon successful authentication of a user. The user authentication unit verifies a signature of a JWT included in an HTTP header in all subsequent API requests. The user authentication unit records a timestamp of a request, an IP address, and executed operation contents in an audit log database having a hash chain structure in an append-only manner. The system not only reduces physical effort of data input, but also forcibly normalizes a format of input data at a system level. The system brings about a technical effect of dramatically reducing an occurrence rate of a parse error or exception processing in a subsequent data processing pipeline. The system simultaneously ensures accuracy and security of data in use cases such as data input support of an electronic medical record system in a medical institution and automatic processing of various application forms in an administrative agency.

The information input from the terminal is transmitted to the information acquisition unit on the server side. In addition to the information received from the terminal, the information acquisition unit automatically collects related information from an internal existing merchant database, a past examination history, a transaction performance database, a contract database of a legal department, a financial database of an accounting department, a system cooperation history database, an audit record database, and the like. For example, for duplication confirmation with an existing merchant, a search is performed using a company name, a representative name, a location, a date of establishment, and the like as keys, and whether or not the same or a similar merchant has been registered in the past is automatically extracted. From the past examination history and transaction performance, a history of occurrence of fraudulent transactions and troubles in the past, a background of contract cancellation and transaction suspension, audit indication items, and the like are also extracted. Furthermore, via the external cooperation unit, a credit rating and a financial score from a database of a credit research agency, a history of administrative guidance and a history of legal violations from public information of an administrative agency, a reputation and word of mouth from a corporate information site and a news site on the Internet, an appearance frequency of a company name and a co-occurrence rate with a negative word from an SNS, a membership qualification and a reputation in an industry from an industry group, a possession status and an application status of intellectual property from a patent information database, past system incident information from a vulnerability information database related to cybersecurity, and the like are automatically acquired. For example, a flaming risk of a company name on an SNS, a past history of administrative guidance, an expulsion history from an industry group, the number of patent applications and contents of possessed patents, a cyber attack damage history, presence or absence of a vulnerability report, and the like are also automatically collected. Specifically, the information acquisition unit activates a plurality of data collection worker processes via a distributed messaging system. The information acquisition unit executes a normalization process for absorbing character fluctuations on the input character string of the company name or the representative name. For example, the information acquisition unit normalizes a difference between full-width and half-width characters and a notation fluctuation of a joint-stock company. The information acquisition unit hashes the normalized character string and executes a search in constant time against an index of an existing database. The information acquisition unit extracts time-series numerical values such as a chargeback occurrence rate and a payment cancellation rate from the past transaction performance database, and expands them on a memory as a multidimensional time-series tensor. The external cooperation unit transmits a domain name of a target company and an identifier of a software stack in use as a query to the vulnerability information database related to cybersecurity. The external cooperation unit acquires a list of returned vulnerability scores, calculates a maximum value and an average value, and stores them in a feature vector. The external cooperation unit connects to a streaming API of an SNS and acquires posted text including the target company name in real time. The external cooperation unit inputs the acquired text to a natural language processing model and calculates an emotional polarity score. For example, the external cooperation unit calculates a continuous value from minus 1.0 to plus 1.0. The external cooperation unit calculates a moving average of negative scores within a certain period of time, and sets a flaming risk flag when a threshold is exceeded. The system integrates internal structured data and external unstructured data into a single high-dimensional data space using a common identifier as a key. The system has a technical effect of amplifying a minute risk signal that may be overlooked in a single data source by cross-validation of a plurality of data sources, and making it detectable. The system functions as a comprehensive threat intelligence infrastructure in use cases such as an anti-money laundering check in a virtual currency exchange and a security examination of a new tenant in a cloud service provider.

The huge amount of information collected by the information acquisition unit is transmitted to the determination unit on the server side. The determination unit executes analysis and determination of various types of information using generative AI. For example, regarding financial information, the generative AI automatically reads financial statements for three past periods, automatically calculates sales, profit, an equity ratio, presence or absence of insolvency, soundness of cash flow, a turnover period of accounts receivable and accounts payable, an increase or decrease in fixed assets, contents of investment activities, a transition of short-term borrowings and long-term borrowings, an increase or decrease in inventory assets, presence or absence of tax delinquency, and the like, and scores financial soundness by comparing them with an industry average and past merchant data. Regarding a certificate of all historical matters, the generative AI automatically analyzes contents using OCR and natural language processing, extracts legitimacy of corporate status, a change history of a representative, description contents of a purpose column, an increase or decrease history of capital, a change history of a location, a record of dissolution and liquidation, a history of merger, division, and business transfer, and the like, and collates them with past fraud cases and risk patterns. Regarding a personal information protection system, the generative AI analyzes a checklist and a rule document, and automatically determines suitability with laws and guidelines, comprehensiveness of information management rules, an implementation status of employee education, presence or absence of information leakage countermeasures, an acquisition status of third-party certification (information security certification, PrivacyMark (registered trademark), etc.), presence or absence of outsourcer management, a maintenance status of a personal information management ledger, and the like. Regarding exclusion of anti-social forces, presence or absence of a risk is determined by collating contents of a written oath and an external database, and for example, collation with an anti-social force list and matching with a past administrative disposition history are also performed. Regarding a past history of fraudulent transactions and a history of administrative guidance, the generative AI crawls an external database and a news article, extracts a past administrative disposition, a trouble case, a litigation history, contents of administrative guidance, presence or absence of an improvement report, an implementation status of recurrence prevention measures, a frequency of administrative guidance, severity of contents, and the like, and evaluates a risk level. Regarding website description contents, the generative AI automatically crawls a website, and automatically determines authenticity of description contents, presence or absence of exaggerated advertising, a difference from past description contents, accuracy of explanation of products and services, presence or absence of legal violations, presence or absence of infringement of third-party rights, presence or absence of false representation and violation of the Act against Unjustifiable Premiums and Misleading Representations, and the like. Regarding an industry risk, the AI determines whether or not the industry is a high-risk industry by referring to a fraud occurrence rate and an administrative guidance occurrence rate of the entire industry, a past merchant trouble occurrence rate, an expulsion rate from an industry group, a legal regulation risk peculiar to the industry, social credibility, and the like. Regarding suitability of payment system cooperation, technical information and an API specification are analyzed, and compatibility with an existing payment system, a fulfillment status of security requirements, strength of an encryption method, standard compliance of a communication protocol, pass/fail of a sandbox test, a past system failure history, presence or absence of an external vulnerability report, and the like are automatically determined. For example, description contents of the API specification and specifications on a payment service side are automatically collated, the AI automatically determines compatibility and presence or absence of a security hole, and a log of the sandbox test is analyzed to detect presence or absence of unauthorized communication and an abnormal response. Specifically, the determination unit inputs the collected wide variety of data to a multimodal neural network based on a transformer architecture. The determination unit inputs a numerical array of financial information to a multilayer perceptron, and generates a 64-dimensional financial feature vector. The determination unit inputs text data of the certificate of all historical matters and the rule document to a large language model, and generates a 256-dimensional text feature vector. The determination unit parses structured text of the API specification as a syntax tree, inputs it to a graph neural network, and generates a 128-dimensional technical feature vector. The determination unit inputs a communication log of the sandbox test to a one-dimensional convolutional neural network, and extracts a feature vector indicating an abnormal communication pattern. For example, the determination unit inputs a time-series array of HTTP status codes and a distribution of response times. The determination unit combines the feature vectors obtained from these respective modalities, and constructs a single high-dimensional integrated tensor. The determination unit inputs the integrated tensor to a final classification layer provided with a self-attention mechanism. The classification layer calculates a complex non-linear interaction between the respective features. For example, the classification layer is trained with weights so as to output an exponentially higher risk score when a feature that financial soundness is low and a feature that an encryption method of an API is old exist simultaneously than when they exist independently. The determination unit outputs a probability value from 0.0 to 1.0 indicating eligibility as a merchant and an individual score for each risk category as a final output. The system formulates a comprehensive risk evaluation across a plurality of areas, which has been intuitively performed by a human examiner, as a mathematical tensor operation in a high-dimensional space. The system dramatically improves accuracy and consistency of examination. The system brings about a technical effect of shortening time required for examination from several weeks to several minutes. The system automates a judgment requiring a high degree of expert knowledge and supports construction of a secure ecosystem in use cases such as an API cooperation examination of a new service in a fintech company and a security audit of a participating institution in a medical data sharing platform.

The determination unit performs scoring for each of these items, executes a comprehensive suitability determination, generates a detailed scoring result, basis data, a summary comment by the AI, a comparison result with a past similar case, and the like, and transmits them to a result display unit on the terminal side. For example, when financial soundness falls below a certain standard, when there is a serious history of administrative guidance in the past, when a false description is recognized on a website, when a personal information protection system is insufficient, when an anti-social force risk is detected, when an industry risk is high, when there is a technical problem in payment system cooperation, when a sandbox test is failed, when an external vulnerability report exists, or the like, it is determined as non-suitable, and the reason is automatically generated and notified to the terminal side. Conversely, when all items satisfy the standards, it is determined that registration as a merchant is possible, and a registration process is executed. Specifically, the determination unit inputs the output comprehensive suitability probability and the individual score of each category to a rule engine expanded on a memory. The rule engine evaluates whether or not each score satisfies a predetermined threshold condition by a logical operation in accordance with a predefined decision tree logic. When a fatal risk is detected in any category, the determination unit executes a short-circuit evaluation that immediately confirms the comprehensive determination as non-suitable. For example, the determination unit executes the short-circuit evaluation when an anti-social force risk score is 0.9 or more, or when a fatal error flag of the sandbox test is 1. When determined as non-suitable, the determination unit specifies an element of a feature vector that triggered the determination. The determination unit inputs an identifier of the specified element to a natural language generation model, and generates text of a specific reason for non-suitability. For example, the determination unit generates a character string that a deprecated algorithm is used for an authentication method of an API and a security standard is not satisfied. When scores of all items clear thresholds, the determination unit sets the comprehensive determination as suitable. When a suitability determination is made, the determination unit automatically issues an INSERT query to a merchant master table to a database management unit. The determination unit asynchronously transmits an issuance request for an API key for a production environment for a new merchant to an API of a payment gateway. The system automates from generation of a determination result to a subsequent system registration process end-to-end without human intervention. The system realizes complete straight-through processing of a business process. The system has a technical effect of reducing an operation cost to the utmost limit and minimizing a lead time required for onboarding of a new merchant. The system provides an indispensable automation infrastructure supporting a business scale in use cases such as a rapidly growing electronic payment platform and an examination process of an app store having a large number of third-party developers.

The registered merchant information is automatically classified by a mapping unit on the server side for each of a plurality of attributes such as an industry, a region, a transaction scale, a risk level, a payment system cooperation status, presence or absence of a history of administrative guidance, a possession status of intellectual property, a scale of the number of employees, a scale of capital, the number of years of establishment, a cybersecurity risk level, and a past system failure history. For example, a merchant map is automatically generated from various perspectives, such as a group with a high risk level among merchants in a restaurant industry, a group in which payment system cooperation has been completed in an IT industry, a group determined to have been improved at present although having a history of administrative guidance in the past, a growth company group possessing a large amount of intellectual property, a startup merchant group established less than three years ago, a merchant group with a high cybersecurity risk, and a merchant group that has caused a system failure a plurality of times in the past. The mapping unit displays such information by diverse visualization methods such as a graph structure, on a map, a heat map, a network diagram, a tree map, a timeline, a risk heat map, and a cybersecurity risk map, and enables a person in charge of each department to refer to the information in real time through the result display unit on the terminal side. For example, a person in charge of risk management can confirm a merchant distribution of a high-risk industry with a heat map, a person in charge of sales can confirm a merchant distribution in a new development area on a map, a person in charge of legal affairs can confirm a time-series transition of a merchant having a history of administrative guidance with a timeline, and a person in charge of a system can confirm a merchant with a high cybersecurity risk with a risk map. Specifically, the mapping unit executes a clustering algorithm using a high-dimensional vector space. The mapping unit converts merchant information into a multidimensional feature vector. The mapping unit converts industry information into binary vector data by a one-hot encoding method. The mapping unit logarithmically converts continuous value data such as capital and the number of employees, and performs a normalization process. The mapping unit combines these feature amounts to generate a single merchant tensor. The mapping unit dimensionally compresses the generated merchant tensor into two-dimensional or three-dimensional spatial coordinates using principal component analysis or a t-distributed stochastic neighbor embedding method. The mapping unit calculates a similarity between merchants as a Euclidean distance or a cosine similarity based on the dimensionally compressed coordinate data. The mapping unit executes a k-means method or hierarchical clustering based on the calculated similarity. The mapping unit constructs a clustering result as graph structure data on a memory. The mapping unit defines a node as an individual merchant. The mapping unit defines an edge as a transaction relationship or similarity between merchants. The mapping unit performs an operation of making a drawing size of a node proportional to a capital scale. The mapping unit changes a drawing color of a node with a gradation from red to blue in accordance with a cybersecurity risk level. The mapping unit inputs the graph structure data to a drawing engine. The drawing engine executes a rendering process in real time using a hardware acceleration function of a parallel arithmetic processor. The system transmits the rendering result to the result display unit on the terminal side via a network. The system directly visualizes a mathematical relationship of high-dimensional data without depending on a human visual cognitive process. Thereby, the system clarifies a complex risk structure that cannot be intuitively grasped by a human. The system dramatically improves a processing speed of data analysis. The system optimizes memory consumption. The system is applied to a merchant examination operation in a financial institution and a store opener management operation in an electronic commerce platform business operator as specific application fields. The system enables a person in charge of risk management to instantly specify a distribution of a high-risk industry. The system supports a person in charge of sales to discover a blank zone in a new development area in a data-driven manner. The system enables a person in charge of legal affairs to read a chain influence of a past history of administrative guidance from a network diagram. The system supports a person in charge of a system to visually specify a vulnerable node group that is likely to be a target of a cyber attack. The mapping unit receives an interactive operation from a user. When a specific node is selected, the mapping unit acquires detailed attribute information related to the node from a database by asynchronous communication. The mapping unit superimposes and displays the acquired information as a pop-up window. The mapping unit dynamically adjusts a resolution of rendering in accordance with a change operation of a display magnification. Thereby, the mapping unit seamlessly switches between a wide-area bird's-eye view display and a local detailed display. The mapping unit includes an animation display function based on time-series data. The mapping unit dynamically draws a growth process and a risk transition of a merchant from the past to the present along a timeline. Thereby, the mapping unit extracts a sign of a temporal change that tends to be overlooked in static data analysis. The system intensively executes these advanced visualization processes on the server side. The system significantly reduces a calculation load on the terminal side. The system guarantees comfortable operability even from a low-spec terminal.

Furthermore, an AI learning management unit on the server side continuously learns a determination result made by the determination unit in the past, information newly acquired from the outside, presence or absence of occurrence of a trouble after an actual transaction, presence or absence of occurrence of administrative guidance, bankruptcy or merger of a merchant, a growth performance, presence or absence of occurrence of cyber attack damage, presence or absence of occurrence of a system failure, and the like, and improves determination accuracy of the generative AI. For example, when a merchant determined to be non-suitable in the past causes a problem at a later date, the case is taken in as learning data and reflected in a future determination standard. Even when there is a new legal revision or a change in an industry guideline, the AI learning management unit automatically acquires information and reflects it in an algorithm of the determination unit. The AI learning management unit matches a past determination result with an actual post-risk occurrence status, and continuously executes optimization of a determination logic. For example, past system cooperation information and a vulnerability report of a merchant where cyber attack damage has occurred are learned and reflected in a future cyber risk determination. Specifically, the AI learning management unit constructs a continuous learning pipeline on a server. The AI learning management unit automatically generates teacher data in which a past determination result and actual post-data are paired. The AI learning management unit acquires a trouble occurrence flag and an administrative guidance flag within a certain period from the start of a transaction as binary data as the post-data. The AI learning management unit format-converts the teacher data as a data set for fine-tuning of a large language model. The AI learning management unit constructs a text sequence including attribute information of a merchant and a past system cooperation log as input data. As a specific example of the input data, the AI learning management unit receives numerical data that capital is ten million yen and text data that a vulnerability of cross-site scripting has been reported in the past. The AI learning management unit defines a continuous value from zero to one indicating a risk occurrence probability and a text token string explaining a risk factor as output data. As a specific example of the output data, the AI learning management unit outputs a numerical value that a cyber attack damage probability is 0.85 and an explanatory text that encryption strength of an authentication system is insufficient. The AI learning management unit updates a weight parameter of a neural network using an error backpropagation method. The AI learning management unit adopts a cross-entropy error or a mean square error as a loss function. The AI learning management unit uses an adaptive moment estimation method as an optimization algorithm. The AI learning management unit executes a gradient descent method while dynamically adjusting a learning rate. The AI learning management unit applies a dropout process and a weight decay process in order to prevent overlearning. When new legal revision information is input, the AI learning management unit updates an external knowledge base using a retrieval-augmented generation technology. Thereby, the AI learning management unit applies the latest determination standard to an inference process without waiting for relearning of the model itself. As a subsequent process, the AI learning management unit deploys the updated weight parameter to an inference engine of the determination unit. The AI learning management unit executes accuracy evaluation of the model using a verification data set before deployment. The AI learning management unit permits application to a production environment only when accuracy exceeds a certain threshold. The system eliminates a conventional examination method depending on a human rule of thumb. The system continuously improves determination accuracy by a data-driven self-evolution mechanism. The system dramatically increases a detection rate for an unknown cyber attack pattern and a new fraud method. The system brings about a technical effect of preventing obsolescence of a model while suppressing consumption of calculation resources. The system is applied to a merchant management system of a credit card company and a store opener examination system of an electronic commerce platform as specific application fields. The system realizes dynamic risk scoring for preventing post-risk occurrence. The AI learning management unit introduces an algorithm of reinforcement learning. The AI learning management unit receives whether an action based on a determination result has succeeded or failed as a reward signal. The AI learning management unit optimizes the model using a policy gradient method so as to maximize a reward. The AI learning management unit preferentially extracts data in a boundary region where the model is at a loss for determination using an active learning method. The AI learning management unit presents the extracted data to a human expert and requests annotation. The AI learning management unit immediately incorporates feedback of the expert into learning data. Thereby, the AI learning management unit efficiently improves performance of the model with a small amount of data. The AI learning management unit executes a learning process in parallel at a plurality of arithmetic nodes using a distributed learning framework. The AI learning management unit significantly shortens a learning time and enables model update on a daily or hourly basis.

A database management unit unitarily manages all merchant information, a determination result, scoring data, mapping data, AI learning data, a user operation log, an external cooperation history, cybersecurity incident information, and the like, and stores them as an audit trail. A log management unit records all operation histories, data acquisition histories, determination histories, mapping histories, system cooperation histories, cybersecurity incident histories, and the like in detail, and enables an audit department and a compliance department to refer to them at a later date. A security management unit implements data encryption, access authority management, unauthorized access detection, data backup, a recovery function at the time of failure occurrence, cyber attack detection, abnormal communication detection, and the like, and ensures safety and reliability of the entire system. Specifically, the database management unit adopts a hybrid configuration combining a relational database and a non-relational database. The database management unit stores basic attributes and a scoring result of a merchant, which are structured data, in a table of the relational database. The database management unit stores a PDF file, image data, and long text generated by AI, which are unstructured data, in a document-oriented non-relational database. The database management unit automatically constructs a B-tree index and a hash index for a frequently searched column in order to improve a search speed. The database management unit executes distributed transaction control using a two-phase commit protocol in order to guarantee data consistency. The log management unit converts all events occurring in the system into a structured log format. The log management unit adds a time stamp, a user identifier, a session identifier, an operation type, and a target resource identifier to log data. The log management unit asynchronously transfers the generated log data to a log collection server via a message queuing system. The log management unit constructs an index of a full-text search engine on the log collection server. Thereby, the log management unit enables searching for a specific audit trail from hundreds of millions of pieces of log data in units of milliseconds. In order to prevent falsification of a log, the log management unit applies a hash chain technology of calculating a hash value of each log entry and concatenating it with a hash value of an immediately preceding log entry to generate a new hash value. The security management unit encrypts all stored data using an advanced encryption standard algorithm. The security management unit strictly manages an encryption key in a dedicated hardware security module. The security management unit encrypts all communication data flowing on a network using a transport layer security protocol. Based on a concept of a zero trust architecture, the security management unit always requests authentication and authorization even for access from an internal network. The security management unit implements an abnormality detection model using machine learning. The security management unit acquires a time-series vector such as a login time of a user, an IP address of an access source, an operation frequency, and a data transfer amount as input data. The security management unit detects an abnormal access pattern deviating from a normal behavior in real time by a neural network using an autoencoder. When detecting an abnormality, the security management unit immediately disconnects the session and executes a subsequent process of transmitting an alert to an administrator. The system reduces an information leakage risk to the utmost limit by these technical processes. The system maintains availability and integrity of the system at a high level. The system is applied to a core system of a financial institution requiring strict compliance and a database management system of a government agency handling confidential information as specific application fields. The system significantly reduces a human cost required for audit response. The system exhibits a technical effect of strengthening resilience against a cyber attack.

On the terminal side, a user interface unit integrally provides an input support function, an automatic complement function, a file upload function, a result display function, a notification function, a download function, a user authentication function, and the like. For example, a suitability determination result and a reason for non-suitability transmitted from the determination unit, visualization information of a merchant map, a summary comment by AI, a risk alert, a request for additional information, a cybersecurity risk alert, and the like are displayed in an easy-to-understand manner, and can be downloaded in a PDF or Excel format as necessary. A notification unit notifies a user of a determination result, a request for additional information, a risk alert, feedback of an AI learning result, an emergency notification at the time of occurrence of a cyber incident, and the like in real time. Specifically, the user interface unit is implemented as a single-page application operating on a web browser. The user interface unit adopts a component-oriented design of a front end, and manages each screen element as an independent module. The user interface unit unitarily holds a data state of the entire application using a state management library. The user interface unit redraws only a difference of a screen at high speed using a virtual document object model. Thereby, the user interface unit reduces the number of times of communication with a server and minimizes a delay of screen transition. An input support function of the user interface unit transmits a query to the server using asynchronous communication every time a user inputs a character in a text box. The user interface unit immediately displays a candidate list returned from the server as a drop-down menu. A file upload function of the user interface unit divides a large-capacity file into a plurality of small chunks. The user interface unit transmits the divided chunks to the server in parallel. The user interface unit includes a resume function of resuming upload from an untransmitted chunk even when network disconnection occurs. The notification unit establishes a WebSocket connection, which is a bidirectional communication protocol, with the server. The notification unit receives a payload of a push notification at the moment when risk determination is completed on the server side. The notification unit analyzes the received payload and pop-up displays it as a toast notification at a lower right part of the screen. In the case of a highly urgent cyber incident notification, the notification unit displays a modal window covering the entire screen and forces a confirmation operation of the user. A download function of the user interface unit receives binary data generated on the server side as a blob object on a memory. The user interface unit generates a temporary download URL from the blob object, and causes the user to store a file in a local storage. A user authentication function cooperates with an external identity provider using an open authentication protocol. The user authentication function requests multi-factor authentication using biometric authentication or a one-time password in addition to password input. The system significantly reduces an input load of the user by these technical processes. The system prevents an erroneous input due to a human error. The system accelerates a decision-making speed of a business by real-time information transmission. The system is applied to a large-scale business support system accessed by a large number of persons in charge simultaneously and a secure information sharing platform under a remote work environment as specific application fields. The system brings about a technical effect of achieving both intuitive operability and high security. The user interface unit adopts a responsive design, and provides a layout automatically optimized for diverse screen sizes such as a tablet terminal and a smartphone as well as a personal computer. The user interface unit complies with an accessibility standard, and supports voice reading by a screen reader and an operation only with a keyboard.

As described above, in the present embodiment, main functions such as an information acquisition unit, a determination unit, a mapping unit, an AI learning management unit, a database management unit, an external cooperation unit, a log management unit, and a security management unit are realized on the server side, and functions such as a user interface unit, an input support unit, a result display unit, a notification unit, a file upload unit, a download unit, and a user authentication unit are realized on the terminal side. Generative AI is incorporated as an essential component in the determination unit and the AI learning management unit on the server side, and is utilized one by one for processes such as analysis, determination, learning, summarization, comparison, visualization, and cyber risk evaluation of various types of information. For example, by combining diverse functions of the generative AI such as document analysis by natural language processing, extraction of certificate contents by image recognition, risk evaluation by abnormality detection, automatic summarization of a business plan by summary generation, presentation of a determination basis by similar case search, automatic crawling and summarization of external information, trend analysis of time-series data, visualization of an alliance structure by network analysis, and automatic learning of a cyber attack pattern and risk score calculation, highly accurate and efficient merchant examination management, which has been difficult to realize by conventional manual work, can be realized. Specifically, the system containerizes each functional module on the server side as an independent microservice. The system dynamically allocates calculation resources in accordance with a load status of each microservice using a container orchestration tool. The system installs an application programming interface gateway, and routes all requests from a terminal to an appropriate microservice. The system constructs a dedicated arithmetic cluster equipped with a large number of parallel arithmetic processors in order to speed up an inference process of the generative AI. The system adopts a large language model having billions to hundreds of billions of parameters and a multimodal model capable of simultaneously processing an image and text as a model of the generative AI. The system acquires text data of a business plan of a merchant and an appearance image tensor of a store as input data. As a specific example of the input data, the system receives text of 5,000 characters regarding future business development and RGB image data with a resolution of 1024 pixels square. The system generates a score indicating feasibility of a business and facility information of a store extracted from an image as structured data as output data. As a specific example of the output data, the system outputs a numerical value that a feasibility score is 0.92 and a text label that a security camera is installed. As a subsequent process, the system transmits these output data to the database management unit, and uses them for calculation of a comprehensive evaluation score of the merchant. In document analysis by natural language processing, the system utilizes a self-attention mechanism of a transformer architecture to accurately capture a context of a long sentence. In image recognition, the system extracts a fine feature such as an imprint and a watermark pattern of a certificate using a convolutional neural network. In abnormality detection, the system calculates a reconstruction error of new data using a latent space model learned from past normal transaction data, and determines data whose error exceeds a threshold as a risk. The system connects these plurality of AI models as a pipeline, and executes multifaceted analysis on one piece of input data in parallel. The system instantly processes a huge amount of information exceeding a limit of human cognitive ability. The system dramatically shortens a lead time of an examination operation from several weeks to several minutes. The system eliminates fluctuation of personal judgment and ensures objective and homogeneous examination quality. The system is applied to a merchant onboarding process of a payment agency business operator expanding globally and a procurement source evaluation system of a manufacturing industry having a large number of suppliers as specific application fields. The system exhibits a technical effect of improving processing efficiency of a computer technology itself and providing an advanced information processing infrastructure.

### (System Configuration)

A system according to the present embodiment comprises an information acquisition unit, a determination unit, a mapping unit, a database management unit, an external cooperation unit, an AI learning management unit, a log management unit, a security management unit, a user interface unit, an input support unit, a result display unit, a notification unit, a file upload unit, a download unit, and a user authentication unit. The information acquisition unit receives a company name of a merchant candidate, a representative name, a location, a date of establishment, capital, a number of employees, business contents, financial statements for three past periods, a certificate of all historical matters, a rule document regarding a personal information protection system, a written oath regarding exclusion of anti-social forces, a past history of fraudulent transactions and a history of administrative guidance, a URL of a corporate website, an industry classification, and technical information for payment system cooperation (an API specification, security authentication information, a system configuration diagram, a communication protocol specification, an explanation of an encryption method, a sandbox test result, etc.) from a terminal, and further automatically collects related information from an internal existing merchant database, a past examination history, a transaction performance database, a contract database of a legal department, a financial database of an accounting department, a system cooperation history database, an audit record database, and the like. For example, the information acquisition unit performs a search using a company name, a representative name, a location, and a date of establishment as keys for duplication confirmation with an existing merchant, extracts a history of occurrence of fraudulent transactions and troubles, a background of contract cancellation and transaction suspension, and audit indication items from a past examination history and transaction performance, and further automatically acquires a credit rating and a financial score from a database of a credit research agency, a history of administrative guidance and a history of legal violations from public information of an administrative agency, a reputation and word of mouth from a corporate information site and a news site on the Internet, an appearance frequency of a company name and a co-occurrence rate with a negative word from an SNS, a membership qualification and a reputation in an industry from an industry group, a possession status and an application status of intellectual property from a patent information database, past system incident information from a vulnerability information database related to cybersecurity, and the like via the external cooperation unit. For example, a flaming risk of a company name on an SNS, a past history of administrative guidance, an expulsion history from an industry group, the number of patent applications and contents of possessed patents, a cyber attack damage history, presence or absence of a vulnerability report, and the like are also automatically collected. Specifically, the information acquisition unit implements a distributed crawler system that asynchronously and in parallel collects data from diverse data sources. The information acquisition unit passes input data received from the terminal to a normalization processing module. The normalization processing module executes unification of full-width and half-width characters, deletion of an unnecessary blank, and standardization of a date format. The information acquisition unit issues an SQL query to an internal database using the normalized company name and representative name as search keys. The information acquisition unit specifies a similar company including a notation fluctuation at high speed using a Levenshtein distance and an N-gram method as a fuzzy search algorithm. The information acquisition unit transmits a data acquisition request to the external cooperation unit. The external cooperation unit calls a RESTful application programming interface provided by a credit research agency. The external cooperation unit uses an OAuth protocol as an authentication method, and establishes a secure communication path. For a website of an administrative agency, the external cooperation unit controls a headless browser, analyzes a dynamically generated document object model tree, and scrapes necessary text data. In data acquisition from a social networking service, the information acquisition unit connects to a streaming application programming interface and collects posted data in real time. The information acquisition unit applies natural language processing to the collected text data, and divides it into words using a morphological analysis engine. The information acquisition unit collates with a dictionary of words having a negative emotional polarity, and counts a co-occurrence frequency with a company name. From a patent information database, the information acquisition unit parses patent publication data provided in an XML format, and extracts an applicant name, a title of invention, and an international patent classification code. From a database related to cybersecurity, the information acquisition unit acquires data in a JSON format including a common vulnerability identifier. The information acquisition unit stores all the collected information in a graph database in which a company is a node and a relationship of information is an edge. The system improves comprehensiveness and a speed of data collection by orders of magnitude by these technical processes as compared with a case where a human manually searches and collects data. The system prevents siloing of information, and constructs distributed data inside and outside a company as one integrated knowledge graph. The system is applied to an automatic information collection system in a credit management department of a company and a due diligence support system in an investment fund as specific application fields. The system exhibits a technical effect of eliminating a bottleneck of information collection in an initial stage of examination and providing high-quality input data to a subsequent AI determination process.

The determination unit inputs all the information collected by the information acquisition unit into the generative AI, and executes analysis and determination of various types of information. For example, regarding the financial information, the determination unit causes the generative AI to automatically read financial statements for three past periods, automatically calculate sales, profit, an equity ratio, presence or absence of insolvency, soundness of cash flow, a turnover period of accounts receivable and accounts payable, an increase or decrease in fixed assets, contents of investment activities, a transition of short-term borrowings and long-term borrowings, an increase or decrease in inventory assets, presence or absence of tax delinquency, and the like, and score financial soundness by comparing them with an industry average and past merchant data. Regarding the certificate of all historical matters, the generative AI automatically analyzes contents using OCR and natural language processing, extracts legitimacy of corporate status, a change history of a representative, description contents of a purpose column, an increase or decrease history of capital, a change history of a location, a record of dissolution or liquidation, a history of merger, split, and business transfer, and the like, and collates them with past fraud cases and risk patterns. Regarding the personal information protection system, the generative AI analyzes a checklist and a rule document, and automatically determines suitability with laws and guidelines, comprehensiveness of an information management rule, an implementation status of employee education, presence or absence of an information leakage countermeasure, an acquisition status of third-party certification, presence or absence of contractor management, a maintenance status of a personal information management ledger, and the like. Regarding the exclusion of anti-social forces, presence or absence of a risk is determined by collating contents of a written oath and an external database, and for example, collation with an anti-social force list and matching with a past history of administrative disposition are also performed. Regarding the past history of fraudulent transactions and the history of administrative guidance, the generative AI crawls an external database and a news article, extracts a past administrative disposition, a trouble case, a litigation history, contents of administrative guidance, presence or absence of an improvement report, an implementation status of a recurrence prevention measure, a frequency of administrative guidance, severity of contents, and the like, and evaluates a risk level. Regarding the website description contents of a company, the generative AI automatically crawls a website, and automatically determines authenticity of description contents, presence or absence of false advertising, a difference from past description contents, accuracy of explanation of a product or service, presence or absence of a legal violation, presence or absence of infringement of a third party's right, presence or absence of false representation and a violation of the Act against Unjustifiable Premiums and Misleading Representations, and the like. Regarding the industry risk, the AI refers to an occurrence rate of fraud and an occurrence rate of administrative guidance in the entire industry, a past occurrence rate of merchant trouble, an expulsion rate from an industry group, a legal regulation risk peculiar to the industry, a social credibility degree, and the like, and determines whether or not the industry is a high-risk industry. Regarding the technical suitability of payment system cooperation, technical information and an API specification are analyzed, and compatibility with an existing payment system, a fulfillment status of a security requirement, strength of an encryption method, standard compliance of a communication protocol, pass or fail of a sandbox test, a past system failure history, presence or absence of an external vulnerability report, and the like are automatically determined. For example, the AI automatically collates description contents of the API specification with specifications on a payment service side, automatically determines compatibility and presence or absence of a security hole, analyzes a log of the sandbox test, and detects presence or absence of unauthorized communication and an abnormal response. Specific examples of a prompt sentence to be read by the generative AI include “Analyze the following financial statement data and score financial soundness compared with an industry average”, “Extract legitimacy of corporate status and a past risk factor from contents of the following certificate of all historical matters, and determine a risk level”, “Collate the following rule document regarding a personal information protection system with legal guidelines, and evaluate suitability”, “Crawl contents of the following merchant website, and determine presence or absence of false description and false advertising”, “Compare the following API specification with a payment system requirement, and determine cooperation suitability”, “Analyze the following sandbox test log, and detect presence or absence of an abnormal response and unauthorized communication”, and the like. Specifically, the determination unit implements a large language model based on a transformer architecture. The determination unit acquires numerical data of financial statements and text data of a certificate of all historical matters as input data. The determination unit divides the text data into subword units and tokenizes them as preprocessing. The determination unit converts a token sequence into a multidimensional embedding vector. The determination unit generates, for example, a 512-dimensional word embedding vector. The determination unit receives numerical data of sales of 100 million yen and a text sequence including a representative change history as specific examples of the input data. The determination unit inputs these input vectors to a self-attention mechanism. The determination unit calculates a dependency relationship between respective tokens, and acquires a feature amount representation considering a context. The determination unit generates a probability distribution indicating a risk level and a continuous value score indicating financial soundness as output data. The determination unit outputs a numerical value of 0.15 indicating a bankruptcy probability and a probability value of 0.01 indicating a relationship with anti-social forces as specific examples of the output data. The determination unit further outputs a natural language text token sequence explaining a determination basis. The determination unit determines whether or not the output probability value exceeds a preset threshold value as subsequent processing. When the threshold value is exceeded, the determination unit executes branch processing of adding the merchant to a list requiring examination. The determination unit transmits the output score to the mapping unit. In the analysis of the financial information, the determination unit expresses the extracted numerical value as a multidimensional vector, and calculates a cosine similarity with a financial vector of a bankrupt company in the past. In the analysis of the certificate of all historical matters, the determination unit extracts text from an image tensor using an optical character recognition model, and extracts a company name, a person's name, and a date as structured data using a named entity recognition model. In the analysis of the personal information protection system, the determination unit calculates a semantic similarity between a text vector of a rule document and a text vector of a legal guideline, and specifies a missing clause. In the analysis of the website, the determination unit detects a contradiction between a product image and an explanatory text using a multimodal model of an image and text. In the suitability determination of the payment system cooperation, the determination unit inputs text data of a specification and time-series data of a test log to a recurrent neural network, and detects a sequence of an abnormal communication pattern. By these advanced arithmetic processings, the system analyzes a huge amount of documents at a speed and accuracy impossible by human visual confirmation. The system detects an ambiguous expression and an unknown risk pattern that cannot be handled by a rule-based program by generalization ability. As a specific application field, the system is applied to an advanced compliance check system of a financial institution and an automatic examination engine of a platform operator. The system provides a core technical improvement toward full automation of examination operations.

The mapping unit automatically classifies information by a plurality of attributes such as a suitability determination result and a risk evaluation result by the determination unit, an industry of a merchant, a region, a transaction scale, a risk level, a payment system cooperation status, presence or absence of a history of administrative guidance, a possession status of intellectual property, a scale of the number of employees, a scale of capital, a number of years of establishment, a cybersecurity risk level, and a past system failure history, generates a merchant map by diverse visualization methods such as a graph structure, on a map, a heat map, a network diagram, a tree map, a timeline, a risk heat map, and a cybersecurity risk map, and enables a person in charge of each department to refer to the merchant map in real time through the result display unit on the terminal side. For example, a person in charge of risk management can confirm a merchant distribution of a high-risk industry with a heat map, a person in charge of sales can confirm a merchant distribution in a new development area on a map, a person in charge of legal affairs can confirm a time-series transition of a merchant having a history of administrative guidance with a timeline, and a person in charge of a system can confirm a merchant having a high cybersecurity risk with a risk map. Specifically, the mapping unit executes a rendering pipeline that converts a multidimensional data structure into a visual element. The mapping unit receives various scores and attribute information output from the determination unit as structured data in a JSON format. The mapping unit expands this structured data on a memory and constructs an in-memory database. In visualization on a map, the mapping unit converts location information of a merchant into coordinate data of latitude and longitude using a geocoding API. The mapping unit draws a map tile on a canvas element of a browser using a graphics library for web. The mapping unit superimposes and draws a marker and a polygon on the map based on the coordinate data. In generation of a heat map, the mapping unit calculates a density of merchants existing in a specific geographical area and a sum of risk scores. The mapping unit maps a calculation result to two-dimensional grid data, and generates a smooth color gradation using a kernel density estimation method. In generation of a network diagram, the mapping unit applies a layout algorithm based on a dynamic model. The mapping unit sets an attractive force and a repulsive force between nodes, and obtains a stable arrangement in which energy is minimized by iterative calculation. In generation of a tree map, the mapping unit executes an algorithm of dividing and arranging hierarchized data as an area ratio of a rectangle. In generation of a timeline, the mapping unit defines a time axis as a one-dimensional coordinate system, and arranges a plot according to an occurrence time of an event. In these drawing processings, the mapping unit actively uses hardware acceleration of a graphics processing unit on the terminal side. Even with a large-scale data set including tens of thousands of data points, the mapping unit realizes a smooth pan and zoom operation without lowering a frame rate. The mapping unit processes a filtering operation from a user in real time. For example, when a threshold value of a risk score is changed by a slider control, the mapping unit immediately issues a query to the in-memory database, and excludes a data point that does not match a condition from a drawing target. By these technical processings, the system converts complex multidimensional data into a format that is easy for a human visual cortex to process. The system makes it possible to intuitively discover a pattern and an abnormal value hidden in data. The system eliminates a cognitive load of reading a large amount of text data, and brings about a technical effect of improving a speed of decision making. As a specific application field, the system is applied to a dashboard system for management, an area analysis tool of a marketing department, and a threat visualization system of a security operations center. The system promotes information sharing between departments and supports data-driven organizational management.

The database management unit unitarily manages all merchant information, determination results, scoring data, mapping data, AI learning data, user operation logs, external cooperation histories, cybersecurity incident information, and the like, and stores them as an audit trail. For example, information of all merchants registered in the past, a scoring result output by the determination unit, a merchant map generated by the mapping unit, learning data accumulated by the AI learning management unit, all operation histories performed by a user, an acquisition history of external data acquired by the external cooperation unit, an occurrence history of a cybersecurity incident, and the like are stored in chronological order, and can be searched, extracted, and reused as necessary. Specifically, the database management unit adopts a distributed database architecture capable of handling a petabyte-class data capacity. The database management unit implements a sharding technology of dividing and arranging data in a plurality of physical servers. The database management unit inputs an identifier of a merchant to a hash function, and determines a shard for storing data based on an output value thereof. Thereby, the database management unit prevents concentration of access to a specific server, and horizontally scales read and write performance. In order to enhance data availability, the database management unit asynchronously replicates data of each shard to a plurality of replica nodes. The database management unit includes a failover mechanism that automatically promotes a secondary node to a primary node when a failure occurs in the primary node. The database management unit uses a time-series database engine specialized for storing time-series data in combination. The database management unit writes data having a time stamp, such as a user operation log, a system cooperation history, and a cybersecurity incident history, to a disk as continuous blocks along a time axis. Thereby, the database management unit processes a range search specifying a specific period and a query of trend analysis over time at an extremely high speed. In order to optimize a storage cost, the database management unit automates data lifecycle management. The database management unit arranges latest data with a high access frequency in a high-speed solid state drive. The database management unit executes tiered storage management of automatically moving past audit trail data after a certain period of time has elapsed to an inexpensive and large-capacity hard disk drive or an archive storage on a cloud. In order to guarantee data integrity, the database management unit periodically acquires a snapshot of the entire database, and detects data corruption using a checksum. In a search and extraction function, the database management unit supports complex join processing and aggregation processing by a structured query language. The database management unit dynamically optimizes an execution plan using a query optimizer, and selects an access path that returns a result in the shortest time. By these technical processings, the system safely and efficiently accumulates a huge amount of information assets. The system eliminates data silos and provides a company-wide data utilization infrastructure. The system exhibits a technical effect of minimizing system downtime and ensuring business continuity. As a specific application field, the system is applied to an integrated customer database of a financial institution and a transaction history management system of a large-scale platform. The system provides a robust infrastructure for big data analysis while satisfying strict audit requirements.

The external cooperation unit cooperates with a plurality of external information sources such as a credit research agency, an administrative agency, a corporate information site on the Internet, a news site, an SNS, an industry group, a patent information database, and a vulnerability information database related to cybersecurity by diverse methods such as an API, web crawling, an RSS feed, and database cooperation, and automatically acquires necessary information. For example, a credit rating and a financial score are acquired from a credit research agency by API cooperation, a history of administrative guidance and a history of legal violations are acquired from an administrative agency by web crawling, an appearance frequency of a company name and a co-occurrence rate with a negative word are analyzed from an SNS, a membership qualification and a reputation in an industry are acquired from an industry group, a possession status and an application status of intellectual property are acquired from a patent information database, and past system incident information and a vulnerability report are acquired from a vulnerability information database related to cybersecurity. Specifically, the external cooperation unit implements an integrated interface module corresponding to diverse protocols and data formats. In application programming interface cooperation, the external cooperation unit adds an authentication token to a header of an HTTP request, and establishes a secure communication channel. The external cooperation unit receives data in a JSON format or an XML format as a response from an external server. The external cooperation unit parses the received data into an internal standardized data structure. In web crawling, the external cooperation unit automatically analyzes a robot exclusion protocol of a target site, and operates a crawler within a permitted range. In order to reduce a load on a target server, the external cooperation unit executes a rate limit avoidance algorithm of inserting a random delay time between requests. For a single page application that dynamically generates contents, the external cooperation unit activates a headless browser, waits for completion of execution of JavaScript, and then extracts a document object model tree. The external cooperation unit accurately scrapes a specific text node from the extracted HTML data using XPath or a CSS selector. In cooperation of an RSS feed, the external cooperation unit periodically polls a URL of a feed, compares update dates and times, and thereby differentially acquires only a new article. The external cooperation unit executes data cleansing processing on the acquired unstructured text data. The external cooperation unit removes an HTML tag and a special character using a regular expression. The external cooperation unit unifies a character code to UTF-8. In data acquisition from a social networking service, the external cooperation unit maintains a streaming connection, filters a post including a specific keyword in real time, and accumulates it in a memory buffer. The external cooperation unit writes the data to a database as batch processing when the buffer reaches a certain amount. When a communication error or a timeout occurs, the external cooperation unit executes retry processing while gradually extending a retry interval using an exponential backoff algorithm. By these technical processings, the system integrates countless external data sources having different formats and acquisition methods into a single system. The system breaks through a limit of manual information collection, and dramatically improves freshness and comprehensiveness of information. The system brings about a technical effect of providing a loosely coupled architecture capable of flexibly following a specification change of an external system. As a specific application field, the system is applied to an open source intelligence collection system of a company and a competitive research automation tool of a marketing department. The system detects a change in an external environment in real time and supports rapid decision making.

The AI learning management unit continuously learns a determination result made by the determination unit in the past, information newly acquired from the outside, presence or absence of occurrence of trouble after an actual transaction, presence or absence of occurrence of administrative guidance, bankruptcy or merger of a merchant, a growth track record, presence or absence of occurrence of cyber attack damage, presence or absence of occurrence of a system failure, and the like, and improves determination accuracy of the generative AI. For example, when a merchant determined to be non-suitable in the past causes a problem at a later date, the case is taken in as learning data and reflected in a future determination standard. Even when there is a new legal revision or a change in an industry guideline, the AI learning management unit automatically acquires information and reflects it in an algorithm of the determination unit. The AI learning management unit collates a past determination result with an actual post-risk occurrence status, and continuously executes optimization of a determination logic. For example, past system cooperation information and a vulnerability report of a merchant where cyber attack damage has occurred are learned and reflected in future cyber risk determination. Specifically, the AI learning management unit constructs a pipeline that automates an operation process of machine learning. The AI learning management unit periodically extracts data of a past determination log and a post-result from the database management unit. The AI learning management unit inputs the extracted data to a feature engineering module. The feature engineering module automatically executes complementation of a missing value, removal of an outlier, encoding of a categorical variable, and scaling of a continuous variable. The AI learning management unit divides the preprocessed data into a training data set, a validation data set, and a test data set. The AI learning management unit acquires an attribute vector of a merchant and an embedding vector of text as input data. The AI learning management unit receives a numerical value of 50 employees and a text vector indicating a past system failure history as specific examples of the input data. The AI learning management unit defines a continuous value indicating a risk occurrence probability and a classification label as output data. The AI learning management unit outputs a numerical value of 0.75 as a system failure occurrence probability and a label of high risk as specific examples of the output data. The AI learning management unit executes relearning of a neural network using a deep learning framework. The AI learning management unit updates a weight parameter so as to minimize a loss function using a gradient descent method. In optimization of a hyperparameter, the AI learning management unit efficiently searches a search space using a Bayesian optimization algorithm, and determines an optimal learning rate and batch size. When new legal revision information is input, the AI learning management unit updates a vector index of an external knowledge base using a retrieval-augmented generation technology. Thereby, the AI learning management unit dynamically incorporates the latest knowledge into a prompt at the time of inference without changing a weight of a model. As subsequent processing, the AI learning management unit evaluates performance of the relearned model using the test data set. The AI learning management unit calculates evaluation indexes such as precision, recall, and an F-measure. Only when the performance of the new model exceeds that of the old model, the AI learning management unit deploys the new model to an inference endpoint in a production environment. The AI learning management unit adopts a blue-green deployment method at the time of deployment, and makes system downtime zero. By these technical processings, the system autonomously adapts to an environmental change and a new threat. The system exhibits a technical effect of preventing accuracy degradation of a model and maintaining high prediction performance over a long period of time. As a specific application field, the system is applied to a fraud detection system of a financial institution and a threat intelligence infrastructure of a cybersecurity product. The system provides an advanced determination logic that always reflects the latest knowledge while minimizing human intervention.

The log management unit records all operation histories, data acquisition histories, determination histories, mapping histories, system cooperation histories, cybersecurity incident histories, and the like in detail, and enables an audit department and a compliance department to refer to them at a later date. For example, who input which merchant information and when, what kind of determination result was output, which external information was acquired at what timing, what kind of mapping was generated, what kind of cybersecurity incident occurred, and the like are recorded in chronological order and stored as an audit trail. Specifically, the log management unit implements an integrated log collection architecture in a distributed system environment. The log management unit makes a lightweight log collection agent resident in each functional module and server node. The log collection agent monitors a log file output by an application in real time, and reads a new log entry every time it is appended. The log management unit converts the read log data into a structured format of a JSON format. The log management unit adds metadata such as a time stamp, an event ID, an importance level, a transmission source IP address, a user identifier, and a name of an executed function to the log data. The log management unit transmits the structured log data to a message broker. The message broker functions as a high-throughput distributed messaging system, and temporarily buffers a large amount of log data. The log management unit asynchronously consumes the log data from the message broker, indexes it, and stores it in a cluster of a full-text search engine. In the full-text search engine, the log management unit constructs an inverted index, and enables ultra-high-speed search by an arbitrary keyword or condition. In order to completely prevent falsification of a log, the log management unit applies a blockchain technology or a hash chain technology. The log management unit generates a block of log data at regular time intervals, and calculates a cryptographic hash value of the block. By including the calculated hash value in a header of the next block, the log management unit records past log data as an unchangeable chain structure. The log management unit provides a dedicated interface for the audit department. Through this interface, the log management unit supports execution of a complex search query and extraction of a specific event pattern. For example, the log management unit automatically detects a series of events that a specific user downloaded a large amount of data outside business hours by correlation analysis, and displays it as an alert. By these technical processings, the system maximizes transparency and traceability of the system. The system provides a forensic infrastructure for quickly investigating a cause and specifying a damage range in the unlikely event of a security incident. The system brings about a technical effect of technically ensuring compliance requirements and reducing legal risks of a company. As a specific application field, the system is applied to an audit response system based on the Financial Instruments and Exchange Act and an access log management system of an electronic medical record in a medical institution. The system instantly extracts meaningful information from a huge amount of log data, and dramatically improves efficiency of audit operations.

The security management unit implements data encryption, access authority management, unauthorized access detection, data backup, a recovery function at the time of failure occurrence, cyber attack detection, abnormal communication detection, and the like, and ensures safety and reliability of the entire system. For example, access authority is finely set for each user, information that can be browsed and edited is controlled for each department, all communications are encrypted, an alert is automatically issued when unauthorized access is detected, data backup is periodically acquired, and recovery can be quickly performed when a failure occurs. Specifically, the security management unit implements a comprehensive security framework based on a multi-layered defense architecture. In data encryption, the security management unit applies an advanced encryption standard algorithm such as AES-256 to stored data, and executes encryption processing at a block level or a file level. For communication data, the security management unit uses a TLS 1.3 protocol, and establishes end-to-end encrypted communication using a cipher suite having forward secrecy. In access authority management, the security management unit adopts a role-based access control model. The security management unit dynamically issues an authority token based on a user's job title and affiliated department, and performs signature verification of the token at the time of an access request to each microservice. In unauthorized access detection and cyber attack detection, the security management unit integrates and operates a network-type and host-type intrusion detection system. The security management unit implements a behavior detection algorithm using machine learning. The security management unit acquires a time-series tensor such as packet header information of network traffic, a statistical feature of a payload, and an API call frequency as input data. The security management unit learns a model of a normal communication pattern using an autoencoder or a recurrent neural network. The security management unit calculates a reconstruction error between real-time input data and a predicted value of the model, and detects an error exceeding a threshold value as a zero-day attack or abnormal communication. As subsequent processing when an abnormality is detected, the security management unit dynamically updates a rule of a firewall to block communication from the IP address, and transmits an emergency alert to an administrator. In data backup, the security management unit automatically executes a schedule combining differential backup and full backup. The security management unit asynchronously transfers backup data to a plurality of geographically separated data centers, and takes a disaster recovery measure. In the recovery function at the time of failure occurrence, the security management unit uses a self-healing function of a container orchestration tool. The security management unit automatically discards a container instance that has failed a health check, and restarts a new instance, thereby maintaining service availability. By these technical processings, the system minimizes an information leakage risk due to a cyber attack from the outside or an internal crime. The system exhibits a technical effect of eliminating a single point of failure of the system and realizing high fault tolerance. As a specific application field, the system is applied to a core system of a company responsible for critical infrastructure and a backend system of a cloud service holding a huge amount of personal information. Based on a principle of zero trust, the system always verifies all access and provides a robust security environment.

The user interface unit operates on the terminal side, and integrally provides an input support function, an automatic complementation function, a file upload function, a result display function, a notification function, a download function, a user authentication function, and the like. For example, when a company name is input, a past candidate list and a similar company name are automatically displayed, automatic format conversion is performed when financial statements are uploaded, a suitability determination result and a reason for non-suitability transmitted from the determination unit, visualization information of a merchant map, a summary comment by AI, a risk alert, a request for additional information, a cybersecurity risk alert, and the like are displayed in an easy-to-understand manner, and can be downloaded in a PDF or Excel format as necessary. The notification unit notifies a user of a determination result, a request for additional information, a risk alert, feedback of an AI learning result, an emergency notification when a cyber incident occurs, and the like in real time. The file upload unit automatically determines a format of an uploaded file, performs text extraction from a PDF and OCR processing from an image as necessary, and standardizes data. The download unit enables a determination result, a merchant map, a summary comment by AI, and the like to be downloaded in various file formats. The user authentication unit includes a security function such as single sign-on and multi-factor authentication, and controls access authority for each department. Specifically, the user interface unit is constructed as an advanced front-end application operating on a rendering engine of a web browser. The user interface unit adopts a virtual document object model, and optimizes drawing performance by keeping redrawing of a screen according to a state change to a minimum differential update. The input support function of the user interface unit monitors a keystroke event, applies debounce processing, and transmits an asynchronous request to a server at a timing when input stops for a certain period of time. Thereby, the user interface unit realizes smooth automatic complementation while preventing an excessive load on the server. The file upload unit reads binary data of a file selected by a user into a memory using a file API of HTML5. The file upload unit analyzes header information of the file and accurately determines a MIME type. In the case of a large-capacity file, the file upload unit divides data into chunks of several megabytes, and transmits them in parallel as multipart form data. The file upload unit executes preprocessing of downscaling a resolution of an image file before transmission using computing power on the terminal side, and saves a communication band. The result display unit analyzes determination result data in a JSON format received from the server, and dynamically assigns a value to each component on the screen using a data binding technology. When receiving visualization information of a merchant map, the result display unit calls a graphics library for web, and executes drawing with hardware acceleration on a canvas element. The notification unit constantly maintains a WebSocket connection with the server, and establishes a full-duplex communication channel. The notification unit immediately receives an event message push-delivered from the server, calls a native notification API of an operating system, and displays a desktop notification. The download unit converts binary data received from the server into a blob object, dynamically generates a download attribute of an anchor tag, and triggers a file save dialog. The user authentication unit implements an OpenID Connect protocol, and safely exchanges a JSON Web Token with an external authentication provider. By these technical processings, the system provides rich operability and responsiveness comparable to a desktop application. The system brings about a technical effect of hiding an influence of network delay and maximizing user's work efficiency. As a specific application field, the system is applied to a back-office business system in which complex data input and confirmation work continue, and a monitoring dashboard requiring real-time situation grasping. The system realizes a distributed processing architecture that efficiently utilizes resources on the terminal side and distributes a load on the server side.

As described above, in the system according to the present embodiment, each unit operates in cooperation to realize highly accurate and efficient merchant examination management centered on the generative AI. Specific examples of a prompt sentence to be read by the generative AI include “Analyze the following financial statement data and score financial soundness compared with an industry average”, “Extract legitimacy of corporate status and a past risk factor from contents of the following certificate of all historical matters, and determine a risk level”, “Collate the following rule document regarding a personal information protection system with legal guidelines, and evaluate suitability”, “Crawl contents of the following merchant website, and determine presence or absence of false description and false advertising”, “Compare the following API specification with a payment system requirement, and determine cooperation suitability”, “Analyze the following sandbox test log, and detect presence or absence of an abnormal response and unauthorized communication”, and the like, and by the generative AI executing analysis, determination, summarization, comparison, visualization, cyber risk evaluation, and the like of various types of information using these prompts, it is possible to realize highly accurate and efficient merchant examination management that has been difficult to realize by conventional manual work. Specifically, the system implements a prompt engineering module that dynamically generates and optimizes these prompt sentences. The prompt engineering module converts data in diverse formats collected by the information acquisition unit into a text sequence that can be processed by a large language model. The prompt engineering module executes chunking processing of automatically summarizing or discarding less important information so that the number of tokens of input data does not exceed an upper limit of a context window of the model. The system combines a plurality of specialized models as an ensemble in an inference pipeline of the generative AI. For example, the system assigns a model specialized for numerical calculation and logical inference to analysis of financial data, and assigns a model specialized for context understanding of a long sentence to analysis of a rule document. The system acquires a combined text vector of a prompt sentence and target data as input data. The system receives a combination of a numerical array of each item of financial statements and text instructing scoring as a specific example of the input data. The system generates an answer text for each task and a tensor of a probability distribution as output data. The system outputs a numerical value of 0.88 as a financial soundness score and a classification label indicating that abnormal communication is detected as specific examples of the output data. As subsequent processing, the system aggregates outputs from the respective models into an integration module, and calculates a final comprehensive determination score. In order to minimize latency of inference processing, the system applies a quantization technology of converting a weight parameter of a model from a floating-point number to a low-bit integer. The system executes matrix multiplication operation at high speed by utilizing a tensor core of a parallel arithmetic processor. By these technical processings, the system does not simply imitate a human cognitive process, but processes information at a scale and speed impossible for humans through mathematical operations in a high-dimensional space. The system exhibits a technical effect of completely eliminating individual dependence in examination operations and establishing a highly reproducible objective evaluation standard. As a specific application field, the system is applied to a real-time merchant onboarding system in a fintech company and a supply chain risk management system of a global company. The system provides a fundamental technology for constructing a robust risk management system without hindering a growth speed of business.

### (Implementation Steps)

### Step 1: Input/Upload of Merchant Candidate Information

Using the user interface unit on the terminal side, a company name of a merchant candidate, a representative name, a location, a date of establishment, capital, a number of employees, business contents, financial statements for three past periods (a balance sheet, a profit and loss statement, and a cash flow statement), a certificate of all historical matters (a PDF file or an image file), a rule document regarding a personal information protection system (a privacy policy, information management rules, and an employee education record), a written oath regarding exclusion of anti-social forces, a past history of fraudulent transactions and a history of administrative guidance, a URL of a corporate website, an industry classification, and technical information for payment system cooperation (an API specification, security authentication information, a system configuration diagram, a communication protocol specification, an explanation of an encryption method, a sandbox test result, and the like) are input or uploaded. The input support unit streamlines input work by performing automatic complementation of the company name and the representative name, postal code conversion of the location, format conversion of the financial statements, OCR processing of the certificate of all historical matters, checklist creation of the personal information protection system, automatic analysis of the API specification, and the like. Specifically, in this step, the user interface unit on the terminal side executes real-time validation processing on the input text data. The user interface unit verifies validity of formats of an email address and a telephone number using a regular expression. The user interface unit confirms whether an invalid character code or a script tag is included by sanitization processing. The file upload unit reads a file dragged and dropped by a user into a memory. The file upload unit calculates a hash value of the file, and determines duplication with an already uploaded file on a client side. When an image file is uploaded, the file upload unit executes image preprocessing such as edge extraction and contrast adjustment using a calculation resource on the terminal side. The file upload unit transmits the preprocessed image data to the information acquisition unit on the server side by asynchronous communication. The information acquisition unit on the server side inputs the received image data to an optical character recognition model. The optical character recognition model has an architecture combining a convolutional neural network and a recurrent neural network. The optical character recognition model acquires an image tensor composed of a two-dimensional pixel value array as input data. The optical character recognition model receives a grayscale image tensor with a resolution of 2048 pixels square as a specific example of the input data. The optical character recognition model generates a sequence of recognized characters, bounding box coordinates of each character, and a certainty score as output data. The optical character recognition model outputs a character string “Kabushiki Kaisha” and a numerical value of a certainty degree of 0.99 as a specific example of the output data. As subsequent processing, the information acquisition unit specifies a character region where the certainty score falls below a threshold, and returns a warning message to the user interface unit to prompt manual confirmation. In order to extract a table structure from the PDF file of the financial statements, the information acquisition unit uses a heuristic ruled line detection algorithm and a machine learning-based layout analysis model together. The information acquisition unit converts the extracted numerical values into a structured JSON format, and stores the structured JSON format in the database management unit. By these technical processings, the system automates a conversion process from unstructured data to machine-readable structured data. The system brings about a technical effect of dramatically reducing human cost and time required for data input and eliminating input errors. As a specific application field, the system is applied to back-office operations of a financial institution that processes a large amount of paper media and PDF documents, and an electronic application reception system of an administrative agency. The system establishes a foundation for providing high-quality input data with less noise to a subsequent AI analysis pipeline.

### Step 2: Automatic Information Acquisition From Internal and External Databases and External Information Sources

In addition to the information received from the terminal, the information acquisition unit automatically collects related information from an internal existing merchant database, a past examination history, a transaction performance database, a contract database of a legal department, a financial database of an accounting department, a system cooperation history database, an audit record database, and the like. Furthermore, the external cooperation unit automatically acquires a credit rating, a history of administrative guidance, a reputation, word of mouth, a news article, a flaming history, a membership qualification, a possession status of intellectual property, a cyber attack damage history, a vulnerability report, and the like from a database of a credit research agency, public information of an administrative agency, a corporate information site on the Internet, a news site, an SNS, a list of an industry group, a patent information database, a vulnerability information database related to cyber security, and the like. Specifically, in this step, the information acquisition unit and the external cooperation unit execute an advanced parallel data collection pipeline using a distributed processing framework. The information acquisition unit dynamically generates queries to a plurality of data sources using the company name and the representative name received from the terminal as seed information. In accessing the internal database, the information acquisition unit minimizes overhead of database connection using a connection pooling technology. The information acquisition unit asynchronously issues a complex join query across a plurality of tables, and expands a result set into a data frame on a memory. The external cooperation unit transmits non-blocking HTTP requests using asynchronous IO in parallel to an external application programming interface. The external cooperation unit monitors a rate limit of each external source, and dynamically controls a transmission frequency of the requests using a token bucket algorithm. In web scraping, the external cooperation unit orchestrates a group of distributed crawler nodes, and assigns a crawling task for each domain of a target site. The external cooperation unit extracts a named entity from the acquired HTML document using natural language processing, and eliminates an advertisement and a navigation element that become noise. The information acquisition unit executes entity resolution processing on a huge amount of data collected from inside and outside the company. The information acquisition unit determines whether records acquired from different data sources indicate the same company in consideration of a company name including a notation fluctuation and an abbreviation, a change of a location due to relocation, and the like. In this determination, the information acquisition unit calculates a Levenshtein distance and a Jaro-Winkler distance between character strings of each attribute, and calculates an identity score using a machine learning-based classifier. The information acquisition unit merges a group of records whose identity score exceeds a threshold into a single master record. The information acquisition unit inputs a group of collected text data to a vectorization model, and converts the group of collected text data into a high-dimensional embedding vector. The information acquisition unit stores these vectors in a vector database, and speeds up a subsequent similarity search. By these technical processings, the system breaks down information silos and reconstructs distributed heterogeneous data as an integrated knowledge base. The system completely eliminates a process in which a human manually collects information using a browser or a search engine. The system exhibits a technical effect of dramatically improving comprehensiveness and speed of information collection. As a specific application field, the system is applied to an automatic investigation system in a credit management department of a company and a data aggregation foundation for corporate valuation in an investment bank. The system eliminates information asymmetry in an initial stage of examination, and enables highly accurate risk evaluation.

### Step 3: Multifaceted Information Analysis and Determination by Generative AI

The determination unit inputs all the information collected by the information acquisition unit to the generative AI, and performs analysis and determination of various types of information. For example, regarding financial information, the generative AI automatically reads financial statements for three past periods, automatically calculates sales, profit, an equity ratio, presence or absence of insolvency, soundness of cash flow, a turnover period of accounts receivable and accounts payable, an increase or decrease in fixed assets, contents of investment activities, transition of short-term borrowings and long-term borrowings, an increase or decrease in inventory assets, presence or absence of tax delinquency, and the like, and scores financial soundness by comparing with an industry average and past merchant data. Regarding a certificate of all historical matters, the generative AI automatically analyzes contents using OCR and natural language processing, extracts legitimacy of corporate status, a change history of a representative, description contents of a purpose column, an increase or decrease history of capital, a change history of a location, a record of dissolution or liquidation, a history of merger, split, and business transfer, and the like, and collates them with past fraud cases and risk patterns. Regarding a personal information protection system, the generative AI analyzes a checklist and a rule document, and automatically determines suitability with laws and guidelines, comprehensiveness of information management rules, an implementation status of employee education, presence or absence of information leakage countermeasures, an acquisition status of third-party certification, presence or absence of contractor management, a maintenance status of a personal information management ledger, and the like. Regarding exclusion of anti-social forces, presence or absence of a risk is determined by collating contents of a written oath and an external database, and for example, collation with an anti-social force list and matching with a past history of administrative disposition are also performed. Regarding a past history of fraudulent transactions and a history of administrative guidance, the generative AI crawls an external database and a news article, extracts a past administrative disposition, a trouble case, a litigation history, contents of administrative guidance, presence or absence of an improvement report, an implementation status of recurrence prevention measures, a frequency of administrative guidance, severity of contents, and the like, and evaluates a risk level. Regarding description contents of a corporate website, the generative AI automatically crawls the website, and automatically determines authenticity of the description contents, presence or absence of exaggerated advertising, a difference from past description contents, accuracy of explanation of products and services, presence or absence of legal violations, presence or absence of infringement of third-party rights, presence or absence of false representation and violation of the Act against Unjustifiable Premiums and Misleading Representations, and the like. Regarding an industry risk, the AI determines whether or not the industry has a high risk by referring to a fraud occurrence rate and an administrative guidance occurrence rate of the entire industry, a past merchant trouble occurrence rate, an expulsion rate from an industry group, a legal regulation risk peculiar to the industry, social credibility, and the like. Regarding suitability of payment system cooperation, technical information and an API specification are analyzed, and compatibility with an existing payment system, a fulfillment status of security requirements, strength of an encryption method, standard compliance of a communication protocol, pass or fail of a sandbox test, a past system failure history, presence or absence of an external vulnerability report, and the like are automatically determined. Specific examples of a prompt sentence to be read by the generative AI include “Analyze the following financial statement data and score financial soundness compared with an industry average”, “Extract legitimacy of corporate status and past risk factors from contents of the following certificate of all historical matters, and determine a risk level”, “Collate the following rule document regarding a personal information protection system with legal guidelines, and evaluate suitability”, “Crawl contents of the following merchant website, and determine presence or absence of false description and exaggerated advertising”, “Compare the following API specification with payment system requirements, and determine cooperation suitability”, and “Analyze the following sandbox test log, and detect presence or absence of an abnormal response and unauthorized communication”. Specifically, in this step, the determination unit executes an inference pipeline centered on a multimodal large language model. The determination unit simultaneously acquires an array of structured financial numerical values, a text token sequence of a rule document, and a screenshot image tensor of a website as input data. The determination unit receives an array of floating-point numbers indicating transition of sales for three years, a full text of a privacy policy, and an RGB image tensor with a resolution of 1024 pixels square as specific examples of the input data. The determination unit inputs these heterogeneous data to respective encoders, and converts them into high-dimensional vector representations in a common latent space. The determination unit calculates relevance between a text vector and an image vector using a cross-attention mechanism, and fuses multimodal feature amounts. The determination unit inputs the fused feature amount vector to a decoder network. The determination unit generates a continuous value of a risk score for each evaluation item, a classification label, and a natural language text token sequence explaining a determination basis as output data. The determination unit outputs a numerical value of a financial soundness score of 0.85, a classification label of low anti-social force risk, and an explanatory text that no unnatural increase or decrease in capital is seen, as specific examples of the output data. As subsequent processing, the determination unit inputs each output score to a weighted linear sum algorithm, and calculates a final comprehensive determination score. When the comprehensive determination score falls below a preset threshold, the determination unit executes branch processing of flagging the merchant as non-suitable. In a process of inference processing, the determination unit performs a similarity search on a vector index of an external knowledge base, dynamically acquires a text vector of a related past judicial precedent and the latest legal guideline, and adds the text vector to a context of the prompt. By these technical processings, the system executes complex logical inference, which is performed by a human expert by comparing a plurality of materials, at high speed and accurately as a mathematical operation inside a computer. The system brings about a technical effect of extracting a hidden risk factor with high accuracy from atypical data and ambiguous expressions that cannot be handled by a rule-based system. As a specific application field, the system is applied to an advanced credit examination system of a financial institution and a store opener screening system of a platform operator. The system significantly shortens a lead time of examination operations and constructs a scalable risk management system.

### Step 4: Generation and Notification of Determination Result, Scoring, and Basis Information

The determination unit performs scoring for each item, executes comprehensive suitability determination, generates a detailed scoring result, basis data, a summary comment by AI, a comparison result with a past similar case, and the like, and transmits them to the result display unit on the terminal side. The notification unit notifies the user in real time of a determination result, a reason for non-suitability, a risk alert, a request for additional information, feedback of an AI learning result, an emergency notification when a cyber incident occurs, and the like. For example, when financial soundness falls below a certain standard, when there is a history of serious administrative guidance in the past, when false description is recognized on a website, when a personal information protection system is insufficient, when an anti-social force risk is detected, when an industry risk is high, when there is a technical problem in payment system cooperation, when a sandbox test is failed, when an external vulnerability report exists, and the like, it is determined as non-suitable, and the reason is automatically generated and notified to the terminal side. Specifically, in this step, the determination unit inputs a multidimensional score vector output from the generative AI to an aggregation algorithm. The determination unit multiplies the score vector by a weight coefficient matrix corresponding to importance of each evaluation item, and calculates a comprehensive suitability determination score. In this score calculation, the determination unit adopts a hybrid approach of ensembling a rule-based determination logic using a decision tree model and an output of the generative AI. The determination unit combines the calculated comprehensive score, an individual score of each item, and a natural language summary comment output by the generative AI, and generates a structured result payload in a JSON format. In order to generate a comparison result with a past similar case, the determination unit calculates a cosine similarity between a feature amount vector of a current merchant and a past merchant vector in the database. The determination unit extracts a top case having the highest similarity, and adds an ex-post result thereof to the result payload. The determination unit publishes the generated result payload to a message queuing system. The notification unit asynchronously subscribes to the result payload from the message queue. The notification unit analyzes a flag in the payload, and evaluates whether a non-suitability determination or a serious risk alert is included. When the corresponding flag exists, the notification unit immediately transmits a data packet of a push notification through a WebSocket connection established with the user interface unit on the terminal side. When urgency is extremely high, such as when a cyber incident occurs, the notification unit executes subsequent processing of calling an email transmission API and a short message service API in addition to a normal notification channel, and directly transmitting an alert to a mobile terminal of an administrator. By these technical processings, the system structures a complex determination result into a format easy for a human to understand, and transmits it without delay. The system exhibits a technical effect of enabling real-time decision making and prompt action without waiting for daily result confirmation by batch processing. As a specific application field, the system is applied to a fraud detection system for online transactions requiring determination in seconds and a mission-critical infrastructure monitoring system. The system provides a robust notification mechanism directly linked to early detection of risks and minimization of damage.

### Step 5: Automatic Generation and Visualization of Merchant Map

The mapping unit automatically classifies the information by a plurality of attributes such as a suitability determination result and a risk evaluation result by the determination unit, an industry of a merchant, a region, a transaction scale, a risk level, a payment system cooperation status, presence or absence of a history of administrative guidance, a possession status of intellectual property, a scale of the number of employees, a scale of capital, a number of years of establishment, a cyber security risk level, and a past system failure history, generates a merchant map by diverse visualization methods such as a graph structure, on a map, a heat map, a network diagram, a tree map, a timeline, a risk heat map, and a cyber security risk map, and enables a person in charge of each department to refer to the merchant map in real time through the result display unit on the terminal side. Specifically, in this step, the mapping unit receives multidimensional attribute data and score data output from the determination unit as input. The mapping unit expands these data as a multidimensional array on a memory. The mapping unit executes a clustering algorithm, and automatically groups a group of merchants having similar attributes. For example, the mapping unit divides data points in a high-dimensional space into a plurality of clusters using a k-means method. The mapping unit calculates barycentric coordinates of each cluster, and calculates a distance between the clusters. The mapping unit generates rendering data for visualization. When generating a network diagram, the mapping unit constructs graph structure data with merchants as nodes and transaction relationships and similarities as edges. The mapping unit executes layout calculation based on a dynamic model, and determines two-dimensional coordinates that balance attractive force and repulsive force between nodes. When generating a heat map, the mapping unit calculates a density function on a two-dimensional grid based on geographical coordinate data, and generates a pixel array of smooth color gradation by kernel density estimation. The mapping unit serializes the generated rendering data into a JSON format, and transmits the serialized rendering data to the result display unit on the terminal side. The result display unit on the terminal side calls a data-driven document manipulation library and a graphics library for web based on the received data. The result display unit draws vector graphics and pixel data on a canvas element at high speed using a graphics processing unit on the terminal side. The result display unit monitors a mouse hover and a click event from a user, and executes interactive processing of popping up information of a data point corresponding to coordinates where the event occurred. By these technical processings, the system converts complex multidimensional data reaching tens of thousands of cases into a format in which a human visual cortex can instantly recognize a pattern. The system brings about a technical effect of intuitively grasping a macro trend and a micro abnormal value that cannot be discovered by an enumeration of spreadsheet software. As a specific application field, the system is applied to a portfolio analysis tool in a corporate planning department and a company-wide threat monitoring dashboard in a risk management department. The system strongly supports strategic decision making based on data, and provides a foundation for improving data literacy of the entire organization.

### Step 6: Continuous Improvement of Determination Accuracy by AI Learning

The AI learning management unit continuously learns a determination result made by the determination unit in the past, information newly acquired from the outside, presence or absence of occurrence of a trouble after an actual transaction, presence or absence of occurrence of administrative guidance, bankruptcy or merger of a merchant, a growth track record, presence or absence of occurrence of cyber attack damage, presence or absence of occurrence of a system failure, and the like, and improves determination accuracy of the generative AI. For example, when a merchant determined to be non-suitable in the past causes a problem at a later date, the case is taken in as learning data and reflected in future determination criteria. Even when there is a new legal revision or a change in industry guidelines, the AI learning management unit automatically acquires information and reflects the information in an algorithm of the determination unit. Specifically, the AI learning management unit constructs a continuous learning pipeline. The pipeline converts newly acquired data with a correct answer label into a multidimensional tensor. The AI learning management unit fine-tunes weight parameters of a large language model using self-supervised learning and reinforcement learning. The system receives a past determination score vector, a time-series financial fluctuation matrix, and binary data of a trouble occurrence flag as input data. The system projects these input data into a 512-dimensional embedding vector space. The AI learning management unit minimizes a cross-entropy loss using a backpropagation method. The processing unit updates a weight of each layer of a neural network by a gradient descent method. The system generates an updated attention weight matrix and a new risk determination threshold group as an output. The system applies this output result as an initial parameter in the next inference processing. The system inputs text data of a legal revision to a natural language processing model. The model extracts a changed regulatory requirement from the text, and outputs the changed regulatory requirement as a rule-based constraint condition vector. The system incorporates this constraint condition vector as a penalty term for a loss function. Thereby, the system immediately reflects the latest legal requirement in a determination logic without depending on manual update by a human. This configuration prevents obsolescence of the model. This configuration brings about a technical effect of continuous improvement of determination accuracy. This technology is applicable to a field requiring dynamic risk evaluation, such as a credit examination system of a financial institution and a store opener monitoring system in an electronic commerce platform.

### (Specific Use Case)

For example, when an electronic payment service provider examines a corporation running a restaurant business as a new merchant, first, using the user interface unit of the terminal, a company name, a representative name, a location, a date of establishment, capital, a number of employees, business contents, financial statements for three past periods (a balance sheet, a profit and loss statement, and a cash flow statement), a certificate of all historical matters (a PDF file), a rule document regarding a personal information protection system (a privacy policy, information management rules, and an employee education record), a written oath regarding exclusion of anti-social forces, a past history of fraudulent transactions and a history of administrative guidance, a URL of a corporate website, an industry classification, and technical information for payment system cooperation (an API specification, security authentication information, a system configuration diagram, a communication protocol specification, an explanation of an encryption method, a sandbox test result, and the like) are input or uploaded. The input support unit automatically suggests a registered company name in the past or a similar company name when the company name is input, automatically complements an address from a postal code when the location is input, automatically extracts numerical data from a PDF or Excel when the financial statements are uploaded, performs OCR processing from an image of the certificate of all historical matters, automatically generates a checklist of the personal information protection system, and also performs format conversion of the API specification and automatic analysis of the communication protocol. Specifically, the input support unit executes a preprocessing pipeline for extracting structured data from unstructured data. The input support unit acquires an uploaded PDF file or image data as a two-dimensional pixel value tensor. The input support unit inputs the pixel value tensor to an optical character recognition model using a convolutional neural network. The model specifies a character region in an image as a bounding box. The model outputs characters in the specified region as a sequence of character codes. The input support unit inputs the extracted text data to a natural language processing model. The model executes a named entity extraction algorithm. The model outputs attribute information such as a company name, a location, and capital as key-value type structured data. The input support unit analyzes tabular data of the financial statements. The input support unit extracts a pair of each account title and an amount based on ruled line information and spatial arrangement of text. The input support unit converts the extracted numerical values into a floating-point multidimensional array. The input support unit converts a technical document such as an API specification into a syntax analysis tree. The input support unit generates a feature amount vector indicating a type of a communication protocol and strength of an encryption method. The system transmits these structured data and feature amount vector to the subsequent determination unit. This configuration eliminates work of manual input and visual confirmation by a human. This configuration brings about technical effects of speeding up data input and reducing input errors. This technology is applicable to a merchant onboarding process of an online payment agency service, a tenant registration system of a cloud service, and the like.

In addition to the information received from the terminal, the information acquisition unit automatically collects related information from an internal existing merchant database, a past examination history, a transaction performance database, a contract database of a legal department, a financial database of an accounting department, a system cooperation history database, an audit record database, and the like. For example, in order to confirm duplication with an existing merchant, a company name, a representative name, a location, and a date of establishment are searched as keys, and a history of fraudulent transactions and trouble occurrence, a background of contract cancellation and transaction suspension, and an audit indication item are extracted from a past examination history and transaction performance. Furthermore, via the external cooperation unit, a credit rating and a financial score from a database of a credit research agency, a history of administrative guidance and a history of legal violations from public information of an administrative agency, a reputation and word of mouth from a corporate information site and a news site on the Internet, an appearance frequency of a company name and a co-occurrence rate with a negative word from an SNS, a membership qualification and a reputation in an industry from an industry group, a possession status and an application status of intellectual property from a patent information database, past system incident information and the like from a vulnerability information database related to cyber security are automatically acquired. For example, a flaming risk of a company name on an SNS, a past history of administrative guidance, an expulsion history from an industry group, the number of patent applications and contents of possessed patents, a cyber attack damage history, presence or absence of a vulnerability report, and the like are also automatically collected. Specifically, the information acquisition unit drives a distributed data collection engine. The information acquisition unit issues queries in parallel to a plurality of heterogeneous databases. The information acquisition unit normalizes relational data acquired from the internal database. The information acquisition unit collects unstructured text data from an external website and an SNS using a web scraping technology. The information acquisition unit inputs the collected text data to a morphological analysis engine. The engine divides the text into a sequence of word tokens. The information acquisition unit converts each token into a 300-dimensional dense vector using a word embedding model. The information acquisition unit calculates a cosine similarity between a company name vector and a negative word vector. The information acquisition unit outputs this similarity as a co-occurrence rate score. The information acquisition unit acquires vulnerability information such as a common vulnerability identifier from a cyber security information database. The information acquisition unit collates the acquired information with system configuration information of the merchant. When a matching vulnerability exists, the information acquisition unit calculates a vulnerability severity score. The information acquisition unit integrates these collected data, and generates an integrated feature amount matrix for each merchant. The system uses this integrated feature amount matrix as input data for inference processing in the subsequent determination unit. This configuration automates an information collection process. This configuration completes comprehensive information collection in milliseconds compared with a case where a human manually performs a search. This configuration brings about technical effects of improving efficiency of data collection and preventing oversight. This technology is applicable to a supply chain risk management system, a due diligence automation system of an investment fund, and the like.

The determination unit inputs all the information collected by the information acquisition unit to the generative AI, and for example, regarding financial information, the generative AI automatically reads financial statements for three past periods, automatically calculates sales, profit, an equity ratio, presence or absence of insolvency, soundness of cash flow, a turnover period of accounts receivable and accounts payable, an increase or decrease in fixed assets, contents of investment activities, transition of short-term borrowings and long-term borrowings, an increase or decrease in inventory assets, presence or absence of tax delinquency, and the like, and scores financial soundness by comparing with an industry average and past merchant data. Regarding a certificate of all historical matters, the generative AI automatically analyzes contents using OCR and natural language processing, extracts legitimacy of corporate status, a change history of a representative, description contents of a purpose column, an increase or decrease history of capital, a change history of a location, a record of dissolution or liquidation, a history of merger, split, and business transfer, and the like, and collates them with past fraud cases and risk patterns. Regarding a personal information protection system, the generative AI analyzes a checklist and a rule document, and automatically determines suitability with laws and guidelines, comprehensiveness of information management rules, an implementation status of employee education, presence or absence of information leakage countermeasures, an acquisition status of third-party certification, presence or absence of contractor management, a maintenance status of a personal information management ledger, and the like. Regarding exclusion of anti-social forces, presence or absence of a risk is determined by collating contents of a written oath and an external database, and for example, collation with an anti-social force list and matching with a past history of administrative disposition are also performed. Regarding a past history of fraudulent transactions and a history of administrative guidance, the generative AI crawls an external database and a news article, extracts a past administrative disposition, a trouble case, a litigation history, contents of administrative guidance, presence or absence of an improvement report, an implementation status of recurrence prevention measures, a frequency of administrative guidance, severity of contents, and the like, and evaluates a risk level. Regarding description contents of a corporate website, the generative AI automatically crawls the website, and automatically determines authenticity of the description contents, presence or absence of exaggerated advertising, a difference from past description contents, accuracy of explanation of products and services, presence or absence of legal violations, presence or absence of infringement of third-party rights, presence or absence of false representation and violation of the Act against Unjustifiable Premiums and Misleading Representations, and the like. Regarding an industry risk, the AI determines whether or not the industry has a high risk by referring to a fraud occurrence rate and an administrative guidance occurrence rate of the entire industry, a past merchant trouble occurrence rate, an expulsion rate from an industry group, a legal regulation risk peculiar to the industry, social credibility, and the like. Regarding suitability of payment system cooperation, technical information and an API specification are analyzed, and compatibility with an existing payment system, a fulfillment status of security requirements, strength of an encryption method, standard compliance of a communication protocol, pass or fail of a sandbox test, a past system failure history, presence or absence of an external vulnerability report, and the like are automatically determined. For example, the AI automatically collates description contents of the API specification with specifications on a payment service side, automatically determines compatibility and presence or absence of a security hole, analyzes a log of the sandbox test, and detects presence or absence of unauthorized communication and an abnormal response. Specifically, the determination unit executes a complex inference engine combining a large language model based on a transformer architecture and a graph neural network. The determination unit receives a time-series array of financial indicators, a token embedding vector of text data, and a structured parameter of a system cooperation specification as input data. The determination unit inputs the time-series array of financial indicators to a long short-term memory network. The network learns a fluctuation pattern of financial data for three past periods, and outputs a continuous value score from 0 to 1 indicating a future default probability. The determination unit constructs a relationship between entities extracted from the certificate of all historical matters as a knowledge graph. The determination unit predicts a hidden link between nodes on the knowledge graph using the graph neural network. The network outputs a risk probability distribution indicating whether or not it has a network structure similar to a past fraudulent company. The determination unit inputs the API specification and the log data of the sandbox test to an anomaly detection model. The model learns a latent space of a normal communication pattern using an autoencoder. The model calculates a reconstruction error between the input log data and reconstructed data. When the reconstruction error exceeds a predetermined threshold, the model outputs an abnormal communication flag. The determination unit inputs an output score from each of these models to a fully connected layer. The fully connected layer outputs a final comprehensive suitability score and a contribution weight of each risk factor. The system transmits this comprehensive suitability score to the subsequent mapping unit and notification unit. This configuration eliminates a conventional examination process depending on human intuition and experience. This configuration mathematically evaluates a correlation of non-linear feature amounts in a high-dimensional space. This configuration brings about technical effects of dramatically improving examination accuracy and shortening examination time. This technology is applicable to a merchant examination system of a credit card company, an account opening examination system of a crypto asset exchange, and the like.

Specific examples of prompt sentences to be read by the generative AI include “analyze the following financial statement data and score financial soundness compared with an industry average”, “extract legitimacy of corporate status and a past risk factor from contents of the following certificate of all historical matters, and determine a risk level”, “collate the following rule document regarding a personal information protection system with a legal guideline, and evaluate suitability”, “crawl contents of the following merchant website, and determine presence or absence of a false description and an exaggerated advertisement”, “compare the following API specification document and a payment system requirement, and determine cooperation suitability”, and “analyze the following sandbox test log, and detect presence or absence of an abnormal response and abnormal communication”. Specifically, the determination unit includes a dynamic prompt generation module. This module automatically selects an optimal prompt template in accordance with a type and a data amount of input data. This module embeds structured data in the selected template, and generates an input text to a natural language processing model. The system receives, as the input data, for example, a numerical vector such as sales and an operating profit, and a text character string of a rule document. The system inserts these pieces of data into a placeholder of the prompt sentence. The determination unit inputs the generated prompt sentence to a large language model. This model calculates a dependency relationship between respective words in the prompt using a self-attention mechanism. This model generates, as an output, an answer text to a requested task, and a probability score from 0 to 1 indicating a certainty factor of each determination item. For example, this model outputs numerical data of 0.85 as a financial soundness score. This model outputs label data of no detection as presence or absence of abnormal communication. The system passes these output results to a subsequent scoring processing module. This configuration clarifies an instruction to the model, and suppresses a blur of inference. This configuration achieves both flexible task definition by natural language and strict numerical output. This configuration brings about a technical effect of improving stability of an inference result. This technology is applicable to an automatic response system using an interactive agent, a document summarization system, and the like.

The determination unit performs scoring for each item, executes comprehensive suitability determination, generates a detailed scoring result, basis data, a summary comment by the AI, a comparison result with a past similar case, and the like, and transmits them to a result display unit on a terminal side. A notification unit notifies a user of a determination result, a reason for non-suitability, a risk alert, a request for additional information, feedback of an AI learning result, an emergency notification at the time of occurrence of a cyber incident, and the like in real time. For example, when financial soundness falls below a certain standard, when there is a past serious history of administrative guidance, when a false description is recognized on a website, when a personal information protection system is insufficient, when an anti-social force risk is detected, when an industry risk is high, when there is a technical problem in payment system cooperation, when a sandbox test is failed, when an external vulnerability report exists, or the like, it is determined as non-suitability, and the reason is automatically generated and notified to the terminal side. Specifically, the determination unit executes an integrated scoring algorithm based on ensemble learning. The determination unit receives a vector of an individual score output from each inference model as an input. The determination unit performs weighted addition of these individual scores using a random forest algorithm. The determination unit outputs a final total suitability score as an integer value from 0 to 100. The determination unit generates a non-suitability flag when the total suitability score is less than a preset threshold value. The determination unit specifies a feature amount that has become a main factor of a score decrease by tracing a branch condition of a decision tree. The determination unit generates text data of a natural language indicating the reason for non-suitability based on the specified feature amount. The notification unit receives the generated text data, the total suitability score, and the non-suitability flag. The notification unit encapsulates these pieces of data into a structured message payload. The notification unit push-distributes the message payload to the result display unit on the terminal side by asynchronous communication using a bidirectional communication protocol. This configuration prevents a determination result from becoming a black box. This configuration logically and transparently presents a basis for determination. This configuration brings about a technical effect of supporting user's decision making and improving reliability of the system. This technology is applicable to presentation of a diagnosis basis in a medical diagnosis support system, generation of a danger prediction alert in an automatic driving system, and the like.

The mapping unit automatically classifies the information by a plurality of attributes such as a suitability determination result and a risk evaluation result by the determination unit, an industry of a merchant, a region, a transaction scale, a risk level, a payment system cooperation status, presence or absence of a history of administrative guidance, a possession status of intellectual property, a scale of the number of employees, a scale of capital, a number of years of establishment, a cybersecurity risk level, and a past system failure history, generates a merchant map by diverse visualization methods such as a graph structure, on a map, a heat map, a network diagram, a tree map, a timeline, a risk heat map, and a cybersecurity risk map, and enables a person in charge of each department to refer to the merchant map in real time through the result display unit on the terminal side. For example, a person in charge of risk management can confirm a merchant distribution of a high-risk industry with a heat map, a person in charge of sales can confirm a merchant distribution of a new development area on a map, a person in charge of legal affairs can confirm a time-series transition of a merchant having a history of administrative guidance with a timeline, and a person in charge of a system can confirm a merchant having a high cybersecurity risk with a risk map. Specifically, the mapping unit drives a multidimensional data visualization engine. The mapping unit receives a multidimensional vector group including attribute data and a risk score of the merchant output from the determination unit as an input. The mapping unit executes a principal component analysis algorithm. The mapping unit dimensionally compresses a high-dimensional feature amount space into a two-dimensional or three-dimensional visualization space. The mapping unit generates a graph network structure in which each merchant is a node and a transaction relationship and similarity between merchants are edges based on the compressed coordinate data. The mapping unit makes a size of the node proportional to a transaction scale, and allocates a color of the node as a gradation of the risk score. The mapping unit outputs the generated graph network structure as vector graphics data. The mapping unit transmits this vector graphics data to the result display unit on the terminal side. The result display unit renders a graph of a scale of tens of thousands of nodes without delay by hardware acceleration using a parallel arithmetic processor. This configuration converts a huge amount of text data and numerical data into an intuitively graspable visual expression. This configuration enables a human to instantly recognize a correlation and an abnormal value between complex data. This configuration brings about a technical effect of improving efficiency of data analysis and speeding up decision making. This technology is applicable to a monitoring system of network traffic, visualization of an expansion simulation of an infectious disease, and the like.

An AI learning management unit continuously learns a determination result made by the determination unit in the past, information newly acquired from the outside, presence or absence of occurrence of a trouble after an actual transaction, presence or absence of occurrence of administrative guidance, bankruptcy or merger of a merchant, a growth track record, presence or absence of occurrence of cyber attack damage, presence or absence of occurrence of a system failure, and the like, and improves determination accuracy of the generative AI. For example, when a merchant determined to be non-suitable in the past causes a problem at a later date, the case is taken in as learning data and reflected in a future determination standard. Even when there is a new legal revision or a change in an industry guideline, the AI learning management unit automatically acquires information and reflects it in an algorithm of the determination unit. Specifically, the AI learning management unit executes a hybrid learning pipeline combining online learning and batch learning. The AI learning management unit collects a trouble history and log data of a system failure that occurred after an actual transaction as a correct answer label. The AI learning management unit pairs an input feature amount vector at the time of past determination with the correct answer label, and constructs a new learning data set. The AI learning management unit inputs this learning data set to a neural network model. This model calculates an error between a predicted value and the correct answer label. The AI learning management unit finely adjusts a weight parameter of the model so as to minimize an error function using a stochastic gradient descent method. The AI learning management unit inputs text data of a legal revision to a natural language processing model. This model extracts a new constraint condition from the text, and updates a rule-based evaluation function. The system applies the updated weight parameter and evaluation function as a new determination standard in next inference processing. This configuration autonomously adapts the system to an environmental change and appearance of a new risk pattern. This configuration brings about a technical effect of preventing accuracy deterioration of the model and maintaining long-term prediction performance. This technology is applicable to an environment where a data distribution changes with time, such as a spam mail filtering system and an algorithmic trading system in a financial market.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

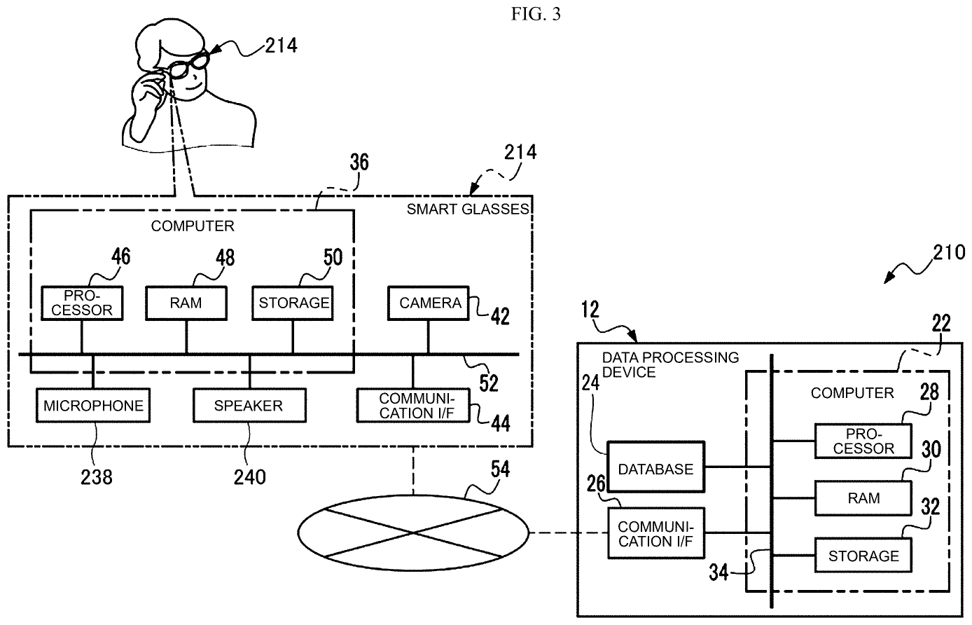

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

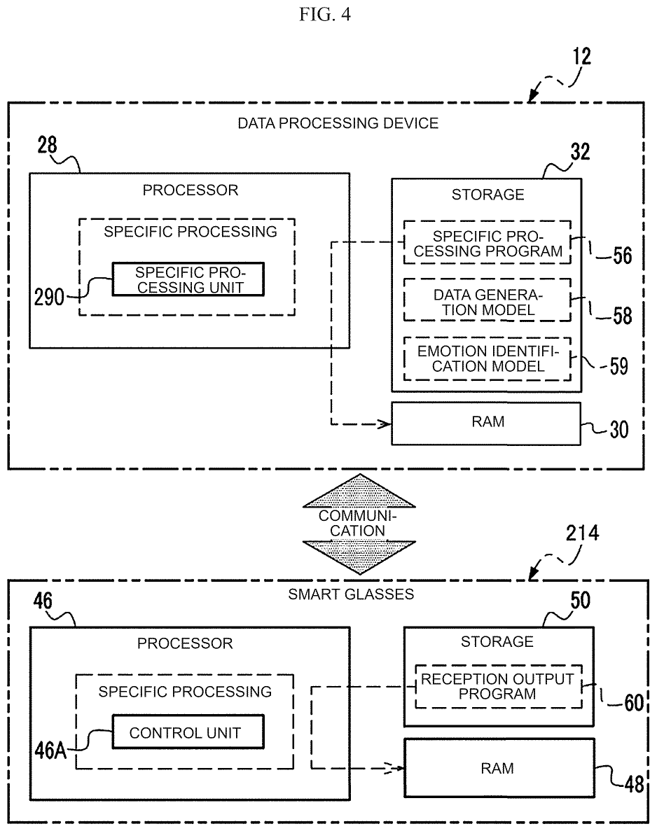

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

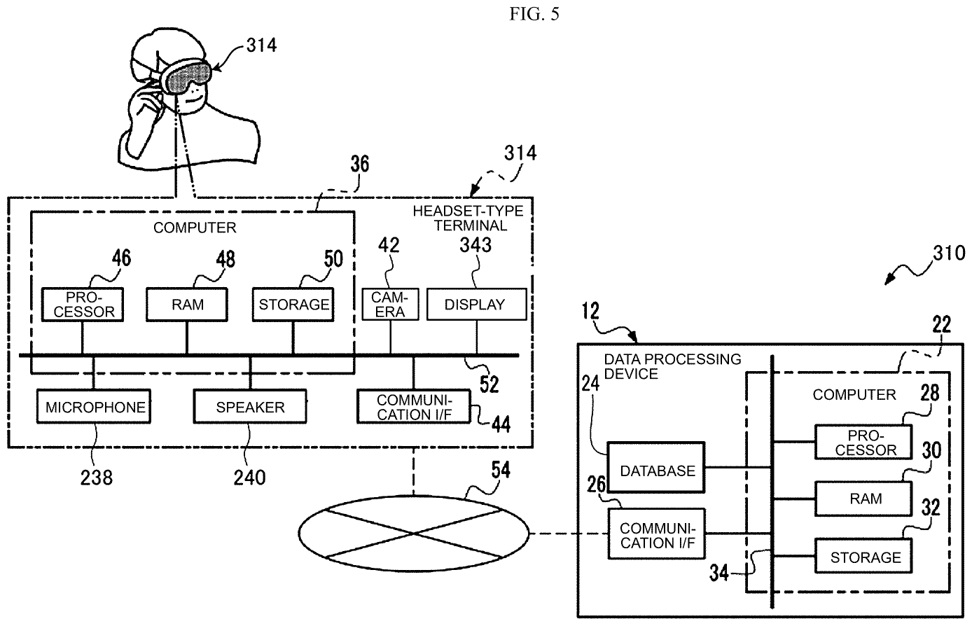

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

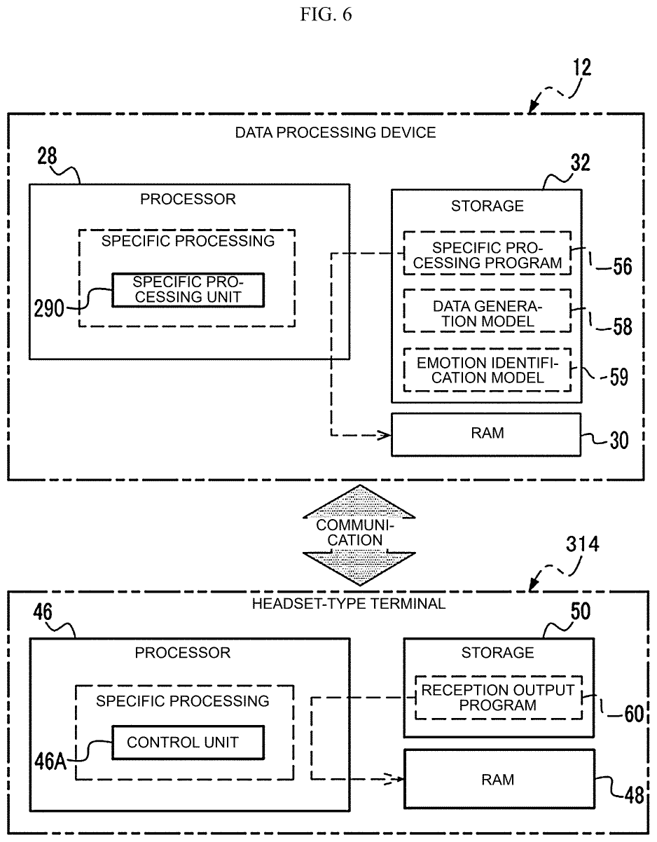

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

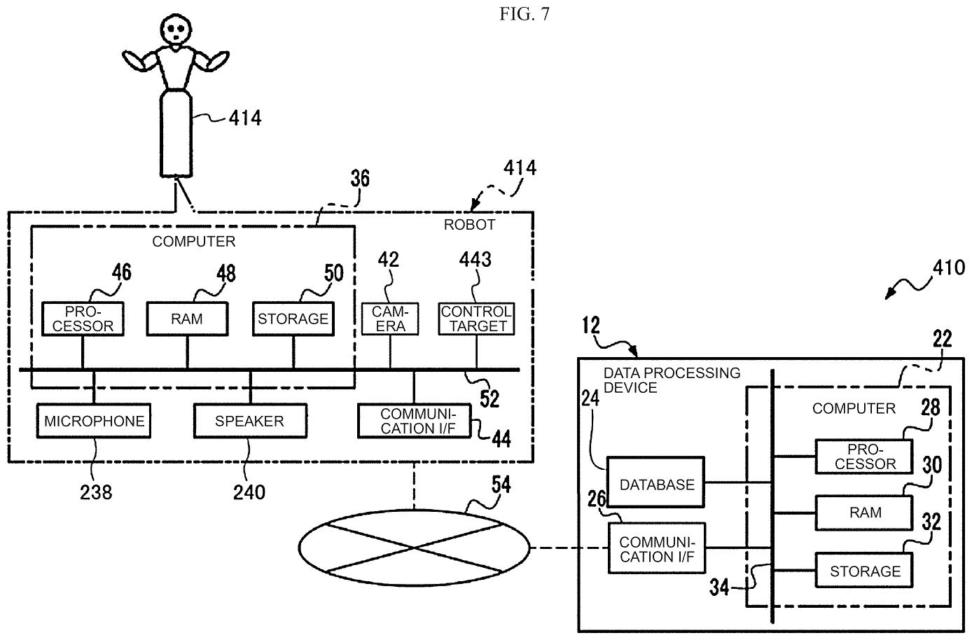

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

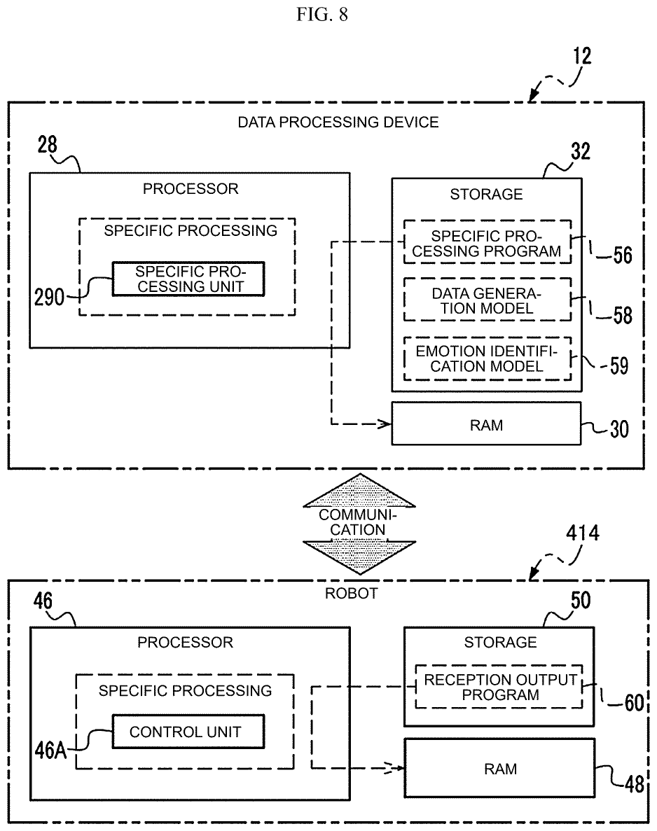

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

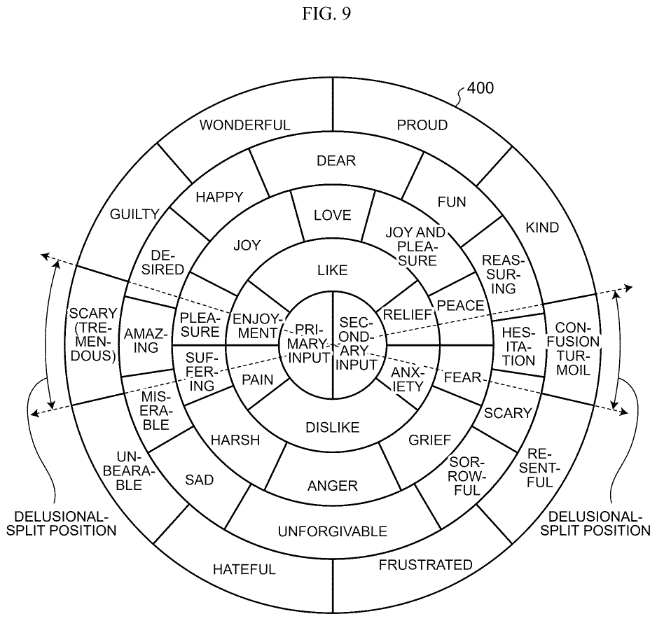

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

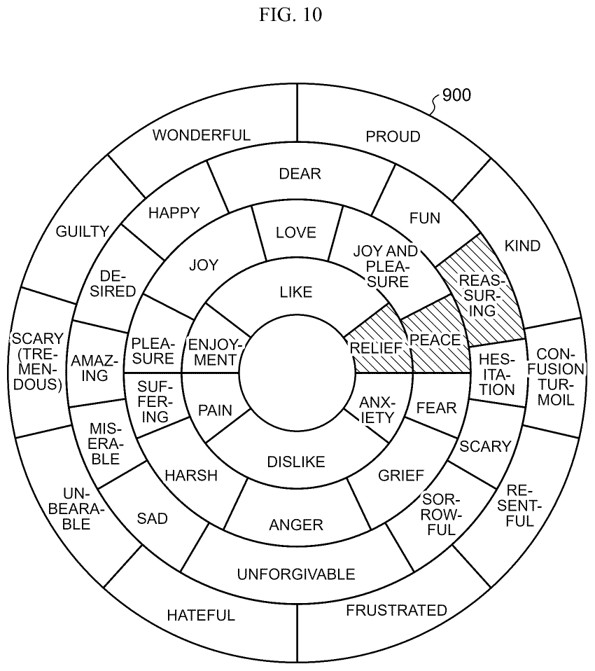

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A merchant examination management system in an electronic payment service, comprising: an information acquisition unit; a determination unit; and a mapping unit, wherein the information acquisition unit is configured to receive a company name of a merchant candidate, a representative name, a location, a date of establishment, capital, a number of employees, business contents, financial statements for a plurality of past periods, a certificate of all historical matters, a rule document regarding a personal information protection system, a written oath regarding exclusion of anti-social forces, a past history of fraudulent transactions and a history of administrative guidance, a URL of a corporate website, an industry classification, technical information for payment system cooperation, and the like as data input or uploaded from a terminal, further automatically collect related information from an internal existing merchant database, a past examination history, a transaction performance database, a contract database of a legal department, a financial database of an accounting department, and the like, and automatically acquire a credit rating, a history of administrative guidance, a reputation, word of mouth, a news article, a flaming history, a membership qualification, a possession status of intellectual property, and the like from a database of a credit research agency, public information of an administrative agency, a corporate information site on the Internet, a news site, an SNS, a list of an industry group, a patent information database, and the like via an external cooperation unit; the determination unit is configured to analyze all information collected by the information acquisition unit using generative AI, perform scoring and suitability determination from multifaceted viewpoints such as financial soundness, legitimacy of corporate status, suitability of a personal information management system, an anti-social force risk, presence or absence of a past history of fraudulent transactions and a history of administrative guidance, authenticity of website description contents, an industry risk, and technical suitability of payment system cooperation, and automatically generate a determination result and basis information; and the mapping unit is configured to automatically classify the information by a plurality of attributes such as a suitability determination result and a risk evaluation result by the determination unit, an industry of a merchant, a region, a transaction scale, a risk level, a payment system cooperation status, presence or absence of a history of administrative guidance, a possession status of intellectual property, a scale of the number of employees, a scale of capital, and a number of years of establishment, generate a merchant map by diverse visualization methods such as a graph structure, on a map, a heat map, a network diagram, a tree map, and a timeline, and enable a person in charge of each department to refer to the merchant map in real time through a result display unit on a terminal side.

### Supplementary Note 2

The system according to Supplementary Note 1, wherein the information acquisition unit is configured to automatically collect related information from a plurality of internal databases such as an internal existing merchant database, a past examination history, a transaction performance database, a contract database of a legal department, and a financial database of an accounting department in addition to input information of a merchant candidate, and further automatically acquire a credit rating, a history of administrative guidance, a reputation, word of mouth, a news article, a flaming history, a membership qualification, a possession status of intellectual property, and the like from diverse external information sources such as a credit research agency, an administrative agency, a corporate information site on the Internet, a news site, an SNS, an industry group, and a patent information database via an external cooperation unit; and the determination unit is configured to comprehensively analyze data acquired from these diverse information sources using the generative AI, and unitarily and automatically execute a merchant examination operation conventionally performed manually.

### Supplementary Note 3

The system according to Supplementary Note 1, wherein the mapping unit is configured to dynamically visualize a relationship and a risk distribution of the merchant and a payment partner as a corporate map by combining a plurality of pieces of attribute information such as a suitability determination result and a risk evaluation result by the determination unit, an industry of a merchant, a region, a transaction scale, a risk level, a payment system cooperation status, presence or absence of a history of administrative guidance, a possession status of intellectual property, a scale of the number of employees, a scale of capital, and a number of years of establishment, and further enable each internal department to refer to the map information in real time; and the determination unit is configured to continuously improve accuracy of the corporate map and reliability of risk evaluation by continuing to learn new external information and a past determination history using the generative AI.

What is claimed is:

1. A system comprising:
circuitry configured to:
receive, via a communication interface coupled to a packet-switched network, entity profile data and document files from a terminal device, and store the entity profile data and document files in a storage device;
collect supplementary attribute data associated with the entity profile data from a plurality of external data services via the communication interface, and consolidate the supplementary attribute data with the entity profile data into a unified attribute record in the storage device;
process the document files using an optical character recognition model and an object detection model to extract structured attribute data and network topology graph data, and append the structured attribute data and network topology graph data to the unified attribute record;
apply a graph neural network to the network topology graph data by constructing a graph comprising component nodes and dependency edges derived from the network topology graph data, executing a message passing algorithm to propagate feature information between adjacent component nodes, and generating a connectivity feature vector representing inter-component dependency relationships;
apply a generative neural network model to the unified attribute record and the connectivity feature vector to generate scoring vectors across a plurality of attribute evaluation dimensions, and compute an attribute classification vector and a reason vector from the scoring vectors; and
transmit the attribute classification vector, the reason vector, and a relational graph representation generated by classifying entities in the storage device according to multi-attribute clusters derived from the scoring vectors to the terminal device via the communication interface.

2. The system according to claim 1, wherein the circuitry is configured to perform N-gram character string matching on entity name fields in the entity profile data against an in-memory entity name index to identify candidate matching records, and present a ranked list of candidate matching records to the terminal device for disambiguation prior to storing the entity profile data.

3. The system according to claim 2, wherein the circuitry is configured to asynchronously query a plurality of external data services including entity registration databases and public information repositories via the communication interface upon receiving the entity profile data, and merge returned attribute fields with the entity profile data in the unified attribute record using a common entity schema.

4. The system according to claim 3, wherein the circuitry is configured to verify a MIME type of each received document file, apply a hash function to each document file to generate an integrity hash value, and execute a malware scan prior to transmitting the document file to a processing pipeline for optical character recognition and object detection.

5. The system according to claim 4, wherein the circuitry is configured to apply the optical character recognition model to image-format document files to extract text content fields, normalize the extracted text content fields according to a unified data schema, and store the normalized text content fields as structured attribute data associated with corresponding entity profile records in the storage device.

6. The system according to claim 1, wherein the circuitry is configured to parse specification document files in a structured markup format to extract endpoint identifiers, parameter data types, and response schema definitions as a data structure in memory, and apply the object detection model to system architecture diagram image files to extract component identifiers and network topology as the network topology graph data.

7. The system according to claim 6, wherein the circuitry is configured to project the scoring vectors into a 512-dimensional embedding vector space, compute inter-entity similarity scores by applying a cosine distance function to pairs of projected embedding vectors, and generate the relational graph representation from entity clusters identified by applying a clustering algorithm to the 512-dimensional embedding vectors.

8. The system according to claim 1, wherein the circuitry is configured to apply token-level positional encoding to text sequences extracted from the document files prior to processing by the generative neural network model, and compute named entity labels and sentiment polarity scores for text sequences, the named entity labels comprising entity type identifiers and temporal markers.

9. The system according to claim 1, wherein the circuitry is configured to generate the scoring vectors by applying the generative neural network model to the unified attribute record, the scoring vectors comprising a first dimension score corresponding to financial attribute data, a second dimension score corresponding to regulatory compliance attribute data, and a third dimension score corresponding to technical configuration attribute data.

10. The system according to claim 9, wherein the circuitry is configured to compute the attribute classification vector by applying a weighted combination of the scoring vectors across the plurality of attribute evaluation dimensions, compare an aggregate classification score derived from the attribute classification vector against a classification threshold value, and generate the reason vector identifying scoring dimensions contributing to the aggregate classification score falling below the classification threshold value.

11. The system according to claim 1, wherein the circuitry is configured to update a machine learning model used in computing the scoring vectors by generating training pairs from historical attribute classification vectors and corresponding unified attribute records, and fine-tuning the machine learning model on the training pairs to improve classification accuracy using self-supervised learning with a cross-entropy loss function.

12. The system according to claim 1, wherein the circuitry is configured to classify entities in the storage device according to a plurality of attribute dimensions to generate the relational graph representation, and render the relational graph representation as a network diagram, a heat map, or a timeline visualization selectable at the terminal device.

13. The system according to claim 12, wherein the circuitry is configured to dynamically update the relational graph representation by incorporating updated scoring vectors generated from newly collected supplementary attribute data, and transmit updated graph data to terminal devices subscribed to a real-time update channel via the communication interface.

14. The system according to claim 1, wherein the circuitry is configured to record all state transitions and data access events associated with entity profile records in a tamper-resistant distributed ledger, and store audit log entries comprising a timestamp, an entity identifier, an operation code, and a user identifier in the distributed ledger.

15. The system according to claim 14, wherein the circuitry is configured to execute a token-based authorization check for all requests to access entity profile records or attribute classification vectors, and apply an access control policy limiting data access to authorized user identifiers associated with corresponding organizational role parameters.

16. The system according to claim 1, wherein the circuitry is configured to encrypt data packets transmitted between the terminal device and the system using a transport layer security protocol, and perform mutual authentication using a digital certificate based on a public key cryptosystem prior to accepting entity profile data from the terminal device.

17. The system according to claim 1, wherein the entity profile data comprises corporate entity attribute data, the document files comprise structured specification documents and system architecture diagram image files, and the attribute classification vector and reason vector correspond to a multi-dimensional attribute-based assessment of the corporate entity.

18. A system comprising:
circuitry configured to:
receive, via a communication interface coupled to a packet-switched network, entity profile data and document files from a terminal device;
collect supplementary attribute data from external data services and consolidate into a unified attribute record;
apply an optical character recognition model and object detection model to extract structured attribute data and network topology graph data;
apply a graph neural network to the network topology graph data using message passing operations to generate a connectivity feature vector;
apply a generative neural network model to the unified attribute record and connectivity feature vector to generate scoring vectors, compute an attribute classification vector and a reason vector, and project scoring vectors into a 512-dimensional embedding vector space for relational graph generation; and
transmit the attribute classification vector, the reason vector, and the relational graph representation to the terminal device via the communication interface.

19. The system according to claim 18, wherein the circuitry is configured to update a machine learning model used in computing the scoring vectors by generating training pairs from historical attribute classification vectors and using self-supervised learning with a cross-entropy loss function, record all state transitions and data access events in a tamper-resistant distributed ledger, and dynamically update the relational graph representation by incorporating updated scoring vectors from newly collected supplementary attribute data.

20. A method comprising:
receiving, via a communication interface coupled to a packet-switched network, entity profile data and document files from a terminal device, and storing the entity profile data and document files in a storage device;
collecting supplementary attribute data from a plurality of external data services and consolidating with the entity profile data into a unified attribute record;
processing the document files using an optical character recognition model and an object detection model to extract structured attribute data and network topology graph data;
applying a graph neural network to the network topology graph data by constructing a graph with component nodes and dependency edges, executing message passing to generate a connectivity feature vector;
applying a generative neural network model to the unified attribute record and the connectivity feature vector to generate scoring vectors and compute an attribute classification vector and a reason vector; and
transmitting the attribute classification vector, the reason vector, and a relational graph representation to the terminal device via the communication interface.
